(19) United States
(12) Patent Application Publication
(10) Pub. No.: US 2024/0046034 A1
(43) Pub. Date: Feb. 8, 2024

(54) System and method to memorize and communicate information elements representable by formal and natural language expressions, by means of integrated compositional, topological, inferential, semiotic graphs

(71) Applicant: stefano casadei, cambridge, MA (US)

(72) Inventor: stefano casadei, cambridge, MA (US)

(21) Appl. No.: 17/881,607

(22) Filed: Aug. 5, 2022

(51) Int. Cl. G06F 40/20; G06F 16/9038

(52) U.S. Cl. CPC G06F 40/20; G06F 16/9038

(57) ABSTRACT

Systems and methods are disclosed to enable a plurality of users to memorize, recall and communicate a plurality of information elements by means of an ensemble of symbols. Both natural languages and formal languages of a mathematical nature are used to provide the basis to construct symbolic representations having different degrees of complexity, ranging from names, words, numerical quantities, physical quantities, simple natural language expressions, to more complex constructs such as lists, tables, inferential derivations and documents. The disclosed systems and methods integrate four components: (1) a compositional structure which reflects, for example, the compositional structure of natural languages, and which enables users to compose their own symbols from existing symbols according to each user's specificities; (2) a representation of signification events as points in a semiotic space, which enables a flexible user-dependent and context-dependent relationship between symbols and their referents; (3) a topological component representing equivalence, proximity and similarity between symbols, which enables approximate matching during search and recall; and (4) an inference component.

### BACKGROUND OF THE INVENTION

This invention relates to the general area of information systems, databases, knowledge representation and reasoning, and human machine interfaces.

Many activities carried out by humans and by artificial systems rely on the representation, memorization, recall and communication of information elements such as (or representable by) names, words, physical measurements, numerical quantities, properties, relationships, lists and more sophisticated constructs such as natural language expressions, tables, inferential derivations, documents, etc.

Modern technologies use digital representations of these information elements (and of any other underlying entity) consisting of digital structures which are ultimately materialized by chunks of binary memory cells held in storage devices such as electro-mechanical hard disks drives (HDD), solid state drives (SSD), or random-access memory devices (RAM).

These digital structures, containing sequences of 0's and 1's, are processed by means of digital processors and then converted into analog signals by means of digital-to-analog (D/A) modules or devices, for example, to present information to a user via a computer screen. Conversely, analog-to-digital (A/D) modules (or devices) convert real-world events such as actions, commands or data entered by a user into materialized digital structures.

One limitation of many existing technologies for representing and memorizing information is their lack of simple and intuitive interfaces, which makes them hard to use by naive users who have not been specifically trained to use these technologies. This application discloses methods and system to define ensembles of symbols that mimic human language and human thought, for example, by analyzing natural language expressions generated by a user and by extracting symbols from these expressions which the user can then use to compose more complex symbols and expressions. The direct participation of the user in the creation of symbols results in symbols that are better adapted to the user and therefore easier to use.

Another roadblock towards the development of user-friendly memory systems is due to the non-univocal and mutable correspondence between symbols and their meanings (semiotic mismatch). Humans express themselves by means of ambiguous multi-sense symbols which have different meanings in different contexts, for example: “the user clicked on the mouse” and “the cat chased the mouse” (non-univocal symbol-to-referent mapping). Conversely, humans use different symbols or different expressions to convey the same meaning (non-univocal referent-to-symbol mapping, symbol redundancy).

Many of the existing information, communication, and database systems break down when one or both of these mappings between symbols and their meanings is non-univocal; in other words, these existing systems require symbols to have a unique meaning or assume that a referent is always represented by the same symbol, thus creating a communication barrier with human users, who are instead accustomed to map symbols to meanings in a very loose and flexible way.

To deal with symbol ambiguity and symbol redundancy, the disclosed invention embeds the ensemble of symbols in a semiotic space whose points represent the instantaneous meanings of symbols, thus providing a basis to differentiate between the multiple meanings of a symbol and also to detect and organize symbol redundancies.

Another limitation of many existing database and communication systems is their inability to perform inference and reasoning in the presence of uncertainty and semiotic mismatch. Most of the existing reasoning engines assume a univocal correspondence between symbols and their meanings and also regard information as a set of axioms whose truth value is absolute and indefeasible. Therefore, existing database and communication systems based on these strict reasoning engines do not support hypothetical reasoning with uncertain and contradictory information or when symbols have a context dependent meaning.

The disclosed invention assumes only a loose and flexible correspondence between symbols and meanings and between propositions and truth values and employs different types of coherent frames to localize coherence constraints (both for logical coherence and semiotic coherence). Mutually contradictory hypotheses and statements are segregated into separate frames, so that inference and logical deductions can be safely carried out within the boundary of a context frame, which provides protection and isolation from the contradictory statements contained in other frames.

### SUMMARY OF THE INVENTION

According to one aspect of this invention, in order to represent and memorize information, a user develops, with the assistance of the memory system, an ensemble of information-bearing symbols that best suits the user's needs, culture, and competences.

Some of the symbols created by a user are conceptual symbols, so called because they typically correspond to concepts, ideas, mental states, etc. which can be regarded as existing inside the mind or the brain of the user. Natural languages, such as the English language, are a rich source of conceptual symbols and some embodiments of this invention rely on natural languages to generate conceptual symbols such as names for everyday objects and individuals, categories, predicates, logical statements, relationships, etc.

Mathematics, computer science and other disciplines based on formal languages and models also provide sources of symbols such as numbers, lists, sets, functions, and more complex objects, such as tables, documents, and datasets.

According to another aspect of this invention, a user manipulates existing symbols, for example by means of a graphical user interface or by a voice-assisted interface, so as to generate new ones, for example, by means of symbol synthesis (composition) or symbol analysis (decomposition).

Natural language expressions are analyzed grammatically and decomposed into constituent symbols so as to encode the original expression into a format that makes explicit the grammatical roles of its components. Furthermore, the constituent symbols obtained by decomposing formal and natural language expressions are used as building blocks to generate new composite symbols. Grammatical analysis and symbol composition enables the transformation of plain natural language expression represented by character strings into logical symbols, such as predicates, amenable to inferential processing.

According to another aspect of this invention, in order to deal with symbol ambiguity, the disclosed memory system wraps a symbol into a semiotic point representing its instantaneous atomic meaning in a particular signification event; the memory system further represents the extended meaning of a symbol by recording the trajectories in semiotic space obtained by linking semiotic points generated by said symbol.

The memory system may present a summary of the history of previous usages of a

symbol to a user and prompt the user to select the usage or the usages of the symbols that best correspond to the current meaning.

Semiotic points with similar or slowly varying meanings may be organized into threads and clusters which provide the basis to define the histories of semiotic entities. Semiotic entities are further analyzed into finer entities and joined into coarser entities.

According to another aspect of this invention, the disclosed memory system contains a plurality of descriptive symbols (or descriptive aggregates) wherein a descriptive symbol is an aggregate symbol containing a featured symbol (the subject of the descriptive symbol) and a plurality of descriptor symbols (or annotation symbols), each describing a feature of the subject.

Descriptive symbols may play the role of entity representatives and may arise, for example, from the consolidation of information accumulated over the history of an entity.

According to another aspect of this invention, to deal with symbol redundancies, symbols are compared and organized based on a hierarchy of topological relations (FIG. 2) which capture the equivalence and similarities of their atomic and extended meanings.

A symbol (more specifically, a multiform symbol) may occur in the memory system multiple times and in multiple locations in one of several possible symbol forms such as symbol identifiers, compositional codes, exploitable forms, analog widgets, etc. (see FIG. 3).

Occurrences of symbols in a physical embodiment of the disclosed memory system, which are given by materialized digital structures, sit at the bottom finest layer of the topological abstraction hierarchy (layer 201 of FIG. 2). Two equivalent materialized digital structures (for example, two materialized digital structures containing the same bit sequence) are considered to be instances of the same symbol form; thus, an element in layer 202 (a symbol form) corresponds to an equivalence class of materialized symbol occurrences contained in layer 201.

At the next layer transition (from 202 to 203), a multiform symbol occurring in a particular form (e.g., a compositional code) may be converted to another equivalent symbol form (e.g., an exploitable form), yielding an equivalence class of symbols forms: equivalence in 202 (symbols forms) yields an element of 203, a multiform symbol.

Next, multiform symbols characterized by the same primary exploitable form (symbol body) are grouped into body-equivalence (BODEQ) classes (203 to 204) and these are further organized into semantic-equivalence (SEMEQ) classes (204 to 205).

Finally, groupings of similar symbols (or symbols related by proximity or subsumption relationships) are constructed (layer 206). These groupings may be obtained from a (possibly asymmetric) “similarity” distance between non equivalent symbols based on, for example: (a) a domain-specific or primal metric, such as the edit-distance in spaces of strings or the conventional Euclidean norm in real vector spaces (b) the number of shared constituents (applicable to aggregate symbols such as descriptive symbols) (c) the probability of conveying the same atomic meaning or (d) the overlap of their extended meanings in a semiotic space. Synonymous words or expressions are considered similar inasmuch as they can be used interchangeably in some contexts.

For primal symbols, such as numbers and physical quantities, a natural similarity measure is provided by the metric defined on the space to which they belong. These primal similarity measures are extended by embodiments of this invention to composite symbols containing primal symbols, possibly with the assistance of users.

According to one aspect of the invention, symbols are searched for in the memory system by integrating topological (horizontal) search with compositional (vertical) search.

Slack search regions are obtained by creating and updating adaptive neighborhoods which comprise equivalent symbols, similar symbols and symbols related by subsumption relationships (horizontal search).

Vertical compositional search is based on the compositional structure of symbol and on building bottom-up composition lists which track symbol usage. Integration of horizontal and vertical search is carried out by calculating relaxed hypotheses lists of various types, including relaxed composition lists and relaxed compositional hypotheses lists.

According to another aspect of this invention, partial incomplete compositional matches are processed by an inference network which infers nodes and paths to complete the match (compositional and inferential search integration).

According to another aspect of the invention, the memory system assumes only a loose and flexible correspondence between symbols and meanings and between propositions and truth values and, to ensure soundness, performs logical coherence checks and semiotic coherence checks within coherent frames of different types, such as:
(a) Coherent interactive sessions, wherein a user maps all occurrences of a symbol to the same referent (and all occurrences of a proposition to the same truth value);
(b) Composite symbols (e.g., natural language expressions, relational tables, databases), wherein multiple occurrences of a constituent symbol have, by construction, the same interpretation.
(c) Coherent symbol aggregates of different types: (c1) descriptive aggregates, which consolidate information pertaining to the same featured subject; (c2) inference aggregates, which aggregates the premises and byproducts of inference derivations; (c3) topological aggregates, which group equivalent, similar or adjacent symbols. Coherent aggregates are obtained via semiotic unification and logical unification, that is, by grouping symbols sharing a constituent which has been recognized (by a user or by a semiotic master) to have the same interpretation and by grouping occurrences of propositional symbols recognized to have the same truth value.
(d) Finally, semiotic entities, which contain semiotic points characterized by a constant or slowly varying meaning.

Embodiments of this invention organize information into a network of “parallel” coherent frames thus enabling alternative descriptions of the world, hypothetical reasoning and defeasible reasoning, wherein information entered at one point can be safely corrected or modified at a later point.

According to another aspect of the invention, a newly create composite symbol is compared and mated with existing instantiated symbols having some constituent in common, so as to initialize adaptive neighborhoods and establish inferential links. For this purpose, partial matches (sub-matches) found during ingestion of the new symbol may be used.

According to another aspect of the invention, a memory graph comprising instantiated symbols and inference nodes is constructed by integrating up to four different types of graphs: (1) compositional graphs (representing the compositional structure of symbols), (2) topological graphs (representing symbol equivalence, similarity and subsumption), (3) semiotic graphs (representing the varying and non-univocal relationships between symbols and their referents) and (4) inference graphs (which represent logical and inferential relationships and execute inference derivations).

According to another aspect of this invention, semiotic entities are periodically consolidated so as to yield rich entity representations containing maximal sets of features; these entity representations, combined with efficient multi-depth compositional search algorithms (and their topologically relaxed variants for approximate matching), reduce the need of deep inferential searches, which are prone to quickly hitting a combinatorial explosion barrier.

This underlying entity consolidation process, which entails pre-unification of symbol occurrences, is partially executed offline, during a grooming phase, and partially by means of feedback from users.

According to another aspect of the invention, intermediate expansions of hierarchical compositional codes provide a variable-complexity multi-level representation of a symbol which allows a user or an application to select a computationally optimized symbol representation whose memory footprint is commensurate with the available resources.

According to another aspect of this invention, in order to minimize the amount of physical resources needed by the memory system to support a particular application, the memory store is organized into a collection of slices, wherein certain slices are devoted to storing only application-specific symbols so that content irrelevant for the particular application at hand does not need to be loaded into short-term memory.

### BRIEF DESCRIPTION OF DRAWINGS

FIG. 1A (drawing sheet 1) illustrates an embodiment of the disclosed memory system which comprises: a plurality of materialized digital structures representing occurrences of symbols; storage means to hold these materialized digital structures; I/O interfaces to convert between external analog signals and internal digital representations such as materialized digital structures; processing means which convert, create, combine, analyze, or otherwise process symbol occurrences, and which also process digital representations of input/output signals received from or delivered to the I/O interfaces. The memory system is connected to at least one user (e.g., a human user), which is able to interpret the symbols represented in the memory system. The memory system is also optionally connected to: (1) input and output modules to mediate and/or facilitate interaction with the user and the external environment; (2) an application engine; (3) a source of external symbols.

FIG. 1B shows the memory system in a configuration with multiple users.

FIG. 1C illustrates a distributed memory system comprising two nested memory systems which are connected to a plurality of possibly remote users by means of a network.

FIG. 2 (drawing sheet 2) depicts the organization of symbol occurrences into layers of equivalence classes and proximity/similarity/subsumption groupings (topological abstractions of the memory system).

FIG. 3 (drawing sheet 2) depicts the types of symbol forms, their inter-relationships and the roles they play with respect to a multiform symbol instance.

FIG. 4 (drawing sheet 3) is a flowchart representing the various steps and user actions that may be taken during an interactive session, including: browsing of the memory content; symbol creation; symbol ingestion; and editing of the semiotic graph. Querying the memory system is achieved by creating and ingesting query symbols.

FIG. 5 (drawing sheet 4) illustrates in more details the steps involved in the composition of a new symbol and, by means of an example, depicts the symbols and symbol form instances involved as well as their relationships.

FIG. 6 (drawing sheet 5) depicts an integrated compositional-semiotic graph extending over 6 interactive sessions and illustrating the usage of an ambiguous symbol (“a mouse”) and its disambiguation based on the teachings of this invention. This figure also illustrates the creation of a multi-sense reconciler symbol (boundary symbol).

FIG. 7 (drawing sheet 6) depicts an integrated compositional-semiotic graph extending over 5 sessions and illustrating the semiotic refinement of a vague (fuzzy) symbol (specifically, the category “people”).

FIG. 8 (drawing sheet 7) depicts an integrated compositional-topological-semiotic graph extending over 6 sessions and illustrating semiotic unification of 3 propositional symbol 812, 813, 814, as well the associated thread-to-cluster semiotic history conversion and the resulting descriptive symbol 807. The figure also illustrates a topological link (between 801 and 805) and the corresponding topological symbol 816.

FIG. 9 (drawing sheet 8) depicts an integrated compositional-semiotic graph extending over 5 sessions and illustrating entity state updates, semiotic refinements, and semiotic analysis of a coarse entity into finer sub-entities.

FIG. 10 (drawing sheet 9) depicts an integrated compositional-semiotic graph extending over 4 sessions and illustrating the reconciliation of two related semiotic entities by means of a reconciler semiotic entity whose incipient point is simultaneously linked to the tail points of the two related semiotic entities. The reconciled semiotic entities could correspond, for example, to different meanings represented by the same symbol, such as the mouse” symbol of FIG. 6; different flavors of a symbol (such as the “people” symbol of FIG. 7); or equivalent meanings of symbol.

The first two examples result in a cross-over configuration in the semiotic graph, wherein the two related semiotic entities, after having come together into the reconciler, diverge again and maintain their separated histories (as shown in FIG. 10). In the latter case, the two semiotic entities are merged resulting in a unique history (not shown in FIG. 10). After reconciliation, the semiotic entities are represented by a symbol obtained by sub-referencing (or plucking from) the reconciler.

FIG. 11A (drawing sheet 10) illustrates an iteration of the compositional search method

based on composition lists and 11B (drawing sheet 10) illustrates the approximate-match variant where a search-enabling constituent is jiggled within a slack search region.

FIG. 12 (drawing sheet 11) illustrates a concrete inference node hosted by a particular if/then rule (expressed as category subset symbol) which executes syllogisms.

FIG. 13 (drawing sheet 11) shows an abstract category subset symbol and four inference sub-nodes, one of which is exemplified in FIG. 12. Two of these are forward-chaining inference nodes and two are backward chaining nodes.

FIG. 14A (drawing sheet 11) illustrates a singleton category sample node hosting a forward-chaining inference sub-node and a terminal back-chaining sub-node which resolves query symbols directly (without spawning additional goal symbols). In FIG. 14B, this terminal back-chaining node 1411 of FIG. 14A is shown as being connected to a category subset node 1421 so as to realize a direct resolution of a query symbol.

FIG. 15 (drawing sheet 11) is a category union symbol node with two inference sub-nodes (one for each constituent term).

FIG. 16 (drawing sheet 12) illustrates an inference sub-node associated with a conjunction of terms (intersection of categories); input query symbols are decomposed and delegated to the constituent categories; the responses of these, once received, are combined into a response to the input query.

FIG. 17 (drawing sheet 12) similarly processes input queries to a disjunction of terms (union of categories), except that a response to the input query can be constructed after receiving a response from just one of the constituent categories.

FIG. 18 (drawing sheet 13) illustrates a symbol representing a two-column table which hosts a forward-chaining inference node that retrieves the information contained in a particular row when an input signal is received which contains an element of the first column.

FIG. 19 (drawing sheet 13) illustrates the integration of the inference component of the memory graph with the topological component: the same table node shown in FIG. 18 is linked, in FIG. 19, to an input symbol node which is an approximation of an element of the first column.

FIGS. 20-22 (drawing sheet 13) shows inference nodes hosted by a linguistic symbol. FIG. 20 materializes the transitive property of the “in” preposition by means of a forward-chaining node and a backward-chaining node; FIG. 21 and FIG. 22 represent some of the joint semantics of the verb “to go” with the prepositions “in” and “when”.

### DETAILED DESCRIPTION OF THE INVENTION

### 1 Memory System Interacting with Users

### 1.1 Main Embodiment

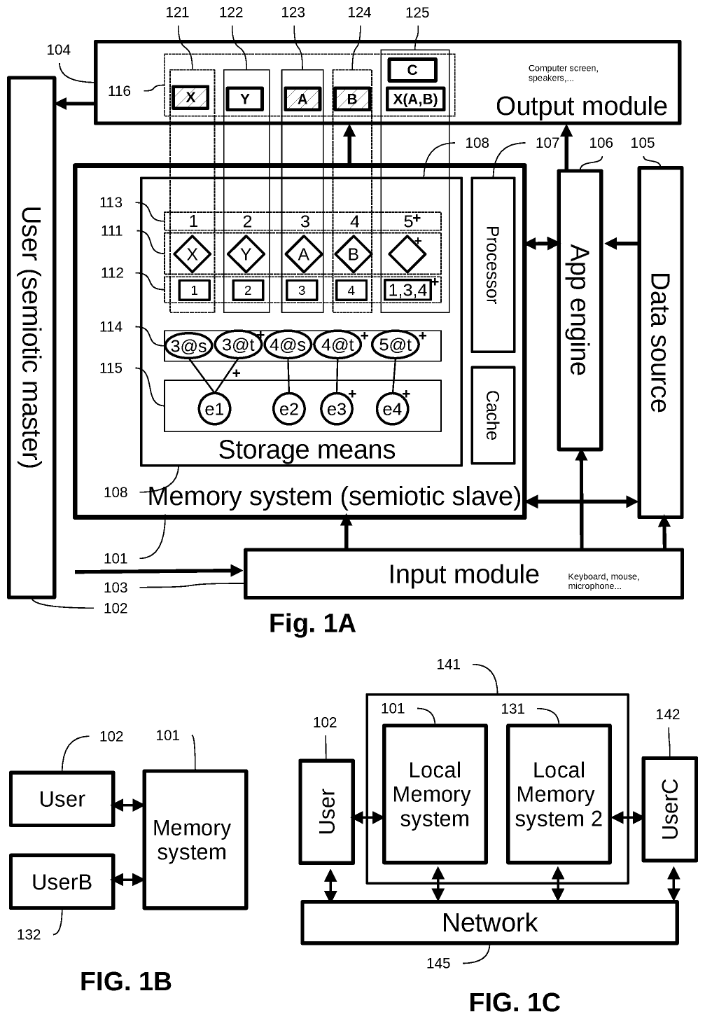

To appreciate the disclosed invention, it is convenient to examine one possible general embodiment as shown in FIG. 1A, which illustrates a memory system 101 interacting with a user 102 via input means 103 and output means 104. The user 102 could be a human user or a computer-controlled agent or apparatus capable of interpreting symbols (semiotic master).

The memory system may also be connected (directly or via a network) to an application engine 106 which carries out some task that needs a connection to a memory system, such as, for example, maintaining a smart archive of a family's digital photos or maintaining a smart archive of the digital assets of a corporation.

In addition, the memory system may be connected to a data source 105, which could be another memory system of the type disclosed by this application, possibly interacting with another user; or it could be connected to an external computer system or network including a database or ontology and possibly providing a web service. For example, the memory system could be receiving and importing exogenous symbols from a connected external database or ontology; or it could process a list of files scanned by an external application or a list of internet resources provided by a web service.

The memory system 101 comprises a processor 107 and storage means 108 which contains several types of materialized digital structures: exploitable forms 111, depicted as diamond cells; compositional codes 112, depicted as rectangular cells; symbol identifiers 113, given by the consecutive integers from 1 to 5 in the example shown; semiotic points 114 depicted as oval cells; and semiotic entities 115 depicted as circular cells. Exploitable forms 111, compositional codes 112 and symbol identifiers 113 are different types of digital symbol forms.

Multiform symbols, such as 121, 122, 123, 124 and 125 comprise a plurality of these digital symbol forms; for example, multiform symbol 125 has a symbol identifier {5} and a compositional code [1,3,4], whereas multiform symbol 123 has symbol identifier {3} and an exploitable form denoted <A>.

In addition to digital forms, multiform symbols may have analog symbol forms 116, called widgets, which are materialized in the output module 104.

The embodiment shown in FIG. 1 shows five semiotic points (row 114), of which two, 3@s and 4@s, were created during an interactive session denoted @s and three, 3@t, 4@t and 5@t, during a later session @t.

Four semiotic entities (row 115) are also shown, along with connectors indicating the semiotic points belonging to their histories.

Points 3@s and 3@t are in the same entity {e1}, indicating that the instantaneous (atomic) meaning of the multiform symbol {3}<A> in session @s is (substantially) the same as its instantaneous meaning in session @t. Points 4@s and 4@t belong to two distinct entities {e2} and {e3}, indicating that the atomic meaning of the multiform symbol {4}<B> in session @s is not the same as its atomic meaning in session @t.

All the digital structures created during the second session (session @t) are marked with a small “+” in the upper right corner to indicate that they were not in the memory system at the end of the first session and were added during the following session.

In some embodiments, the memory system 101 is a small-factor device containing one or more storage devices (such an HDD or SSD), a digital processor or microcontroller and the necessary interface devices (not shown in the drawing) to communicate with the I/O modules 103 and 104.

In other embodiments, the memory system 101 is a personal computer and the output means 104, connected to 101, may include a computer screen, speakers, etc. and the input means 103, also connected to 101, may include a keyboard, a mouse, a trackpad device, and possibly a camera.

In other embodiments, the memory system 101, the input means 103 and the output means 104 are all integrated in a smartphone device or a tablet device, which could also include the application engine 106.

The memory system includes transforming means to convert a symbol form into a different symbol form. For example, a symbol identifier consisting of a computer memory address may be converted into a digital exploitable form by dereferencing the symbol identifier and retrieving the content of the corresponding storage record. As another example, in order to transmit a symbol to a user, the memory system may transform a digital symbol form into an analog symbol form, such as a widget to be displayed on an external screen.

The memory system typically includes presenting means to present some of the instantiated presentable symbols, semiotic points, or semiotic entities to the user (or receiving party), resulting in a plurality of presented symbols. These presenting means include a digital processor to convert an internal form into a form suitable for communication to the external environment.

In some embodiments, the presenting means includes transforming means to convert a digital form of a symbol suitable for storage into another digital or analog form suitable for communication.

The presenting means may include a digital to analog interface device to generate output analog signals.

In yet other embodiments the presenting means of the memory system may also include the final signal-consuming device which could be, for example, a computer screen or a speaker.

The memory system may include selecting means to enable an external user to select some of the presented symbols so as to compose new symbols. These selecting means typically include an analog to digital interface to convert external signals which may come, from example, from a keyboard, a microphone, a virtual reality gadget, or any other input device. In some embodiments, an input device may be integrated in the memory system.

The memory system comprises ingesting means and searching means to process queries and newly created symbols so as to generate a proper response. These means typically include a processor and a set of instructions to carry out some of the methods disclosed in this application.

### Additional Remarks on FIG. 1

Symbols 121,122,123,124 are primitive symbols which do not have a compositional

code form. They are however assigned a default dummy compositional code given by their symbol identifier as shown in row 112.

The exploitable forms <X>, <Y>, <A>, <B> (row 111) of the primitive symbols 121,122,123,124 are called the primary bodies of these symbols and are normally stored in a record of the memory system that is typically specified by the permanent identifier of the symbol.

In some embodiments, the body's cell (record) of a primitive symbol may contain a pointer to the external source instead of its defining symbolic structure for the sake of reducing the consumption of storage resources.

Symbol 125 is a code-bearing composite symbol obtained by composing the builder symbol 121 with the symbols 123 and 124. A composite symbol is defined by its compositional code; the defining compositional code of 125 is [1,3,4], as shown in the intersection of 125 and 112.

The body's cell (diamond shape) for the composite symbol 125 is empty; indeed, the compositional code suffices to define the symbol. However, the memory system may decode the compositional code by executing the builder therein so as to produce the decoded body of the symbol.

The notation {1}<X>, {2}<Y>, {3}<A>, {4}<B> is used to indicate that the integers 1,2,3,4 are symbol identifiers for <X>, <Y>, <A>, <B> respectively.

The notation {5}[1,3,4] is used to denote this code-bearing composite symbol along with its symbol identifier

### 1.2 Multi-User and Distributed Memory Systems

FIG. 1B illustrates an embodiment where several users interact with a memory system 101. For example, members of the same family may utilize a memory system located in their home to memorize and share information, such as documents and photos and comments about them.

FIG. 1C illustrates a distributed memory system 141, composed of two local memory systems 101 and 131 connected between themselves and with a plurality of users by means of a network. For example, a group of friends or a group of coworkers may have their own memory system to which they maintain exclusive write privileges, but they may grant read privileges to other member of the group so that everyone can access the information and the knowledge contributed by the others and build on it.

### 1.3 Actions Taken During an Interactive Session

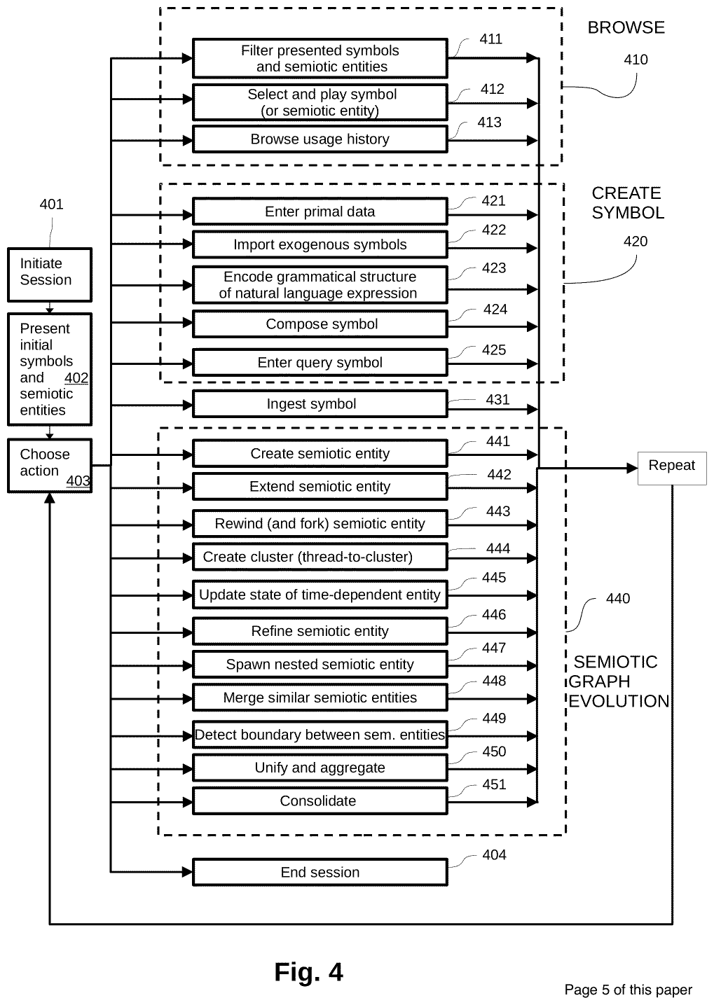

FIG. 4 illustrates the steps that may be executed during an interactive session between a user and the disclosed memory system. After initiating a session (401), some symbols (and possibly some semiotic entities and some semiotic points) are presented to the user (step 402) by creating some analog widgets (for example, on a computer screen). A number of possible steps can then be executed (a choice is made at 403). These steps are divided into four groups: browsing steps (group 410), symbol-creation steps (group 420), the ingestion step (431), and semiotic evolution steps, which result in a modification of the semiotic graph (group 440).

### Browsing

Step 411 filters the presented widgets so that certain symbols or semiotic entities (or semiotic points) are presented more clearly. For example, certain widgets may be removed from view (if displayed on a screen) to reduce clutter. Widgets may also be reorganized, for example, by sorting lists of symbols according to some selected criterion.

Step 412 selects and plays a widget. Widgets provide machine-generated sensorial stimuli including text, visual icons, sounds, etc. which are ultimately received and interpreted by a user or other receiving party; they sit at the boundary between the digital memory system and its external environment (which may include human users).

Typically, a widget (which has not yet been played) contains only hints conveying limited information about the presented symbol (or semiotic entity or semiotic point). To present additional information, the selected widget is played (after having been assigned a player, if needed). This involves creating and presenting additional “secondary” widgets which typically include analog forms of symbols both from the ancestor tree of the primary widget and from its composition lists.

For example, a symbol representing the current friends of the user may be presented initially only via an icon on the screen which only contains the label “Friends”. Playing this widget (for example, in response to a mouse-click or voice command by a user) may entail displaying the list of the names of these friends by creating and presenting a new widget for each one of the friends in the list. Subsequently, a friend widget may itself be selected and played to present additional information about that particular friend.

Typically, additional resources must be allocated when playing a widget. For example, a new pane of window may be required to display the items contained in the friends list.

Moreover, the symbol being played may lack a form suitable for being presented. For example, it may only have a symbol identifier form or a code form. Or it may have a hybrid exploitable form containing several internal (non-exploitable) forms which need to be decoded or expanded in order to expose their informational content. Thus, playing a widget may entail decoding and expansion of symbol forms. Typically, this require the allocation of additional computational resources (such as, for example, a chunk of short-term memory to store the content of the list to be presented).

This (possibly recursive) expansion continues until either a symbol has reached a raw form, or until the available computation resources have been exhausted.

The widgets created and presented when a selected widget is played may be themselves playable (or convertible to a playable form) so that some of the other steps shown in FIG. 3 may be applied to them (e.g., filtering, playing, inclusion in a composition, etc.).

Step 413 presents the history of a selected symbol or entity. This may be useful, for example, to disambiguate or refine the meaning of a symbol, as explained later in more detail.

### Symbol Creation

Each of step in the group 420 results in the creation of a new symbol instance.

Step 421 creates a primal symbol, such as a number or a character string. For example, users may simply enter data in a special editable field, or they may speak into a microphone.

Step 422 imports a symbol from an external database (e.g., from 105 of FIG. 1A) or from the network.

Step 423 encodes a primitive symbol by representing it as the composition of existing symbols. For example, a character string representing a natural language sentence can be analyzed grammatically and converted into a more structured representation which highlights certain grammatical constituents, such as a grammatical subject and a grammatical predicate.

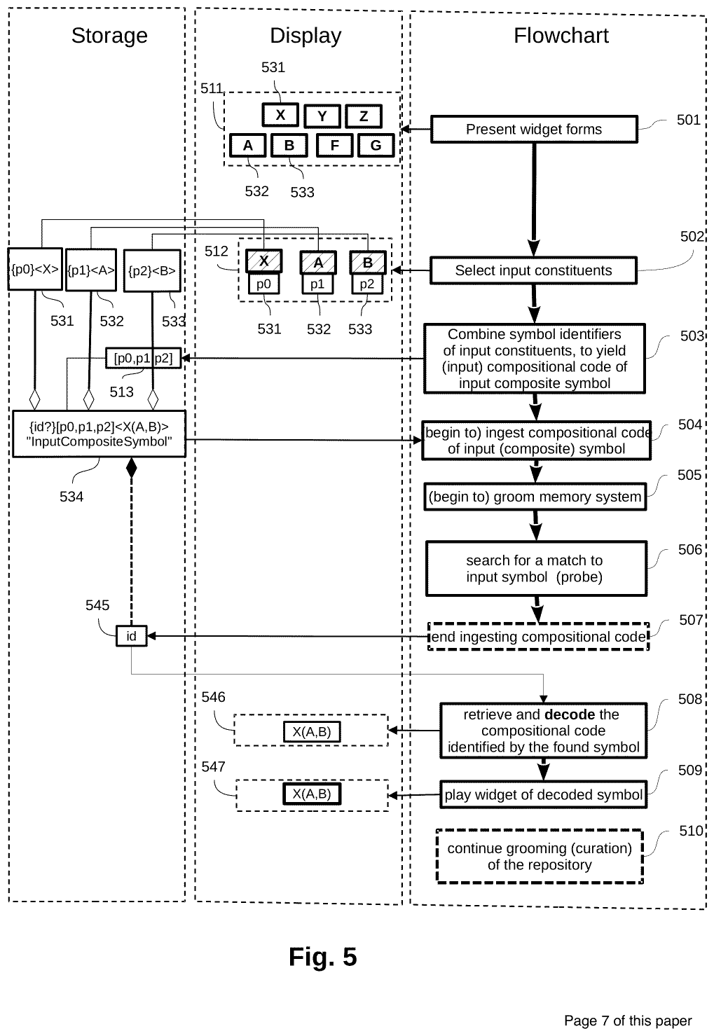

Step 424 generates a new symbol by combining a builder symbol with one or more argument symbols. For example, a symbol representing a 1-slot predicate may be bound to a symbol to yield a bound predicate representing a statement (see also FIG. 5). Step 424 is illustrated in more detail in FIG. 5.

Step 425 creates a query symbol which represents some information to be retrieved.

### Symbol Ingestion

Step 430 requests the memory system to ingest a newly created (fresh) input symbol. This typically entails searching for a match to the input ingestible symbol among the existing instantiated symbol. If the search fails, then the memory system creates and saves an instance of the input symbol. In both cases, ingestion returns an identifier for the ingested symbol.

If the ingested input symbol is a query symbol, then the memory system returns the symbols found to match the query symbol.

### Semiotic Dynamics (Semiotic Evolution)

Step 441 creates a new semiotic entity. This typically occurs when a user deems that a symbol has a meaning in the current context that identifies something new, or something that needs to have a different representation (e.g., a more refined representation or a more consolidated representation). A new semiotic entity can also be a semiotic sub-entity of an existing semiotic entity.

Step 442 extends an existing semiotic entity by “using” (or referring to) its representative symbol. The semiotic history of the extended semiotic entity gains a new semiotic point. Typically, a semiotic entity is extended when the current meaning of its representative symbol is recognized to be the same (or substantially the same) as its most recent meaning.

Step 443 rewinds an entity so that an earlier usage of its representative symbol can be recalled and used to specify a meaning other than its most recent meaning. Rewinding may result in the creation of a semiotic sub-entity.

Step 444 recognizes that the points in a thread represent signification events conveying the same (or approximately the same) meaning and generates a cluster symbol to represent these approximately equivalent points.

Step 445 updates the state of a dynamic or time-varying underlying entity (e.g., a real-

world entity) by appending a new symbol to the symbol history of its corresponding semiotic entity, wherein the new symbol represents the current state of the underlying entity.

Step 446 refines the meaning of a semiotic entity, for example by replacing its representative symbol with a new symbol that includes annotations/descriptors about the underlying entity.

Step 447 spins off a sub-entity from a semiotic entity; the sub-entity may be represented by a tighter representative symbol which is pertinent for the points of the semiotic sub-entity but not necessarily for all the points of the original semiotic entity.

Step 448 joins two semiotic entities having similar or related meaning, which may result in a coarser semiotic entity (fuzzy-reconciliation or merge-reconciliation).

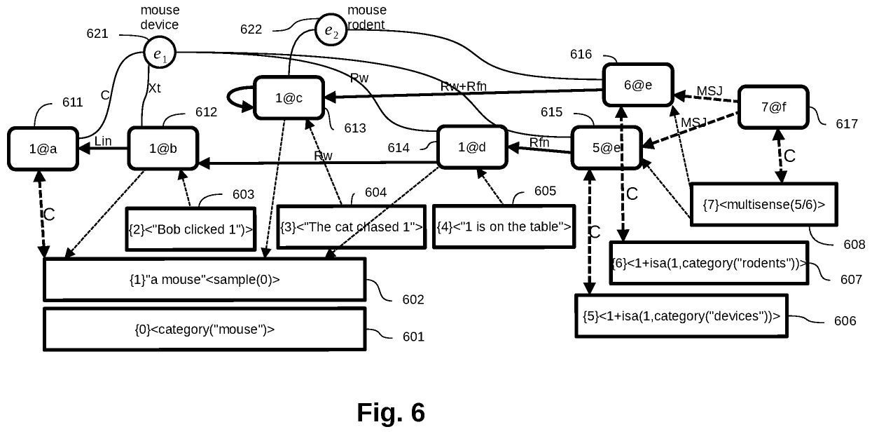

Step 449 detects two distinct incompatible meanings of a symbol and creates a reconciler symbol representing a boundary between two distinct semiotic entities, each semiotic entity corresponding to one of the two meanings. The boundary symbol contributes to the definition of the meaning associated with each one of the two segmented semiotic entities (see for example 608 in FIG. 6) (conflict reconciliation).

Step 450 recognizes that a plurality of symbol occurrences in a plurality of composite symbols have the same (or approximately the same) meaning and unifies these composite symbols, creating a coherent aggregate symbol.

Step 451 consolidates the compositions realized by a semiotic entity into a consolidated representative symbol that combines and summarizes gathered information pertaining to the underlying entity.

Once any of these steps has completed, control returns to the “choose action” step 403, which can either select a new step or end the session (404).

### 1.3.2 Memorizing an Input Composite Information Element (FIG. 5)

FIG. 5 illustrates steps (shown in the rightmost column “Flowchart”) performed to memorize an input information element, which is sometime referred to as semiotic target, to indicate that the user has a meaning or referent for which it seeks a representation. An input composite symbol is constructed by a user (or semiotic master) interacting with the disclosed memory system to represent said semiotic target.

In step 501, the memory system presents a plurality of widget forms to the user. In the example shown in FIG. 5 these presented widgets are depicted in the middle column “Display” as a group 511 containing seven widgets labeled with the letters X,Y,Z,A,B,F,G.

In step 502, the user selects a plurality of input constituents to be used as the ingredient for constructing a new symbol designed to represent the semiotic target. In the example shown, the selection of the user, 512, consists of the three symbols 531,532,533, that is, <X>,<A>,<B>, whose identifiers are {p0},{p1},{p2} respectively (each identifier is shown below the corresponding widget in 512).

At step 503, the symbol identifiers of the input constituent symbols are combined, to yield the input compositional code of the new composite input symbol (the “ingestible” symbol); in the example shown in FIG. 5, this input compositional code 513 is: [p0,p1,p2].

The left of FIG. 5, “Storage”, depicts the symbols 531,532, 533 selected by the user, whose ids are p0,p1,p2 (and whose widgets are shown in 512) and the resulting composite symbol 534. These 4 symbols form an elementary compositional graph, where 531,532, 533 are the parent nodes of the child node 534. The {id?} in 534 indicates that this ingestible symbol is currently unidentified.

Step 504 begins the ingestion of the symbol created at step 503, which may entail the beginning of a memory grooming step 505.

As a part of ingestion, a search for a match to the input symbol 534 is undertaken (step 506). If the search is successful, the identifier (545) of the matching symbol is return (step 507). If not, an instance of input symbol is created in the memory system and the new resulting identifier (545) is returned when the ingest step terminates (step 507). The search for a match to the input symbol may recursively entail the search for other symbols, such as the constituents of the input symbol so that in general step 506 is applied to a plurality of searched symbols.

At later time, the symbol 534 may be recalled (by using its identifier 545 as input signal) and decoded (step 508) into body form (exploitable form) (546). A widget may then be created (step 509) and presented to the user.

Step 510 indicates the continuing grooming phase.

### 2 Digital Structures and Multiform Symbols

### Digital Structures, Symbols, Symbol Occurrences

This section describes general properties of different types of digital structures along with their symbolic function. Digital representations of information, ultimately consisting of sequences of 0's and 1's, are herein referred to as digital structures and the piece of information conveyed by a particular digital structure is referred to as an information element or information bundle.

A digital structure in a memory system fulfills the function of a symbol. According to a common definition, a symbol is a signifier which indicates, signifies or is understood to represent an idea, object or relationship known as the referent or meaning of the symbol.

A human user or other type of agent capable to establish the connection between a symbol and its referent is called a semiotic master.

A semiotic slave, such as the disclosed memory system, relies on a connected semiotic master for assigning a meaning to symbol occurrences. Information elements are accessible only by a semiotic master; a semiotic slave has access only to the symbol occurrences.

A digital structure is materialized in a specific chunk of memory cells inside the memory system; the term materialized digital structure refers to that specific chuck of memory cells containing that bit sequence. Thus, multiple occurrences of the same bit sequence correspond to distinct materialized digital structures.

### Information Elements and Information Bundles

The terms “digital structure”, “information element” and “information bundle” are used herein very broadly and range from simple objects such as numbers, names and words, to complex and structured objects such as natural language expressions, lists, tables, documents, emails, images, etc. Simpler information structures (numbers, names, words) are more naturally referred to as information elements whereas more complex information structures (tables, documents, etc.) are more naturally described as information bundles.

### Contexts, Sessions

When a memory system is operated over an extended period of time, or when multiple memory systems interact with each other and with multiple users, symbols occur in a plurality of distinct contexts and the instantaneous (atomic) meaning of a symbol typically depends on the context in which it occurs.

Consecutive sessions entered by a user or agent with a memory system usually give rise to distinct contexts; a session involving distinct users or memory systems may contain a distinct context for each user and each memory system.

A context is a coherent frame; in a coherent frame, two occurrences of a symbol are assigned the same referent or meaning regardless of the particular form (symbol identifier, exploitable form, symbol code, widget, etc.) in which the symbol occurs.

### Endogenous and Exogenous Symbols

A memory system typically contains occurrences of both endogenous symbols, created by the memory system itself, and exogenous symbols originating from an external source and imported into or referenced by the memory system.

The meaning of an exogenous symbol in a context within the importing system may be different from its “intended” meaning in the system which has created the symbol.

### Symbol Forms

FIG. 3 illustrates several types of symbol forms used by embodiments of the disclosed invention: digital symbolic structures 310, also referred to as digital exploitable forms; compositional codes 330; symbol identifiers 320; semiotic point 340; static (non-playable) widgets 360; and playable widgets 370. All these forms are digital (302), except for widgets which are analog (303).

Instances of these forms in the memory system are illustrated by the example of FIG. 1: the integers {1},{2},{3},{4} and {5} (row 113 in FIG. 1) are the symbol identifiers (320) of the five symbols labeled respectively as 121,122,123, 124 and 125; <X>, <Y>, <A>, <B> (row 111 in FIG. 1) depict four exploitable forms (310) of the symbols identified as {1},{2},{3},{4}; [1,3,4] (row 112 in FIG. 1) is a compositional code (330) of the symbol {5}, indicating that this symbol can be composed by applying the builder symbol {1}<X> to the arguments {3}<A> and {4}<B>. Analog widgets 303 (row 116 in FIG. 1) are shown as being materialized inside the output module 104 the widget for {5}, X(A,B), presents the result of executing the builder <X> (312) to the arguments <A> and <B>.

FIG. 3 illustrates how a multiform symbol 301 relates to its possible forms, which are shown as being organized hierarchically. At the bottom level of this hierarchy, a multiform symbol (301) is embodied by an exploitable form, that is, a symbolic structure (310) that directly conveys information or a meaning which can be accessed outside of the memory system (e.g., within a connected semiotic master) without the assistance of the memory system. The primary symbolic structure (exploitable form) of a multiform symbol is sometimes referred to as its body or primary body.

Symbol forms at the next two levels, symbol identifiers (320), which can be either permanent or transient, and compositional codes (330) are internal symbol representations (304) used by the memory system. Compositional codes are obtained when existing composable constituent symbols are composed together to yield a composite symbol, or when a (possibly exogenous) symbolic structure is analyzed and decomposed into existing symbols to expose its internal structure or to reduce its memory footprint (compression).

At the fourth level, symbols are embedded in a semiotic space whose points (340) identify signification events which, for example, may be defined by (a pair consisting of) a signifying symbol plus the context in which the symbol was referenced or created; hence semiotic points, which can sometimes be viewed as symbol references, represent the instantaneous context-dependent meanings of symbols.

Semiotic points with similar or slowly varying meaning are grouped into semiotic entities (350), which therefore specify symbol histories. Semiotic points and semiotic entities are types of semiotic forms (305).

Symbol forms at the two top levels, static widgets (360) and playable widgets (370) are analog structures (303) and their purpose is to enable a user to interact with the symbols and to enable external communication and action in general. Interactive (playable) widgets (370) can be distinguished from purely sensorial static widgets. Widgets are a type of effective forms (306).

### Multiform Symbols

A multiform symbol (301) is a symbol whose occurrences may be in one or more semantically equivalent forms, referred to as the forms of the symbol. Thus, two occurrences of distinct forms of the same symbol have necessarily the same instantaneous meaning when occurring in the same context or, more generally, in the same coherent frame. For example, a symbol having 1) an exploitable form, 2) a compositional code form and 3) a symbol identifier form may be instantiated into any of these three forms without affecting the conveyed meaning.

As a more specific example, consider the information element consisting of the sequence of N consecutive integers from k to k+N−1 (a mathematical object). (1) An application may need to represent this mathematical object by means of an exploitable form given by an array of length N containing 32-bit representations of these numbers. The total length of an instance of this form would be N*32 bits. (2) The memory system may encode this array by recording the first element of the array, its length and a pointer to a routine which creates the exploitable form described above from these two pieces of information. This code would require 2*32+64=128 bits, assuming the pointer can be represented with 64 bits. (3) Finally, a third form is given by a pointer (requiring a total of 64 bits) to a record that holds the code in (2) or the array in (1) These three forms are considered to be semantically equivalent representations of the same information element.

The aforementioned routine which produces an exploitable form from the array parameters is an example of a builder (312 in FIG. 3), which is a type of computational form (315 in FIG. 3).

### Form Declarators

The notations <B>, {i} and [c] are used to indicate an exploitable form, an identifier, and a compositional code respectively; the notation {i}[c]<B> indicates that [c] and <B> are respectively a compositional code and an exploitable form of the multiform symbol identified by {i}.

The notation $s (on its own) indicates a multiform symbol (without specifying any particular form).

The notation $s may also be used to indicate an unspecified form of a multiform symbol. The notation $s:{i}[c]<B> indicates that {i},[c], and <B> are all forms of $s.

The notations $,{ },{ },< > are form declarators which define the type of form; they are

quite useful to differentiate these forms from text.

By convention, only one enclosing declarator is allowed and all nested forms are written without a declarator. For example if $X, $s1 and $s2, are a builder symbol and two argument symbol, then the exploitable form obtained by applying the builder to the argument would be denoted <X(s1,s2)>.

A symbol having an identifier is said to be identified.

An identified symbol is said to be permanent if it has a permanent symbol identifier.

A symbol for which an identifier has not yet been allocated is called a fresh symbol.

A symbol is said to be transient if it never becomes associated with a permanent symbol identifier.

A symbol may be associated with a local identifier which is unique only within a restricted context (for example within a session).

For multiform symbols permanently stored in memory and having a permanent symbol identifier, the notion of symbol identity applies. For implementation reasons, typical embodiments of this invention treat two symbols with distinct permanent identifiers to be always distinct symbols, even though these symbols are otherwise identical to each other. This amounts to a unique-name assumption (UNA) applied to symbols, as those skilled in the art may recognize.

It is normally assumed that a memory system can transform one symbol form into any other form of the same symbol if the symbol is endogenous, that is, if the memory system has created the symbol. This is not generally the case for exogenous symbols; for example, a memory system may reference an exogenous system by its foreign symbol identifier without necessarily having access to its full definition.

### Topological Relations

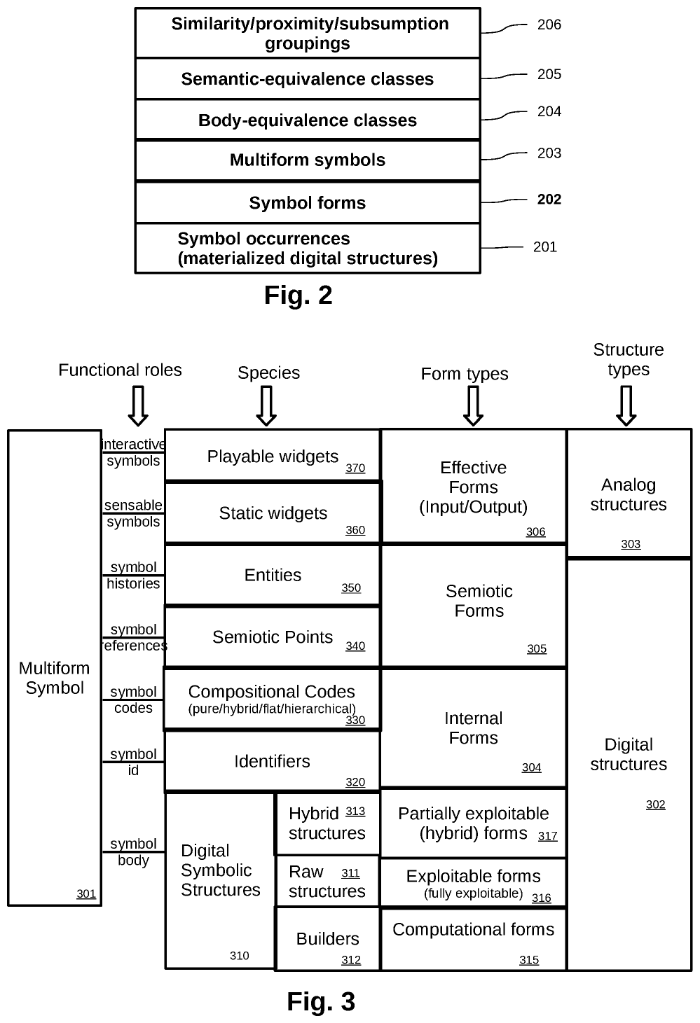

As shown in FIG. 2, symbols, symbol forms and symbol occurrences can be organized hierarchically according to semantic equivalence, proximity, subsumption and similarity relations.

As an example of symbol occurrences (layer 201 of FIG. 2), the symbol 125 in FIG. 1 occurs in the memory system as the compositional code [1,3,4] being stored in some memory record; as an additional example, the symbol 121, having symbol identifier {1}, occurs in the first slot of said compositional code [1,3,4] as an integer symbol identifier. The same symbol 121 also occurs as a defining primitive symbol in some record of the memory system.

A symbol form (sitting at the next level of the hierarchy, 202 in FIG. 2) can be viewed as an equivalent class of symbol occurrences in which two occurrences are considered to be equivalent if they have the same low-level representation, e.g., if they have the same bit sequence or if they have the same visual appearance. For example, the two occurrences of the symbol identified by {1} in the two compositional codes [1,3,4], [1,7,9] are of the same form because the symbol is represented by the bit-sequence representing the integer 1 both in [1,3,4] and in [1,7,9].

In turn, a multiform symbol (sitting at the next level of the hierarchy, 203 in FIG. 2) can be viewed as a class of symbol forms which are assigned the same referent or meaning by construction when occurring in the same coherent frame.

Multiform symbols can be further grouped into semantic equivalence [SEMEQ] classes containing multiform symbols which are semantically equivalent to each other even though their symbol forms are not the same. This is the case, for example, for two identical copies of a symbol stored permanently in two different memory locations and which differ only in their symbol identifier form.

As another example, two symbols characterized by the same exploitable form (body), which are said to be body-equivalent (BODEQ), are also considered to be semantically equivalent. For example, body-equivalence (BODEQ) occurs when a symbolic structure is initially stored as a primitive symbol and is then encoded and stored again as a code-bearing symbol: the defining body of the initial primitive symbol and the decoded body of the code-bearing encoded symbol are identical and the two symbols are body-equivalent and therefore semantically equivalent.

Two distinct multiform symbols belonging to same equivalence class are said to be formal mutations of each other (differing in a formal aspect rather than a substantial one).

Finally, two non-equivalent symbols can be compared according to a semantic distance; for example, a pair or synonymous or related words, such as (“cat”, “feline”) or (“drink”, “beverage”) are considered to be semantically similar in that they have the same or similar instantaneous meaning in some contexts.

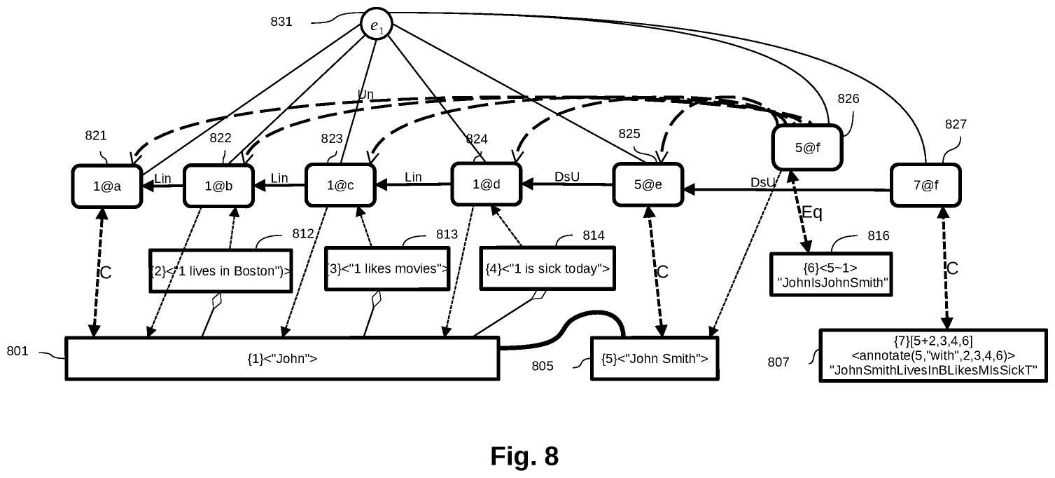

Similarity between symbols can be declared by a user (either human user or a machine agent) by means of a suitable builder. For example, in FIG. 8, node 816 declares the symbols <“John”> and <“JohnSmith”> to have the same meaning. This is reflected in the topological link between 801 and 805.

Even though assessments of similarity are often highly subjective, they can be nonetheless useful, provided their subjective nature is taken into account.

In fact, whereas the scope of certain topological relations is global, similarity judgements expressed by a user have typically local scope and may be restricted to the contextual frame in which they have been emitted. For example, 816 of FIG. 8 has a scope which is limited to the enclosing session and may have to re-asserted in order to be application in a broader scope.

Some embodiments determine the similarity between composite symbols recursively, that is, by first determining the similarity (or proximity) between constituents and then by combining these constituent comparisons by a suitable formula.

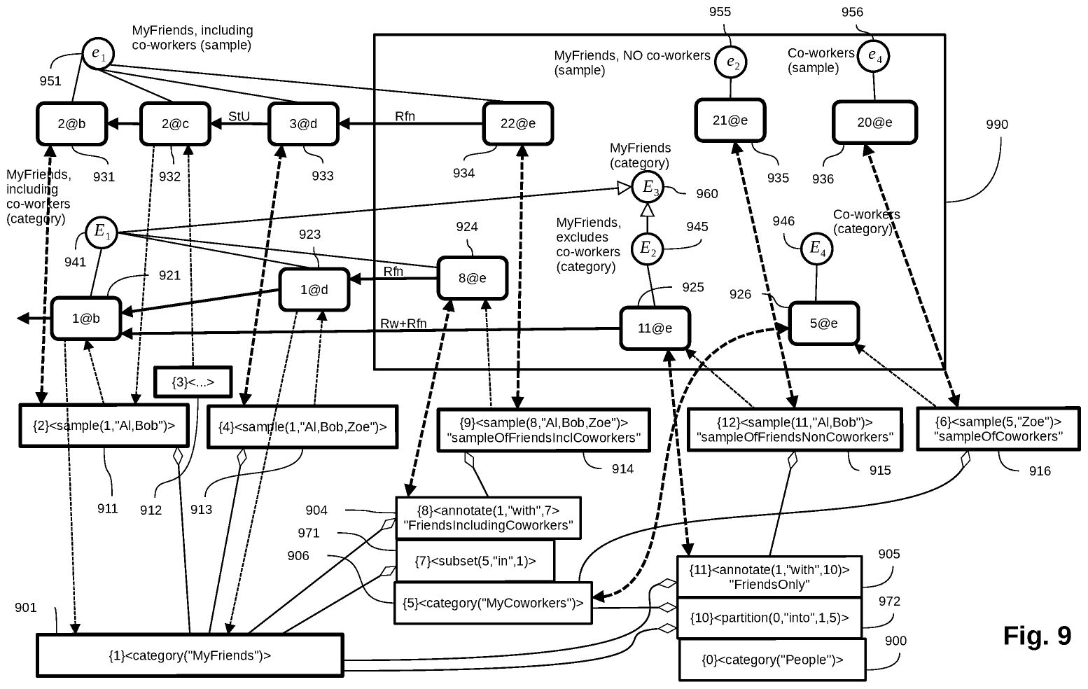

Aggregate symbols, such as descriptive symbols obtained by grouping annotations about a featured symbol (e.g., 807 of FIGS. 8 and 905 of FIG. 9) can be compared by calculating the overlap between these two sets (e.g., the number of common constituents).

According to another aspect of this invention, asymmetric distances are used for comparing symbols and for search relaxation, that is, to generalize the search for an exact match to a search for an approximate match. A distance used for search relaxation may be asymmetric because in a particular context one symbol may be substituted for another but not vice-versa. For example, when searching for a sample of the category “animal”, this category may be replaced by the category “cat” but not vice-versa.

A particular type of asymmetric topological relation is the subsumption relation which exists, for example, between a first descriptive symbol and a second descriptive symbol which is a superset of said first descriptive symbol. Indeed, adding more features to a first descriptive symbol yields a second descriptive symbol which entails the first one. However, the subsumption relation must be semiotically confirmed by a semiotic master because the new features may modify the meaning of the existing features.

Containment relaxation consists in replacing a descriptive symbol with a superset of it and corresponds to an asymmetric overlap distance. When used during search, an overlap asymmetric distance yields both super-matches (the found symbol contains more features) and sub-matches, or partial matches (the found symbol lacks some features).

Whereas super-matches are typically valid matches to a searched symbol, a sub-match is treated by embodiments of the disclosed invention by creating an inferential link which “opens” a path for a subsequent inferential search.

### Primal Symbols, Metric-Based Similarity

Certain types of data, such as numerical values and numerical tuples, physical and geometric quantities, etc., live in spaces equipped with a natural distance function which enables the comparison between elements, resulting in proximity relations. Symbol referring to these information elements may import this natural metric and are henceforth called primal symbols. The spaces to which they belong are called primal spaces.

For example, the symbols “2020” and “2021” can be determined to be similar to each other (based on their proximity) and their distance can be quantified exactly based on the metric structure of their mathematical referents (2021−2020=1).

In addition to symbols referring to mathematical objects (and other conceptual objects pertaining to other scientific disciplines), which are generally available for most applications, certain specific applications may naturally introduce domain-specific primal spaces.

For example, applications manipulating character strings (such as natural language processors) may introduce natural metrics on the set of character strings based on application-specific edit distances.

As another example, geographic-information-systems (GIS) may introduce primal spaces of various sorts based on the natural geographic distance between places.

### Semiotic Invariance

Often, the symbols of a primal space are, or can be regarded as being, semantically or semiotically invariant, that is, their meaning can be considered to be independent from context. This is generally the case for mathematical symbols.

Considering certain types of symbols as being invariant stems often from an application-level deliberate decision to restrict the contexts in which these symbols occur.

### Exploitable Forms

At the bottom level of the symbol forms hierarchy (FIG. 3) we find exploitable forms, also called symbolic structures (310), because of their intrinsic symbolic nature; that is, an exploitable form is capable of directly conveying a meaning or a piece of information to the external environment without the need of any intervention by memory system (contrary to symbol identifiers 320 and compositional codes 330 which need to decoded by the memory system in order to communicate a meaning to the external environment).

The most basic exploitable forms are given by character strings representing, for example, natural language expressions such as <“The cat chased the mouse”>, which can be readily interpreted by a semiotic master such as a human agent or by an artificial natural language processor. Character strings can also be used to represent mathematical entities, such as the number <“2”> or a list of numbers <“{2,3,4}”>.

In embodiments where the memory system communicates with an application engine (106 of FIG. 1), any structure that is meaningful to or usable (exploitable) by the application engine 106 is considered to be an exploitable form. (The application engine is a semiotic master in this case).

Consider for example an application, written in the Java programming language, that assists people to store and organize their personal information, and which communicates with a memory system (of the type disclosed by this invention) in order to memorize personal information entered by one or more users. This Java application may build instances of a “Category” Java class and a “File” Java class representing the categories created by a user to organize user's information and the user's personal computer files. These Java class objects are examples of exploitable forms that the application engine can use without assistance of the memory system (the application engine may even have created and begun to use these symbolic structures before being hooked up to a memory system).

Exploitable forms (such as the strings <“The cat chased the mouse”> and <“{2,3,4}”> of the above examples) that do not contain internal forms of the memory system are said to be raw (or pure) exploitable forms (311).

On the other hand, more complex exploitable forms, such as digital structures created by object-oriented programming languages may contain internal forms of the memory system. These structures are called hybrid symbolic structures or hybrid exploitable forms (313) and are only partially exploitable (317) outside of the memory system. In order to become fully exploitable, the memory system needs to intervene to decode or expand the internal forms contained in the hybrid symbolic structure.

For example, a category Java object created by the application of the previous example (representing for example the category “vacation pictures”) may be used to create a category sample symbol representing a list of files belonging to that category, e.g., all the files containing pictures shot during a particular vacation trip. These files could be represented either by actual file paths (character strings) or, in order for example to reduce the memory footprint of the category object, by the internal symbol identifiers that the memory system uses to represent these files. In the former case the category sample object would be a pure (or raw) exploitable symbolic structure (311,316) whereas in the latter case it would be a hybrid symbolic structure, 313 (only partially exploitable, 317).

### Variable-Complexity Adaptive Representations

Hybrid symbolic structures are crucial for optimizing computational performance in that they enable variable-complexity adaptive representations, as the example above illustrate. Playing a widget for example, requires transforming a representation requiring few computational resources into a representation requiring more resources (just-in time symbol decoding).

### Information Elements and Information Bundles

Is it often convenient to conceptualize information as being composed of discrete elements called information elements. Arbitrarily complex chunks of information may be referred to as information bundles to differentiate them from simpler information elements, even though there is no crisp distinction between the two and the same thing could be regarded as both an element and a bundle depending on the context.

For example, a message (e-email or paper mail) can be regarded as an information bundle which contains several components each representing an information element: author, recipient, date, the body of the message, etc. An email message may also be considered an information element of a larger information bundle, for example, when it is embedded in an extended email conversation or when it is stored along other email messages in an email archive file.

### Builders and Compositional Expressions

In agreement with the compositional structure of information, symbols are also typically

constructed by composing simpler symbols. To this goal, typical embodiments of the disclosed memory system contain executable digital structures (or computational forms 315) called builders, 312, that comprise instructions executable by the processor 107 (FIG. 1), apt to construct digital symbols from existing instantiated symbols.

An executable structure <X>, represented by a builder symbol $X, when applied to the an appropriate list of argument symbols $p1, . . . , $pN, yields a decoded symbolic structure, denoted by the compositional expression <X(p1, . . . , pN)>, wherein $p0, . . . , $pN are referred to as the parents or constituents (or direct ancestor) of the composed symbol, and wherein the composed symbol is referred to as a child or composition (or direct descendant) of its parents.

The form of the parent symbols in the compositional expression <X(p1, . . . , pN)> is arbitrary (a parent could be specified by a symbol identifier, an exploitable form, a compositional code, etc.) as a builder may process symbol forms of different types.

The degree to which a builder is externally exploitable, that is, independent of the memory system that contains it, varies. Some builders, such as a routine that concatenates a list of strings, may simply manipulate raw structures in a way that is totally independent of the memory system. Other builders may comprise instructions to dereference identifiers and to decode compositional codes and are therefore heavily dependent on the memory system. Thus, an exploitable form of a builder symbol could be raw or could be hybrid.

In some embodiments, a builder corresponds to a constructor of an object-oriented programming language. For example, the memory system may build the symbolic structure <category(“people”)> consisting of an instance of the “Category” class. This object is the result of executing a “category” builder on the character string “people”. If the programming language used is Java, then <category(“people”)> would be an instance of a Category Java class.

Builders can be applied repeatedly to generated more complex structures (for example, more complex Java objects) such as: <sample(category(“people”), “Sally”,“Sam”)>, which represents a pair of people named Sally and Sam. Expressions such as these are referred to as compositional expressions.

Sometimes builders are used to specify the nature of a symbol, for example <string(“people”)> explicitly declares a string symbol (as opposed to <category(“people”)>), so that one can state more cleanly: <string(“people”) “has six letter”>. Similarly, one could have <math(“2”)> (the number 2) and <string(“2”)> (the string “2”).

### Internal Forms (Identifiers and Compositional Codes)

Differently from symbolic structures, internal forms generated by the disclosed memory systems, which includes symbol identifiers and compositional codes, do not have a meaning which is directly accessible outside of the memory system and must be somehow dereferenced, decoded or expanded by the memory system that created them in order to expose their meaning and to deliver their information load.

Internal forms occurring in the memory system which generated them are said to endogenous. A memory system may also comprise exogenous internal forms imported from another memory system.

### Symbol Identifiers, Defining Forms

A unique symbol identifier is allocated by the memory system for every new instantiated symbol, which is typically saved by the memory system. Recall that two symbols with distinct identifiers are considered to be distinct (that is, not equal to each other).

A symbol identifier is often also a symbol locator by which the memory system can retrieve a record that contains the defining form of the symbol, namely the form providing the data that defines the symbol.

A symbol identifier that points to a defining form is said to be the primary symbol identifier; it is said to permanent if the defining form is stored long-term. Normally, the memory pointers to the records containing the defining forms of the symbols stored long-term are used as permanent and primary symbol identifiers. In some embodiments, defining forms are stored in a list of arrays (called slices) and the permanent symbol identifier is a pair of integers, where the first integer identifies a slice, and the second integer identifies a slot in the slice.

Some embodiments use a fixed-length identifier, such as 32-bit, 64-bit or 128-bit integer index which is incremented by one each time a new symbol is memorized. If the identifier is sufficiently wide (the width being its bit-length) then it can be used for long-term or even perpetual storage, with no need to ever delete a symbol, provided sufficient storage resources are provided.

### Symbol Immutability

For the sake of safety and simplicity of implementation, the defining form of a symbol is normally required to be immutable in the strongest possible way. Indeed, since a symbol may be used to construct other symbols, allowing a symbol to be modified or deleted would affect all symbols depending on it in a way that may be hard to characterized: Mutating a symbol would invalidate all of its children. Immutability of defining forms corresponds to immutability of the ancestor-subtrees of the memory graph.

### Symbol Identifiers within a Distributed Memory System

In embodiments where a plurality of memory systems share their symbols (see for example FIG. 1C) a symbol identifier normally contains an identifier for the particular memory system or storage device, so that the identifier remains unique within the global memory system.

### Symbol Identifiers within a Session

Within the computational context defined by a particular session, a referenced or newly created symbol may be assigned an additional identifier which specifies the order in which it was referenced or created during the session. This session-embedded identifier should be complemented with an identifier of the session in order to yield a globally unique identifier.

### Dereferencing Operator

The defining form identified by a symbol identifier {i} is denoted *i, where * is a dereferencing operator. For primitive symbols, the defining form *i is a symbolic structure <B> referred to as the defining body of the primitive symbol. It may also be denoted as <!B> to emphasize that <B> is the defining form of the symbol.

For code-bearing symbols, *i is the defining compositional code [c] which can be decoded by the memory system into a symbolic structure <S>, referred to as the decoded body of the symbol.

Normally, a memory system can dereference only endogenous identifiers; exogenous identifiers can normally be dereferenced only the memory system which created it.

A memory system only needs to store either <B> or [c] but may decide to cache the other one to speed up computation.

### Ingestors and Identificators

A procedure or method that assigns a symbol identifier to a symbol $s is called an identificator. In embodiments of this invention, the identification function is typically carried out by an ingestor, denoted by the map s→i(s); the identifier assigned to an ingestible symbol $s is denoted {i(s)}.

An ingestor assigns an identifier to an ingestible symbol in one of two ways: either by determining that the specified ingestible symbol is equivalent or sufficiently similar to a symbol already instantiated in memory (symbol recognition); or by creating a new record to hold the defining form of the ingestible symbol.

The following holds true:

*i(s)=s,

that is, once the symbol $s has been instantiated in the memory slot {i(s)}, it can be retrieved by the dereferencing operator *.

### The Standard Codec

Once an ingestor is given, it is possible to transform a compositional expression <X(p1, . . . , sN)> into a compositional code by means of the standard compositional recursive encoder, which simply ingests the builder and each argument and then concatenates the resulting identifiers:

std_encode(<X(p1, . . . , pN)>)=[i(X),i(p1), . . . , i(pN)]=[i0, i1, . . . , iN]

where {i0}, . . . , {iN} are the symbol identifiers of $X, $p1, . . . , $pN respectively and where each parent $pK is either a symbol identifier (in which case ingestion is not necessary), a compositional code or an exploitable form.

The standard compositional decoder, applied to a code [i0, . . . , iN], reverses the encoding map by first dereferencing each code component $ik which needs to be dereferenced (exploitable forms don't) and then applying the resulting builder to the resulting symbols, to obtain:

(*i0)(*i1, . . . , *iN)=X(s1, . . . , sN).

This decoder will be denoted by the same overloaded notation “*”, also used to indicate the dereferencing operator:

*[i0, i1, . . . , iN]=(*i0)(*i1, . . . , *iN).

In this equality, the notation “*” applied to the code [i0, i1, . . . , iN] is interpreted as a standard decoder.

A standard decoder is a standard compositional recursive decoder if it expands code components given by compositional codes. Otherwise, it is non-recursive or one-shot.

Furthermore, a recursive decoder is strongly recursive if it forces expansion of partially exploitable forms, that is, if it expands recursively internal forms contained in a code component given by a partially exploitable form.

### Code of a Primitive Symbol: the Notation [*i]

Notice that if {i} is the identifier of a composite symbol, then *i is its defining

compositional code which, by convention, is declared as such by surrounding it with square brackets: [*i]. Thus, the compositional code of a composite (or code-bearing) symbol having identifier {i} is [*i].

The notation [*i], however, is not applicable as such when {i} identifies a primitive symbol because, in this case, *i is a symbolic structure, not a code. For the purpose of generalizing the notation [*i], it is therefore convenient to treat a permanent symbol identifier as a special “locator code” which the system can “decode” by simply retrieving the content of the memory record identified by {i}.

In other words, a primitive symbol {i}<!B> is assigned a “locator” code denoted [i] so that the notation [*i] can be extended to primitive symbols by equating it to [i] on primitive symbols.

That is, if *i is primitive then by definition its compositional code is i. With this convention, the notation [*i] always represents the defining compositional code of the symbol identified by {i} both when *i is a composite symbol and when *i is a primitive symbol.

Notice also that, by adopting this convention, codes have length greater or equal to one. If the code length is equal to one, then the code is an identifier, the symbol is primitive and is obtained by simply dereferencing this identifier. If the code length is at least two, then the symbol is composite, the first entry of the code is the identifier of a builder, and the decoded composite symbol is obtained by applying this builder to the remaining entries of the code.

### Additional Multiform Symbol Notations

Recall that the notation {i}<B> is used to indicate that the symbolic structure <B> is a body (primary or not) for the symbol identified by {i}.

The notation {i}<!B> indicates that <B> is the defining (primary) body for the symbol {i}.

Another notation is {i}[!]<!B> or {i}[i]<!B> which further indicates that there is no defining compositional code (except for the length-1 locator code), hence that this symbol is a primitive symbol.

The notation {i}[!c] indicates that the compositional code [c] is the defining form of the symbol identified by {i}, hence that this symbol is composite.

The notation {i}[!c]<B> indicates that {i} has defining form [c] and decoded body <B> (hence <B> is obtained by decoding [c]).

To summarize, a primitive symbol $s is defined as either {i}[!]<!B> or {i}[i]<!B>, and a composite symbol as {i}[!c]<!> or {i}[ !c]<+B>. To indicate that $s has multiple codes and bodies the following notation is used;

$s:{i}[!c0][c1] . . . [cN]<!B0><B1> . . . <BN>.

All of the above form components are optional, a multiform symbol can have just one form. A missing form component can be indicated with an empty bracket. For example, { }[ ]<!B> and { }[!c]< > would be respectively an unidentified primitive symbol and an unidentified composite symbol; and {i}[ ]< > would be an unassigned symbol identifier which could represent, for example, an empty symbol memory cell.

### Compositional Codes and the Compositional Memory Graph

A compositional code of a symbol is a structural representation of the symbol that makes explicit its relationships with its constituents (parents). Different types of compositional codes are listed in 330, FIG. 3 (pure, hybrid, flat, hierarchical).

A directed compositional memory graph is obtained by introducing a node for each symbol and an edge from each node to each one of its parents (if any). The compositional graph containing the symbols stored in a memory system is a directed acyclic graph whose nodes are labeled with the symbol identifiers of the symbols (or with another symbol form if an identifier is not yet available).

A node corresponding to a composite symbol has a directed (downward) edge to each one of its constituents (parents) and each edge is labeled with an integer indicating the position of the constituent in the primary compositional code of the composite symbol.

A node corresponding to a primitive symbol is a root node (it has no parents).

Note that every node has typically multiple children (direct descendants) since its underlying symbol is typically referred to multiple times.

### Flat and Hierarchical (Non-Flat) Codes

A code containing only identifiers, such as the code produced by a standard encoder is called a flat code.

A code which contains nested codes in addition to identifiers is called a non-flat or hierarchical code.

A flat code contains (the identifier of) only one builder whereas non-flat codes contain (the identifiers of) two or more builders.

A hierarchical (non-flat) code is said to be a hybrid code if it comprises symbolic structures (exploitable forms); it is said to be a pure code if it does not contain exploitable forms, so that a pure code contains only identifiers and other pure codes.

### Slices

In some embodiments, the long-term storage is organized into slices and a permanent symbol identifier identifies both the slice and the incremental position within the slice.

Partitioning symbols into slices has several advantages. Symbols used only by a particular application could be stored in one or more slices which are not loaded in memory except when this application is in use, thus reducing the need for live memory resources.

For example, a memory slice could be used for holding all the information about the computer files of a particular user and could be loaded in short memory only when the user needs to access or update information about his/her files.

Another advantage is that a slice may contain symbols having some features in common which could be represented only once in a header of the slice (thus leading to a reduced memory footprint).

A slice may be dedicated to hold symbols of the same primal space (e.g. character strings or numbers) and the slice could integrate functionality for searching. Sensitive information could be stored in an encrypted slice.

### 3 Linguistic Symbols

Natural language expressions, ranging from primitive constituents such as words, to larger constructs such as phrases and sentences, can be viewed as symbols which humans (as well as machines endowed with natural language processing capabilities) use to represent, memorize, and communicate information.

A complex natural language expression can be analyzed into smaller constituents and, conversely, simple natural language expressions can be combined to yield more complex expressions.

Mimicking this compositional structure of natural languages, some of the multiform symbols utilized by embodiments of the disclosed invention can be decomposed into constituent symbols and then recombined into more complex symbols, resulting in a rich and dense “network” of symbols able to convey a broad spectrum of meanings and information elements at all scales of complexity.

Embodiments of this invention provide the means for human agents to participate in the creation of this rich vocabulary of symbols, by enabling them to both analyze natural language expression and compose the resulting constituents into more complex expressions.

Whereas several existing systems based on natural language processing are developed by automatic processing of large amounts (corpora) of text data, the memory system disclosed in this application emphasizes the direct participative role of human users in the creation vocabularies of digital symbols even from very small amounts on input data. This strategy leads to symbolic representations which are more tightly adapted to each user, hence easier to use.

### Textual Expressions

The entry point for building digital symbols based on natural languages is given by textual expressions, that is, character strings containing linguistic expressions, such as “people” and “Sally met Bob yesterday”. In this disclosure, the terms “linguistic expressions” and “linguistic symbols” range from atomic constituents such as “people” to propositional symbols representing sentences such as “Sally met Bob yesterday” to even more complex constructs (paragraphs, etc.).

Symbolic structures (exploitable forms) for the above textual expressions are denoted <“people”> and <“Sally met Bob yesterday”>. In order to underscore that these structures refer to natural language expressions and to distinguish them from plain strings, an optional <:lang> declarator builder may be used to explicitly declare them as such:
{0}<lang(“Sally met Bob yesterday”)>
   Notice that a symbol identifier {0} has been prepended for the sake of improving the clarity of this disclosure.

### Roles and Actors

Expressions such as these can be entered directly by a user into the memory system and if nothing else were done, this system would result in something similar to a common notepad for jotting down notes. A limitation of this kind of basic notepads (whether digital or material) is that each note stands by itself, none of the relationships between the meanings of these notes is captured.

For example, if more notes are added, such as <“Sally met Bill yesterday”>, <“Sally is meeting Bob now”>, there is no explicit representation in the notepad that these three notes involve the same action (“meet”) carried out by the same person (“Sally”) at different times (“yesterday”, “now”) and in different ways (“meeting Bill” vs. “meeting Bob”).

In order to overcome this limitation, this application discloses methods and systems to create reusable symbols from plain textual expressions and to encourage users to reuse these symbols.

In a typical embodiment, the memory system invites a user to analyze an existing textual expression (for example, a textual expression just entered by the user itself) so as to drive the user to recognize one or more grammatical constituents corresponding to some fragments of the textual expression; as a result, for example, the user could recognize that “Sally” plays the role of the subject in the textual expression.

The system would then create a new digital representation of the same sentence by using special actor and role symbols created by builders named “actor” and “role” respectively:
{1}<lang(actor(role(“subject”),“Sally”), met Bill yesterday”)>.
   In this composite multiform symbol, the constituent <role(“subject”)> represents the subject grammatical role and <actor(role(“subject”),“Sally”)> represent “Sally” playing the role of subject in the sentence.

The linguistic symbols {0} and {1} are considered to be formal mutations of each other (that is, they are semantically equivalent). denoted {0}˜{1}.

As an alternative to having the user create the above symbols, an automated natural language processor could be used to analyze textual expression so as to derive actor symbols and composite expressions such as the one above.

### Scripts

To better illustrate the disclosed method, consider the scripts below, which describe a sequence of multiform symbols which could be created during an interactive session between a user and the memory system.

The symbols {2}, {6}, {7}, {8} below are more likely to be precomputed and already available when the session begins.

A nickname for each multiform symbol is inserted between the symbol identifier and angle-bracket declarator
{2}“SubjectRole”<role(“subject”)>
{3}“Sally”<“Sally”>
{4}“SubjectSally”<actor(2,3)>
{5}“SallyMetBillYesterday”<lang(4,“met Bill yesterday”)>

Symbol {2} represents the “subject” grammatical role, obtained by applying the builder <:role> to the role-tag string “subject”. Symbol {3} is the character string “Sally”. Symbol {4} is an actor symbol representing Sally in the role of subject. Symbol {5} combines Sally-as-a-subject with the character string “met Bill yesterday”, therefore representing the sentence: <“Sally met Bill yesterday”>.

Notice that {5} is defined by a hybrid symbolic structure: <lang(4,“met Bill yesterday”>; it is hybrid because it contains both internal forms (the symbolic identifier {4}) and exploitable forms (the builder <:lang> and the character string <“met Bill yesterday”>).

A composite formal mutation of this symbol can be obtained by ingesting the string “met Bill yesterday” and the builders <:lang>, <:actor>, and <:role>:
{6}“LangBuilder”<:lang>
{7}“ActorBuilder”<:actor>
{8}“RoleBuilder”<:role>
{9}“MetBillYesterdayLang”<lang(“met Bill yesterday”)>
{10}“SallyMetBillYesterdayFact”[6,4,9]

The first three symbols of the above script are obtained by ingesting the three builders <:lang>, <:actor> and <:role> so that a symbol identifier is created for each one of them. Symbol {9} is obtained from the ingestion of <lang(“met Bill yesterday”)>. Finally, symbol {10} is obtained by composing the symbols {6} {4} and {9}, to yield a composite symbol defined by the compositional code [6,4,9], which decodes to a symbolic structure semantically equivalent to {5} (and to {0} and {1}).

Note that {0} is a purely textual (linguistic) expression. Expressions other than purely textual expressions, such as {1},{5} and {10} are called grammatically-structured linguistic expressions, or simply structured expressions.

### Virtual Actors and Virtual Expressions

An actor comprises a role and a role player; in the above example, the role is specified by the string “subject” and the role player is “Sally”. The character string “subject” is said to be a role tag.

Actor symbols can be built via the <:actor> builder by passing two arguments, a role symbol $role (or, equivalently, a role-tag string) and a role player symbol $role_player: <actor(role,role_player)>.

An actor in which only the role is specified is called a virtual actor and an expression containing a virtual actor is called a virtual expression or bindable expression. Actors and expressions which are not virtual are said to be concrete or non-bindable. An expression in which all roles are bound to a non-null actor is said to be saturated (or fully-bound).

For example:
{11}<lang(actor(role(“subject”)), “met Bob yesterday”)>
   is a virtual expression where <actor(role(“subject”))> is a virtual actor: the subject of this sentence has not been specified. A virtual actor serves as a placeholder or slot in which the actual actor playing the subject role has yet to be specified.

A virtual expression having a virtual subject role and no other virtual roles yields a unary-predicate (or 1-slot predicate).

### Binding

A virtual expression can be transformed by assigning a concrete player to its unassigned roles; this can be done by means of the <:bind> builder which replaces a virtual actor with a concrete one.

One format of the <:bind> builder is
<bind(expr, role, role_player)>
   where $expr is the input virtual expression; $role is a role symbol (or a role tag) specifying the empty slot (virtual actor) to be filled and $role_player is the symbol provided to play the specified role.

For example, a formal mutation of the expression {1} defined previously can be obtained by binding the subject role of the virtual expression {11} to the subject actor {3}, to obtain (after assigning the symbol identifier {21} to the builder <:bind>):
{22}[21,11,2,3]<bind(11,role(“subject”),“Sally”)>.

Note the compositional code [21,11,2,3] of this propositional symbol: {21} identifies the builder <:bind>; {11} identifies the input virtual expression; {2} identifies the slot to be filled; and {3} identifies the slot filler.

### Complete Grammatical Decomposition

The decomposition of a linguistic expression by the transformation of its textual grammatical fragments into grammatical actors can be applied repeatedly for other identifiable grammatical roles until no grammatical fragments are left. For example, by using the roles: <verb>,<object>,<when>, one can generate the following sequence of virtual expressions which have an increasing number of virtual actors (from 1 to 4):
{23}<lang(role(“subject”), “met Bob yesterday”)>
{24}<lang(role(“subject”), “met”,role(“object”), yesterday”)>
{25}<lang(role(“subject”), role(“verb”),role(“object”), yesterday”)>
{26}<lang(role(“subject”), role(“verb”),role(“object”), role(“when”)>

For the sake of simplicity, in the above expressions, we have used <role(str)> in the place of <actor(role(str))> by assuming that these two symbols are equivalent and can be interchanged in the context of the bind builder.

A concrete expression equivalent to the original textual expression {0} can then be obtained by binding all the four roles of {26}, to obtain:
{0}˜{27}<bind(26,role(“subject”),“Sally”,role(“verb”),“meet”,role(“object”),“Bob”,role(“when”),“yesterday”)>.

This compositional expression can be made more compact by introducing yet another overloaded format of the binding builder, whereby slots (virtual actors) are filled in the order specified by the order of the arguments:
{27}<bind(26,“Sally”,“meet”,“Bob”,“yesterday”)>.

Note that the virtual linguistic expression {26} and the concrete linguistic expression {27} contain four actor symbols and no textual component (other than the irreducible symbols “Sally”, etc.).

### One-Slot (Unary) Predicates

A virtual expression with a virtual subject role and no other virtual roles yields a unary predicate (or 1-slot predicate). Other knowledge representation languages have a similar type of construct. For example, in first order logic they also called unary predicates; in OWL (Web Ontology Language) and in description logic classes and concepts (respectively) are similar to unary predicates.

The builder <:predicate>may be used to create such a symbol, for example:
{28}<predicate(#1, “met Bob yesterday”)>={28}<lang(role(“subject”), “met Bob yesterday”>
   where the #1 placeholder, within the context of the above predicate builder, is shorthand for <role(“subject”)>. The notation p(#1) is also used to denote a predicate with one slot.

When a 1-slot predicate p(#1) is bound to a subject $subj, a concrete (non-virtual) propositional symbol is obtained: <bind(p,subj)>, for example:
{29}<bind(predicate(#1, “met Bob yesterday”),“Sally”>

Note that {0},{27} and {29} are formal mutations of each other.

### Categories and Samples

Category symbols represent categories intended broadly as classes of individuals or things (or even “stuff”) sharing some common characteristics. The simplest way to construct a category symbol is by means of the <:category> builder, for example:
<category(“people”)>.
   The character string passed to this builder is referred to as the name of the category.

Categories can also be built more creatively, for example:
<category(“eats vegetables”)>.

In addition to discrete collections containing identifiable individuals, categories can also refer to non-discrete “uncountable” sets and “stuff”, for example:
<category(“water”)>.

Categories can be used to construct representations for collections of individuals, referred to as category samples, via the <:sample> builder; for example,
<sample(category(“people”),“Bill”)>
   represents a person called “Bill”. They can also be used to construct samples of stuff:
<sample(category(“water”),“one liter”)>
   represents a sample of one liter of water.

The arguments passed to the <:sample> builder after the category symbol are referred to as item symbols or item arguments or sampling arguments. In the above example a character string is used as item symbol, but many other types of symbols can be used as item symbols.

It is also possible to construct a representation of a set of individuals without specifying item symbols; for example:
<sample(category(“people”),5)>
   uses a format of the <:sample> builder that creates a set of people with five (unnamed) individuals.

Other knowledge representation languages have similar constructs. Category symbols correspond to classes in OWL; concepts in Description Logic (DL) and unary predicates in First order Logic (FOL). Sample symbols correspond to: individuals in OWL and DL and to constants in FOL. Despite these correspondences, category symbols and sample symbols are utilized more freely by embodiments of this invention and result in a more expressive representational framework than OWL, DL and FOL.

The unary predicate virtual expression symbols introduced earlier are somewhat equivalent to category symbols in that symbols composed with either one of these constructs can be naturally converted to equivalent symbols based on the other construct, for example:
<pluck(bind(predicate(“#1 is a people”),“Bill”),“Bill”)>
   also defines an individual named “Bill” which belongs to the category “people” (see later for the definition of the <:pluck> builder).

Embodiments of this invention utilize constructs to convert a category into a unary-predicate and vice-versa. If $c is a category symbol, then (c:#1) and <predicate(c)> denote the corresponding unary-predicate symbol; if $p is a unary-predicate symbol, then {p(*)} and <category(p)> denote the corresponding category symbol.

In other words, a predicate symbol can be mapped to a category and vice-versa; consider for example the category:
“AnythingEatingCarrots”<category(predicate1(“#1 eats carrots”))>
“EatsCarrotsPredicate”<predicate1(#1 belongs to category(“eats carrots”))>.

Categories are a type of symbols that have both a linguistic and a set-theoretic nature in that they form an algebra with the basic set operations (union, intersection, set-complement) and with the subset relationship. The usual set operations union and intersection apply:
“CatsAndDogs”<union(category(“cats”),category(“dogs”))
“Biped Mammals”<intersection(category(“mammals”),category(“bipeds”))>
“PeopleEatingVegetables”<intersection(category(“people”),category(“eats vegetables”))>
   and a category can be a subset of another category:
<subset(category(“persons”),category(“animals”))>
<subset(category(“water”),category(“liquids”))>.

A category may be annotated with descriptors that specify super-categories and sub-categories, to yield an annotated category, which is an aggregate symbol. Annotated categories can be related to each other by subsumption relationships, wherein the featured category is subsumed by any of its sub-categories and subsumes any of its super-categories. These subsumption relationships can be used for search relaxation.

### Two-Slot (Binary) Predicate (RDF Triple)

Two-slot predicate (or binary predicate or 2-predicate) symbols are given by a two-slot virtual expressions having a “subject” virtual actor and an “object” virtual actor and are generally denoted p(#1,#2). For example:
{30}“SubjectMetObjectYday”<lang(role(“subject”), “met”, role(“object”), “yesterday”>
   is a two-slot virtual expression having a “subject” slot and an “object” slot and represents the binary predicate defined by character string: “#1 met #2 yesterday”. An alternative equivalent construct (formal mutation) for {30} is
{31}“SubjectMetObjectYday”<predicate(#1, “met”, #2,“yesterday”)
   or:
{31}“SubjectMetObjectYday”<predicate(“#1 met #2 yesterday”)

When both slots are bound, a propositional symbol is obtained, e.g,
{32}“SallyMetCindyYesterday”<bind(30,“Sally”,“Cindy”)>
   Additional examples:
{33}“SubjectHasPasswordObject”<predicate, #1, “has_password”,#2)=<lang(role(“subject”), “has password”,role(“object”))>;
{34}“YahooAccountHasPasswordThingamajig”<bind(33,$yahoo_account,“thingamajig”)>

Other knowledge representation languages have a similar type of construct: triples in RDF databases; binary predicates in first order logic; predicates in OWL; and roles in description logic.

### The Predicator Role

The constituent string “has password” in {33} plays the role of a predicator and can be replaced by the actor symbol:
{35}“hasPasswordPredicator ”<actor(role(“predicator”),“has password”)>
   to obtain the following formal mutation of {33}:
{36}“hasPasswordPredicateMutation”<predicate(“#1 35 #3”)>.

### Templates

A template is a linguistic expression whose actors are all virtual. Consider for example the triple template:
{37}“TripleTemplate”<lang(role(“subject”), role(“predicator”),role(“triple-object”)>.
   Instances of this type of construct do not really represent any information, they simply specify a list of grammatical roles (e.g.: subject, predicator and object) hence the name “template”.

### Restricted (Virtual) Actors

It is possible to constrain or restrict the concrete actors allowed by a virtual expression by specifying a category and by requiring that only instances of that category be allowed in a particular slot. This can be done by defining a restricted virtual actor which is built by adding a restricting category to the <actor> builder's argument list, for example
{41}“PersonsAsSubject”<actor(role(“subject”),category(“persons”))>.
   The restricted actor symbol {41} stands for a subject actor slot fillable by samples of the category “persons”.

A restricted virtual expression is a virtual expression containing at least one restricted actor; for example, consider the following restricted expression containing restricted actor {41}, plus the three grammatical roles “verb”, “object” and “when”:
{42}<lang(41, role(“verb”),role(“object”), role(“when”)>
   In order for “Sally” to be allowed to bind to {42}, she must be declared to be a sample of <category(“persons”)>:
{43}“SallyPerson”<sample(category(“persons”),“Sally”)>
   so that we can now bind Sally into {42}:
{44}“SallyMetBobYday”<bind(42,43,“meet”,“Bob”,“yesterday”)>.

Some embodiments of the disclosed invention do not require a slot filler to satisfy the restriction of a restricted virtual actor and, conversely, infer that the slot filler (obtained by means of <:pluck>) does belong to the restricting category. That is, in the above example, the character string <“Sally”> would be allowed to bind even though <“Sally”> has not previously declared a sample of <category(“persons”)> and, instead, <pluck(“Sally” from 44)> could be inferred to be a sample of <category(“persons”)> thanks to the restriction on {42}.

### Extend Builder, Adjuncts

Embodiments of this invention enable users to construct more informative expressions from existing ones by means of adjuncts, which can be created with the <:extend> builder. For example:
{45}<extend(44,actor(role(“where”),“in a cafe”)>
   appends the adjunct “in a cafe” to the “Sally Met Bob Yesterday” propositional symbol {44}, so that {45} represents the “extended” sentence: “Sally Met Bob Yesterday in a cafe”.

Another path to obtain an equivalent result is by extending the template {26}:
{46}<extend(26,actor(role(“where”)))>
   so that we can say:
{47}<bind(46,“Sally”,“meet”,“Bob”,“yesterday”,“in a cafe”)>,
   which is a formal mutation of {45}.

### Pluck Builder

The pluck builder <:pluck> extracts components from a composite symbol, yielding a symbol whose meaning is in general different from the original component. Consider for example:
{51}<sample(category(“people”), “Joe”)>
{52}<sample(category(“people”), “Bill”, “Barack”)>
{53}<union(51,52)>
{54}<pluck(“Joe”, from 53)>
   The multiform symbols {51} and {54} are certainly similar (they both refer to a person named “Joe”). However, they are not semantically equivalent because the latter is likely to refer to “Joe Biden”.

### Query Symbols

Embodiments of the disclosed invention utilize special symbols called query symbols to retrieve information from the memory system. The basic building blocks to construct query symbols are atomic query symbols, each consisting of a unary predicate in which the empty slot is specially marked with a “?” notation, to indicate that the memory system is supposed to return the instantiated symbol found in the corresponding slot of an instantiated symbol matching the query symbol.

For example, the following query may be used to search for someone who “met Bob yesterday”:
{61}<predicate(?, “met Bob yesterday”)>.
   When this query symbol is ingested, the memory system may find or infer a matching symbol such as: <predicate(“Bill”,“met Bob yesterday”)> and then return (the symbol identifier of) the slot-filling symbol <“Bill”>.

An equivalent form of the query {61} can be obtained via the <:query> builder which transforms the unary predicate {31} defined earlier:
{31}<lang(role(“subject”), “met Bob yesterday”>
   into a query predicate:
{61}˜query(31).

Atomic query symbols, like predicates, can be combined with logical connectives, for example:
<and(predicate(?, “met Bob yesterday”), predicate(?, “met Bob today”)>
   may be used to search for people who met Bob both yesterday and today.

More complex queries may involve more than one match variable, which are then indicated with the notations: “?1”, “?2”, etc. For example:
<and(predicate(?1, “met Bob yesterday”),
predicate(?2, “met Bob today”),
predicate2(?1 “is friend of” ?2))>
   can be used for search for a pair of mutual friends which met with Bob yesterday and today (possibly separately).

### 4 Semiotic Spaces and Semiotic Entities

### 4.1 Semiotic Points

### 4.1.1 Instantaneous Meaning

To better understand the disclosed invention, it is convenient to distinguish between the instantaneous meaning (or point-like meaning, or interpretation) of a symbol from its extended meaning. Instantaneous meaning is what is signified by a symbol occurrence in a specific location and at a particular point in time and is represented by a semiotic point, where “point” indicates its indivisible “atomic” nature and “semiotic” indicates its signification function.

Semiotic points represent the instantaneous and localized signification events underlying communication, which is herein intended in a very broad sense and includes not only transmission but also memorization and recall of information elements. Any interaction with the disclosed memory system which includes memorization, recall, or transmission of information involves a plurality of communication events, each associated to a signification event representable by a semiotic point.

A semiotic space is a representation of all possible signification events: semiotic points are points (elements) of a semiotic space. Any object or structure that may acquire an instantaneous meaning and which may issue semiotic points is said to be an interpretable symbol, or simply a symbol, and the assignment of an instantaneous meaning to an (interpretable) symbol is referred to as symbol interpretation.

The signifier of a semiotic point is the interpretable symbol which underlies the corresponding signification event and which conveys the instantaneous meaning signified in the signification event; it is sometimes appropriate to say that the signifier symbol is uttered in (or by) the signification event, possibly as a byproduct of the utterance of another symbol which contains it (for example, in FIG. 6, the symbol 602, “a mouse”, is uttered as a byproduct of the utterance of 603, “Bob clicked a mouse”). The semiotic points whose signifiers is a particular symbol are said to be issued from (or signified by or owned by) said symbol.

It should be noted that two signification events (semiotic points) may convey the same instantaneous meaning: for example, a semantically invariant symbol is by definition a symbol whose interpretation (instantaneous meaning) is always the same, so that all semiotic points issued from an invariant symbol map to the same instantaneous meaning.

Other symbols which are not declared to be invariant are assumed herein to be ambiguous and to generate semiotic points whose instantaneous meanings are in general distinct.

Consider for example the semiotic graph of FIG. 6, which illustrates the multiple meanings of the singleton sample <sample(category(“mouse”))>, 602, representing “a mouse”, that is, an instance of the “mouse” category, as it is uttered as a byproduct of the utterances of the three sentences 603,604,605, that is: “Bob clicked a mouse”, “The cat chased a mouse”, and “A mouse is on the table”.

More specifically, the graph contains seven semiotic points, 611, 612, 613, 614, 615, 616, 617, spanning five interactive sessions @a, @b, @c, @d, @e. Three of these seven semiotic points: 612, 613, 614, that is, 1@b, 1@c, and 1@d, where {1} is the symbol identifier of the symbol 602, “a mouse”, represent the utterances (or occurrences) of 602 within the three propositional symbols (sentences) 603, 604, 605, that is, {2}<“Bob clicked” 1>, {3}<“The cat chased” 1)> and {4}<1 “is on the table”)>, respectively, uttered in the three interactive sessions @b, @c, @d. The occurrence of (or reference to or utterance of) the symbol 602 in each one of these sentences is represented by one of the semiotic points 612,613, or 614 and constitutes a signification event in which 602 is the signifier symbol. For example, 612, that is, 1@b, represents the occurrence of the symbol “a mouse” in 603, “Bob clicked a mouse”.

It should be noted that the instantaneous intended meaning of the symbol 602 varies: it refers to a device in 612 and to a rodent in 613. The arrow from each one of these sentences to the corresponding semiotic point, for example from 603 to 612, indicates that the sentence depends on the symbol reference (occurrence) identified by the semiotic point; indeed, the sentence “needs” the symbol reference and the meaning of the sentence builds on the meaning of the referred (uttered) symbol.

Each arrow from a semiotic point to its signifier (that is, from 612 to 602, from 613 to 602, and from 614 to 602), indicates that the signification event identified by the semiotic point depends on its signifier: indeed, it is the signifier that conveys the instantaneous meaning of the signification event.

The other four semiotic points: 611,615,616 and 617, that is, 1@a, 5@e, 6@e, and 7@e, represent the creation of the symbols {1},{5},{6},{7}, that is, 601, 606, 607, 608, respectively. The double arrow linking a semiotic point to the signifier symbol it creates indicates their mutual dependency: indeed, not only does the signification event depends on its signifier (as for the other three semiotic points 612,612,614) but the signifier depends on the signification event to which it owes its existence (the signification events 611,615,616, 617 are also creation events). The ontological dependency of the signifier on the event which created it is indicated by an edge from the signifier to the semiotic point identifying said event (that is, from 602 to 611, from 606 to 615, from 607 to 616, from 608 to 617).

The set of semiotic points issued from a symbol over time is referred to as the semiotic history of the symbol. For example, 612,613 and 614 form the semiotic history of 602 up to session @d.

### 4.1.2 Extended Meaning

Whereas a semiotic point specifies an atomic instantaneous meaning, a set of semiotic points or a region in semiotic space specifies an extended meaning.

An extended meaning of a symbol can be characterized by a collection of semiotic points issued from the symbol. For example, a set of semiotic points issued from a symbol in the past provides the extended meaning of the symbol given by the ensemble of the instantaneous meanings of the semiotic points in the set.

As another example, expected semiotic points which are likely be issued in the future, which can be represented by a probability measure in semiotic space, also provide an extended meaning.

In a particular context, right before a symbol is actually used and a semiotic point issued, a symbol conveys an uncertain or expected (or potential) meaning (which is an extended meaning). For example, the meaning of an exogenous symbol imported from an external source is typically uncertain. This uncertain extended meaning collapses to an instantaneous meaning yielding a semiotic point when the symbol occurs or is uttered (or used).

For example, an author who is writing a text may pause and ponder about the meaning of a couple of words in order to choose the best one to convey a particular intended meaning. This intended meaning is the semiotic target of the signification event which is about to occur and the meanings of these couple of words are potential or expected meanings existing in the mind of the author even before a word is uttered; these expected meanings are hidden (or internal) meanings, as opposed to manifest meanings, because they are accessible only to the “mind” which hosts them.

As soon as the author picks and writes down a word to communicate the intended meaning, that word becomes associated with that particular intended meaning and its potential meaning collapses to an instantaneous meaning representable by a semiotic point, which is a concrete manifestation of said instantaneous meaning in that it represents the corresponding physical signification event (e.g., the writing of a word on a piece of paper or the recording of a digital representation in a memory system).

To summarize, according to the teachings of this invention, the genesis and consumption of semiotic points and their associated meanings may be characterized by the follow cycling sequence:
1) A semiotic source (or source-point), for example, a human's mind, produces a semiotic target, that is, an intended meaning (or intended referent) to be communicated (which is also the hidden prior instantaneous meaning of the symbol uttered in the following step);
2) This prior hidden meaning results in the “utterance” of a symbol and the issuance of a semiotic point, which are manifest concrete embodiments of its prior hidden intended meaning (and of the semiotic target);
3) a collection of symbols and their associated semiotic points, obtained by repeating the previous step, are transmitted to a semiotic receiver (endpoint), e.g. a receiving user, which could be physically the same as the semiotic source (but at a different point in time; e.g., when a user retrieves a piece of information recorded by the user itself);
4) semiotic points issued from a symbol evoke, at the endpoint, a posterior extended meaning of that symbol;
5) The receiver “reads” the posterior extended meanings of the symbols received and
6) upon the emergence of a new semiotic target to be communicated, the user selects, among the received symbols, a symbol whose posterior extended meaning can be collapsed to an atomic meaning corresponding to the new semiotic target.

The cycle then repeats itself by issuing a new semiotic point representing the new prior hidden meaning of the symbol.

The context in which a symbol occurs affects its expected meaning. For example, the word “family” used in the context of zoology is quite different from its everyday meaning.

According to the teachings of this invention, past usages (utterances, occurrences) of a symbol provide the basis to establish the expected extended meaning of a symbol. For example, the meaning of the word “family” in the context of zoology could be characterized by the ensemble of usages of the word “family” in a book about zoology.

Embodiments of this invention regard the semiotic points issued from past occurrences of a symbol (and recorded by the memory system), along with information about the contexts of these past occurrences, as being the primary means for defining and accessing the extended expected meaning (that is, the potential meaning) of a symbol.

### 4.1.3 Truth Value of Propositional Symbols

Propositional symbols, such as the statement “It rains”, carry a truth-value (true or false) in addition to a meaning. Similarly to its meaning, a truth-value of a propositional symbol is defined only when it occurs in a particular context. According to the teachings of this invention, both the acquisition of an effective meaning and the acquisition of a truth-value are associated with a semiotic point.

Said truth-value is not necessarily a binary value (true or false) but could instead be characterized by a more general representation, such as a three-value variable (true/false/unknown), a probability distribution (true with a certain probability), etc.

### 4.2 Metric Semiotic Spaces and Semiotic Fluctuations

### Primal Symbols

As mentioned earlier, primal symbols representing numbers, physical quantities, and other low-level information elements are often assumed to have a constant unambiguous meaning so that semiotic points issued from one of these symbols can be often taken to be (semantically) equivalent.

Furthermore, typical primal spaces have a natural metric (e.g., the natural distance function on the set of real numbers: d(x, y)=|x−y| or the edit distance on the set of character strings). This natural distance between primal symbols can be extended to their corresponding semiotic spaces, that is, to a distance between the semiotic points they issue

In these primal semiotic spaces, which embed spaces of semantically invariant symbols, the distance between two semiotic points issued from the same primal symbol is zero due to the semantic invariance of the underlying symbol.

Primal distances, that is, natural distances defined on primal spaces, provide the basis to construct primal adaptive neighborhoods which are used by embodiments of this invention to search for approximate matches to searched primal symbols. Moreover, primal distances and primal adaptive neighborhoods are also used to bootstrap the construction of higher-level distances and neighborhoods defined for more complex (non primal) semiotic points whose signifiers contain primal symbols.

### Non-Primal Symbols

Some kind of metric or distance function representing meaning similarities is assumed to exist also in non-primal semiotic spaces. Humans are indeed capable of assessing the similarity of symbols and of the meanings they convey, and some embodiments of this invention record similarity assessments made by humans to materialize and record metric information within semiotic spaces.

For example, humans are able to classify multiple instances (utterances, occurrences) of an ambiguous multi-sense word such as “mouse” (which could be either a computer device or a rodent) into semiotic clusters wherein instances of a word in a cluster have identical or almost identical meanings and instances from distinct clusters have different meanings. Embodiments of this invention record semiotic clusters to represent metric information of semiotic spaces.

A symbol (such as “mouse”) whose semiotic points give rise to well-segregated distinct clusters in semiotic space is said to be ambiguous, or separably ambiguous. Indeed, it is quite unlikely that a word such as “mouse” could issue a semiotic point which could not be easily classified to either the “rodent” cluster or the “computer device” cluster. The process of assigning a symbol instance to one of the possible clusters is referred to as disambiguation.

Our own experience with natural language suggests that even apparently-non ambiguous expressions, after careful scrutiny, exhibit vagueness or fuzziness which yields “blobby” extended regions in semiotic space.

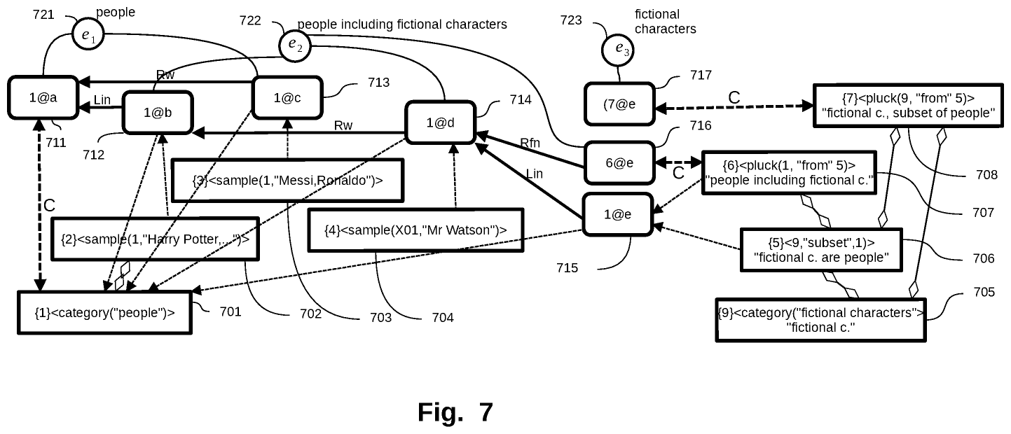

For example, as illustrated by the example in FIG. 7, the category word “people” or “person” (a category is specified herein either with the plural or the singular form, with no intended impact on meaning) may or may not include fictional people, such as Harry Potter (see FIG. 7); thus, there exist (at least) two flavors of the “people” category, one which includes fictional people and one which does not.

As another example, illustrated in FIG. 9, the category word “Friends” may or may not include co-workers.

As yet another example, consider the category “computer file”, which could mean both a character string representing a file path or the actual content of the file.

The same user may use these vague terms multiple times switching from one flavor to another without ever being aware of it.

Reducing the uncertainty of the meaning represented by these fuzzy symbols, which is one of the goals of the disclosed invention, is referred herein as sharpening (or focussing) and is somewhat distinct from the disambiguation of words such as “mouse”, which convey sharply distinct meanings.

Sharpening and disambiguation are collectively referred to as refinement.

Extended semiotic regions are also created by semiotic fluctuations, which refer to slight variations of the instantaneous meaning of a symbol from an occurrence to the next (semiotic fluctuations should not be confused with formal fluctuations of a symbol, which refer to formal variations of a symbol which do not affect its meaning). Even though, most of the time, the meaning of a symbol changes very little (or not at all) from one usage to the next, these semiotic fluctuations may become important and observable, for example, if they accumulate over time (semiotic drifting).

### 4.3 Representing Semiotic Points

Since a genuine atomic signification event is instantaneous, a semiotic point which represents it should have zero duration in time. However, it is often convenient to relax this requirement and to consider the scope of semiotic points to have a non-zero extension in time (or space-time).

For example, the instantaneous meaning of a symbol normally depends on the context in which it occurs; one could go an extra step and consider that it depends only on the context in which it occurs.

Accordingly, some embodiments of this invention construct identifiers of semiotic points by simply pairing the permanent identifier of a symbol with an identifier of the context in which it occurred and assume that the additional information provided by the context identifier is sufficient to specify (identify) exactly the instantaneous meaning of the symbol. (This is not to say that from this pair it is possible to easily obtain a precise representation of its meaning, only that one can assume that a precise meaning exists which is identified by this pair).

In embodiments where symbols are created and used during consecutive interactive sessions involving one or more users, it is normally appropriate to assume that the instantaneous meaning of symbol is constant within a session. If this is the case, the session is a coherent frame and is also referred to as a coherent session. Coherent herein means that all occurrences of a symbol convey the same instantaneous meaning, which is independent of the particular form (exploitable structure, code, symbol identifier, widget, etc.) in which a symbol occurs. Moreover, propositional symbols are assumed have a constant truth value in a coherent frame. Thus, all symbol occurrences are normally assigned the same semiotic point in a coherent frame.

For example, if a user engages in a sequence of interactive coherent sessions denoted @a, @b, @c and if {i1}, {i2}, etc. denote permanent identifiers of symbols memorized or referenced during these sessions, then one could identify the corresponding semiotic points by the pairs i1@a, i2@a, i1@b, as shown in many of the figures.

Since distinct users associate in general distinct instantaneous meanings to a symbol, each user should have a “private” coherent session and a semiotic point should therefore normally specify the user who used the symbol. Furthermore, since a user (or at least a human user) normally participate in a single session at a time, a semiotic point can be often be specified by a triple (i,t,u) given by a permanent symbol identifier {i}, the timestamp of the interactive session, t, and an identifier of the user, u.

Semiotic points can themselves be considered to be symbols forms (see FIG. 3), that is, a semiotic point such as i@a can be considered a form of the symbol {i}, with one caveat: distinct semiotic-point forms occurring in the same context (or coherent frame) are not semantically equivalent (as it is instead the case with the other types of forms, such as symbol identifiers and compositional codes).

Moreover, a semiotic point such as i@a, can be considered as or converted into an exploitable form of a “higher-order” symbol, so that one could create higher-order semiotic points such as <i@a>@b, representing the posterior meaning of the semiotic point i@a in the session @b.

### 4.4 Using Semiotic Point Histories for Meaning Refinement

The semiotic points issued during the interactions between users and the disclosed memory system can be utilized for disambiguating (FIG. 6) or sharpening (FIG. 7) the meaning of new symbol occurrences, so as to capture and materialize more accurately the instantaneous intended meaning of a symbol. To this purpose, embodiments of this invention may present to the user the history of previous usages of a symbol (or a summary thereof), given by a collection of semiotic points recorded in memory, and prompt the user to select the usage or the usages of the symbol (i.e., the semiotic point) that best corresponds to its current intended meaning (e.g., to the semiotic target). FIG. 6 (disambiguation) and FIG. 7 (sharpening) illustrate the disclosed method with examples.

### Disambiguation

In FIG. 6, the symbol 602, that is, {1}“a mouse”<sample(0)> (wherein {0} is the symbol identifier of <category(“mouse”)>, 601) is used during two distinct sessions @b and @c to utter the two expressions (propositional symbols) {2}<“Tom clicked” 1> and {3}<“The cat chased” 1>, resulting in two “mouse” semiotic points 612 and 613, denoted 1@b and 1@c respectively. In 1@b the symbol {1} refers to a device, whereas in 1@c the symbol {1} refers to a rodent.

Suppose that in session @d the user needs to memorize the propositional symbol {4}<1 “is on the table”>. This propositional symbol is ambiguous since both a rodent and a device could be on the table. Suppose that the intention of the user in session @d is to state that a “mouse device” is on the table; then, the user will disambiguate the “mouse” symbol {1} by selecting the semiotic point 1@b as the past occurrence of the symbol that best represents its current intended meaning.

The memory system will also link the current semiotic point 1@d to the selected semiotic point 1@b to record that the current instantaneous meaning of the symbol is the same (or substantially the same) as its meaning in session @b.

Embodiments of this invention assist the user in inspecting the meanings of a symbol by enabling and facilitating the above process: a symbol for which this is possible is referred to as an inspectable symbol.

### Meaning Sharpening

The graph shown in FIG. 7 illustrates how semiotic fluctuations may arise from repeated usage of an apparently un-ambiguous symbol and how semiotic points can be used to represent these fluctuations and to sharpen the resulting fuzzy meaning of the symbol. To emphasize that this fuzziness is even more pronounced and likely to occur when different users refer to the same symbols, in this example it is assumed that each session is owned by a distinct user: Albert own @a; Beatrice owns @b; Cindy owns @c; Diane owns @d.

Suppose that user Albert, in session @a, creates the category symbol {1}<category(“person”)>, 701, yielding the semiotic point: {1}@a<category(“person”)>, 711. Albert may have a well-defined instantaneous prior intended meaning in mind when he issued this point; however, a user receiving the symbol 701 may only be able to reconstruct a coarse and uncertain posterior (presumed) meaning of it since Albert has not provided any contextual information about symbol 701 (such as a sentence referring to 701).

Suppose further that the two samples {2}<sample(1,“Harry Potter”,“David Copperfield”)>, 702, and {3}<sample(1,“Messi”,“Ronaldo”)>, 703, are created by users Beatrice and Chris in sessions @b and @c respectively. The history of the “person” (or “people”) category symbol consists now of the three semiotic points: 711,712,713, that is, 1@a, 1@b, and 1@c. Since the sessions @a, @b and @c are “private sessions” owned by Albert, Beatrice and Chris respectively, the identity of the author is implicitly specified by the session identifier and there is no need to include the author's (owner's) identity in the semiotic point identifier.

Even though the symbol <category(“person”)> is not really “ambiguous” (at least not in the sense of the previous “mouse” example), the posterior meaning evoked in the mind of a user by the three references 1@a, 1@b, and 1@c is slightly different (fluctuates) from one reference (occurrence) to another. Indeed, in the first session, the symbol 701 is quite vague since the symbol comes by itself and no contextual information (such as a sample) has been provided. In the second session, 701 is used to construct a sample 702 which contains well-known fictional characters so that this usage of 701 may evoke the more specific meanings “fictional characters” or “people, including fictional characters”. In the third session, 701 is used to construct sample 703 which contains some real people (the soccer players “Messi” and “RonaIdo”); this usage of 701 may evoke then the more specific meanings: “soccer players”, “famous people”, “rich people”, etc.

Suppose further that in a fourth session @d, the user Diana wants to record the symbol {4}<sample(1,“Mr Watson”)>, 704, with the intention to indicate Sherlock Holmes' assistant (as opposed to a friend of hers whose last name is also “Watson”). To clarify that this is the intended meaning of the expression, Diana would select the semiotic point 1@b, 712, which identifies a signification event where the person category signifier has been associated with a sample of fictional characters; the memory system would further link the new current category semiotic point 1@d, 714, to the point 1@b, 712. Diana has effectively used the semiotic history of the symbol “person” to make its meaning more precise (sharpening/refinement).

### Meaning Feedback from Composition to Constituent: Refinement via Plucking

When a symbol is used as a constituent in a composite symbol (or compositional expression), not only does the constituent contribute to the meaning of the composition but the composition also contributes, in a feedback fashion, to refine the meaning of the constituent: a composition provides contextual information to each one of its constituents.

This motivates the use of the <:pluck> builder, which re-constructs (or re-defines) a constituent symbol by “plucking” it from a composition, resulting in a sharpened (honed) flavor of the original symbol. Thus, plucking provides an additional tool to refine the meaning of fuzzy or vague symbols.

In FIG. 7, for example, the fuzzy category symbol 701, {1}<category(“person”)>, is reconstructed in session @e by plucking {1} from 705, to yield symbol 707, a sharpened flavor of the “people” category, which explicitly asserts that “fictional characters” are allowed.

In a way, this application of the <:pluck> builder “copies” (or “migrates”), to the symbol space, the refinement operation represented in the semiotic space by the semiotic “Rw” link from 714 to 712.

Similarly, a plucked version of the “people” category can be obtained for its other refined flavor (or flavors) which stems from 702, that is, the specific class of “soccer players”, or “famous people”, etc.

Embodiments of this invention sharpen fuzzy symbols such as 701 by applying steps similar to those depicted in FIG. 7, namely:
1) in session @e, the category 705, {9}<category(“fictional characters”> is created;
2) the category 705 is then used to utter the proposition 706, which asserts that 705 is a subset of 701;
3) the original fuzzy category 701 is then plucked from 706 to yield a flavor 707 of 701 which satisfies the additional condition that 701 contains fictional characters;
4) the corresponding semiotic point 716, issued by the creation of the plucked “people” category, is semiotically-linked to 714, the most recent usage of 701 consistent with the condition introduced by 716 (indeed in the sample created by 714 the category 701 did contain fictional characters).

Notice that session @e contains two “people” semiotic points: 715 and 716, the first one issued from the plain “people” category 701, and the other one from the plucked “people” category 707.

Note as well that the semiotic graph of FIG. 7 contains two “fictional character” categories 705 and 708, the latter being guaranteed to be a subset of “people”. Thus, it would be appropriate to create a sample of “Garfield the cat” off category 705, whereas this would not be possible off category 708.

Redefining the meaning of a symbol by plucking it from a context-providing composition can radically change its expected meaning. Consider for example the symbol {1}<“Paris”>. For most people this symbol would signify a city in France. However, if the symbol {1} is plucked from the composite symbol {2}<1,“is in”, “Texas”> or {3}<“Paris Hilton”> its expected meaning changes radically.

### 4.5 Semiotic Entities

A collection of semiotic points conveying the same or similar meanings, issued from the interactions between the disclosed memory system and one or more users over a period time spanning multiple sessions, yields a semiotic entity. This collection of semiotic points is referred to as the semiotic history (or simply history) of the semiotic entity and identifies a collection of symbol occurrences (or utterances).

A semiotic entity normally has at least one representative symbol, which is typically used as the principal signifier for issuing the semiotic entity's history points; more particularly, regular entities (defined more precisely henceforth) have exactly one representative symbol at any point in time (unless they contain multiple sub-entities each having its own representative).

The history of a semiotic entity identifies a plurality of prior instantaneous meanings, namely, the intended meanings underlying the signification events represented by its points. For example, the history of semiotic entity 621 of FIG. 6, which (right after session @d) includes, among others, the semiotic points 612 and 614, that is, 1@b and 1@d, identifies the intended meaning of the symbol {1}“a mouse” in the utterance 603, <“Bob clicked a mouse”> and its intended meaning in the utterance 604 <“A mouse is on the table”>. Similarly, the semiotic entity 722 of FIG. 7, whose history includes 712 and 714 right after session @d, identifies the intended meaning of the symbol {1}<category(“person”)> in the utterances 702, <sample(1,“Harry Potter”,“David Copperfield”)> and 704, <sample(1,“Mr Watson”)>.

The semiotic entity representative of 621 in the sessions @a, @b, @c, @d is the symbol {1}, “a mouse”. The representative of 621 is updated to the more refined symbol 606 in session @e. Similarly, the representative of 722 in the session @a, @b, @c, @d is the symbol 701, {1}<category(“person”)> and is updated to the more refined symbol 707 in session @e.

### Extended Entity Meaning Presumed by a Receiver

When a semiotic entity , along with its history, is delivered to a receiving party (which could be same party as the semiotic source) it evokes an extended potential posterior meaning given by the ensemble of interpretations assigned by the receiving party to each semiotic point in the history of the semiotic entity. This posterior presumed meaning is aligned with the original prior instantaneous meanings to the extent that the receiver has the ability to recreate or simulate the context in which the semiotic points were issued.

This contextual information includes, at a minimum, the compositions realized by the semiotic entity, that is, for example, the utterances <sample(1,“Harry Potter”,“David Copperfield”)> and <sample(1,“Mr Watson”)> for entity 722 of FIG. 7. Embodiments of this invention may utilize additional contextual information for the reconstruction of the semiotic entity's meaning, such as, for example, the time and location of each session and the identity of the author who issued the above utterances.

In summary, a semiotic entity conveys a posterior extended meaning to a receiving endpoint/semiotic receiver (posterior with respect to the issuance of the semiotic points belonging to its history). The receiver may then select a point from the semiotic entity's history to represent or identify a current referent or meaning which is present (or relevant) in the current environment or context.

### Entity Evolution: Extension and Re-Representation; Sub-Entities

Semiotic entities are mutable (evolving) objects and they change in time in many possible ways. It is convenient to assume that the evolution of semiotic entities is monotonic and takes place by means of extension steps which evolve a semiotic entity always “forward”, without ever deleting previous extensions.

The most common type is extension-by-reference obtained when a semiotic point issued from the semiotic entity's representative (assuming it's unique) is appended to the semiotic entity's history. Essentially, extension-by-reference entails the creation of a composite symbol having the semiotic entity's representative as one of its constituents. For example, semiotic entity 621 of FIG. 6, whose representative is 602, “a mouse”, is extended in session @d by the utterance of 604, <“A mouse is on the table”>.

The composite symbols created in extension-by-reference are said to be the compositions of the semiotic entity or the compositions realized by the semiotic entity. Each time a composition is realized, the semiotic point representing the occurrence of the representative symbol in the realized composition is appended to the semiotic entity's history. For example, in session @d, the semiotic point 614 representing the occurrence of 602 in 604 is appended to the history of semiotic entity 621.

Another type of semiotic entity mutation is re-representation, which consists in assigning a new representative to the semiotic entity. If the new representative replaces an existing one, then the mutation is called representative update or entity update; otherwise, it is said to be a parallel re-representation. Since a semiotic point representing the new representative is normally created and appended to the semiotic entity's history, this type of entity evolution is called extension-by-re-representation (or extension-by-update if the re-representation replaces a representative). For example, in session @e of FIG. 6, entity 621 undergoes an extension-by-update where the new representative is the annotation aggregate 606.

The set of the signifiers of the semiotic points in a semiotic entity's history, which includes the current and previous representatives, are said to be the semiotic entity's signifiers or the signifiers recruited by the semiotic entity. For example, semiotic entity 621 in session @e has two recruited signifiers, 602 and 606.

A semiotic entity may spin-off (spawn) a semiotic sub-entity or acquire an existing one; a semiotic entity can also become a semiotic sub-entity nested in another semiotic entity; or it may be joined with another semiotic entity into a larger semiotic entity.

Embodiments of this invention create semiotic entities with different level of homogeneity or granularity: coarser semiotic entities contain semiotic point with similar but non-identical instantaneous meanings whereas the finest semiotic entities comprise points with the same instantaneous meaning.

A semiotic entity can often be viewed as a representation of an underlying real-world entity existing persistently over time (hence the term entity). From a subjective viewpoint, a semiotic entity may also be viewed as a representation of the stream of experiences of one or more users with an underlying “objective” entity.

### Compositions Realized by Entities

For example, in FIG. 6, the semiotic entity 621, whose representative symbols represent a mouse device, realizes three compositions:
1) the propositional symbol 603, {2}<“Bob clicked a mouse”>;
2) The propositional symbol 605, {4}<“A mouse is on the table”>; and
3) the descriptive symbol (annotation aggregate) 606 which includes the annotation that “a mouse” belongs to the “device” category.

Similarly, the semiotic entity 622, representing a rodent mouse, has two compositions:
1) the propositional symbol 604, {3}<“The cat chased the mouse”> and
2) the descriptive symbol (annotation aggregate) 607 providing the annotation that “a mouse” belongs to the “rodent” category.

As another example, in FIG. 7, the semiotic entity 721, representing one flavor or the “people” category, realizes the people category sample 703 including “Messi” and “RonaIdo”. The semiotic entity 722, representing a second flavor or the “people” category, realizes
1) the sample 702 which includes “Harry Potter”;
2) the sample 704 which includes “Mr Watson”; and
3) The redefinition (re-representation) 707 of the “people” category as a category which includes fictional characters.

As yet another example, in FIG. 8, the semiotic entity 821 realizes the three compositions <“John lives in Boston”>, <“John likes movies”>, <“John is sick today”>; the re-representation of <“John”> as <“John Smith”>; and the consolidating re-representation 807 which summarizes all the above compositions into a unique aggregates symbol (a total of five compositions).

As yet another example, FIG. 9 contains two complex coarse semiotic entities, each containing a pair of semiotic sub-entities. Semiotic entity 960 representing coarse category “My Friends” comprises a semiotic sub-entity 941 representing the “My Friend” flavor which includes “My coworkers”; and semiotic sub-entity 945 representing the “My Friend” flavor which excludes “Coworkers”.

### 4.6 Semiotic Graph

Typical embodiments of this invention represent semiotic matches, that is, equality or similarity relationships which have been ascertained or declared between semiotic points, by means of a semiotic graph, wherein pairs of semiotic points are linked with an edge (referred to as semiotic link) only if they are assessed (or declared) to have the same or similar meanings (that is, in topological terminology, if they are sufficiently close to each other).

### 4.6.1 Primitive Graph Structures: Threads and Clusters

Two types of graph structures utilized extensively by some embodiments of this invention are semiotic threads, which are paths in the semiotic graph, and semiotic clusters, in which one point (the cluster center) is linked to all other points of the cluster (either with an outgoing or incoming edge). Threads and clusters, which are subgraphs of the semiotic graph, are considered to be the primitive graph structures of which more complex semiotic structures are composed. Edges within a subgraph are called internal edges or links.

A semiotic thread is obtained, for example, when a symbol is used repeatedly with negligible change of its instantaneous meaning and, for each usage of the symbol, a new semiotic point is created and linked to the preceding semiotic point. In a thread, only consecutive semiotic points are constrained to be close to each other (that is, constrained to have the same or similar instantaneous meanings). Thus, threads are appropriate to capture semiotic drift, that is, smooth and slow change of meaning over time.

On the other hand, in many situations, the instantaneous meaning of a symbol remains stable even over a long period of time and across a plurality of contexts. Embodiments of this invention organize sets of semiotic points with no (or negligible) overall meaning change into semiotic clusters of points wherein the mutual meaning difference between any two points in the cluster is zero or very small.

By convention, the links of a semiotic graph are directed from a semiotic point (the tail of the link) to a previously existing semiotic point (the head of the link). Moreover, semiotic links are normally established at the same time or immediately after the issuance of the tail semiotic point.

When a cluster is created, its center is linked to a set of existing semiotic points (see for example 816 of FIG. 8). Points added later to the cluster are linked to the center. The mutual distance between any two points of the cluster is at most twice the maximum distance associated to a link.

A thread has exactly one inception point, or head-point (the unique point with no internal outgoing edges) and one tail-point (its unique point with no internal incoming edges). The tail-point is normally its most recent point. All other points of the thread have exactly one internal outgoing edge and one internal incoming edge. Thus, a thread does not contain internal bifurcations.

For example, the semiotic graph of FIG. 6 contains two threads after session @e: (615→614→612→611). And (616→613); their inception points are 611 and 613 and their tail-points are 615 and 616, respectively.

A semiotic whose history is a thread is said to be a linear entity, whereas an entity whose history is a cluster is called a cluster entity.

A semiotic entity is said to be a simple entity if it does not contain sub-entities; otherwise, if it is an interconnected set of semiotic sub-entities, it is said to be a complex entity.

A simple semiotic entity having exactly one representative and whose history is a primitive graph structure (either a thread or a cluster) is said to be a regular entity. A complex entity is said to be regular if its sub-entities are regular and if their representatives are distinct.

### 4.6.2 Semiotic Matching

When a user (human or machine) or a semiotic master, while communicating with a memory system (or with any other party) participates in a signification event, one or more information elements are mapped to symbols which are then communicated to the memory system. The information elements or underlying entities for which a symbol is needed for the realization of the signification event are called semiotic targets. Semiotic targets are the intended referents (or intended meanings) of the symbols selected or created in a signification event for the purpose of conveying their intended meaning. For example, right before uttering the sentence “A mouse is on the table”, the hidden prior instantaneous meaning of 602 exists as a semiotic target in the mind of the semiotic source.

Realizing a signification event requires the search for suitable symbols that match the existing semiotic targets. The match of a symbol to a semiotic target is referred to as a semiotic match. In the above example, the aforementioned semiotic target is matched to the symbol 602 of the memory graph.

Embodiments of the disclosed invention facilitate, execute and represent semiotic matching by means of a semiotic graph (such as those depicted in FIG. 6-9) whose edges, referred to as semiotic links, represent semiotic matches. In the disclosed invention, semiotic targets are normally matched to semiotic points (rather than to plain symbols); recall that a semiotic point specifies, in addition to a signifier symbol, a signification event in which the signifier symbol occurred, hence increasing the precision and accuracy of the match. For example, the semiotic target matched to symbol 602 in session @d is also matched to semiotic point 612, as indicated by the link from the semiotic point 614, 1@d, to 612, 1@b.

As mentioned earlier, a semiotic link entails an equality or similarity relationship between the current intended meaning of the signifier of the tail node of the edge (namely, the semiotic target) and the presumed meaning of the signifier of the head node in the signification event represented by the head node. For example, in FIG. 6 the semiotic link from 614 to 612 represents the matching of the aforementioned “a mouse” information element of session @d (the semiotic target) to the occurrence of the symbol 602 in session @b.

More specifically, in FIG. 6, the user uttering the sentence “a mouse is on the table” (node 605) in session @d, recognizes that the semiotic target, given by intended meaning of the symbol 602, “a mouse”, is matched by the meaning of 602 in the utterance “Bob clicked a mouse” (node 603) in session @b. Hence the semiotic point which identifies the current reference of “a mouse”, that is, node 614, is linked to the matching semiotic point 612, which identifies the past occurrence of the symbol 602 in the propositional symbol “Bob clicked a mouse”.

This link is labeled “Rw”, that is “rewind”, to indicate that the current semiotic node has been linked to a semiotic point other than its most immediate previous occurrence (the entity has been “rewound”).

To take advantage of the additional information provided by a semiotic point with respect to its “plain” signifier symbol, the receiving party must be able to recall, reconstruct, simulate or otherwise understand the past context in which the symbol occurred. There may be limitations to how well this task can be accomplished, especially if the past context is an external context, for example, owned by a different user.

If the receiving party is the same as the source party, then semiotic matching relies on the user recollecting his/her previous experience with the symbol. When receiver and source are instead distinct, then the presumed prior meaning of the linkable semiotic point must be reconstructed rather than recalled.

### Multi-Resolution Browsing and Matching

Embodiments of the disclosed invention facilitate semiotic matching by enabling the user to browse a memory graph and the semiotic entities contained therein. Since the memory graph is structured in semiotic entities and semiotic sub-entities, each having access to its own semiotic history, multi-resolution browsing is enabled, that is, semiotic entities of the memory graph can be presented to a user with a controllable amount of details.

Initially, only coarse semiotic matching is typically performed, for example, by presenting to the user a simplified view of the memory graph where only the representative symbols of the top-level semiotic entities are shown. In some cases, it may be satisfactory to find a semiotic match at this coarse level of detail.

When more accuracy is needed, certain semiotic entities are expanded into sub-entities resulting in the presentation of the symbol representatives of these semiotic sub-entities. To attain an even higher level of accuracy, the whole set of recruited semiotic entity signifiers are presented.

The highest level of detail is obtained by presenting the histories of semiotic entities, thus enabling a user to look for a match at the semiotic-point level of precision. The examples of FIG. 6, illustrate how it may indeed be necessary to match at the semiotic point level of detail in order to disambiguate the “a mouse” symbol.

### 4.6.3 Semiotic Entity (and Semiotic Graph) Extension by Semiotic Matching

In some embodiments of the disclosed invention, edges of the semiotic graph (semiotic links) are created when a semiotic target is matched to a semiotic point representing a past signification event or, conversely, by recognizing a fragment of the past experience as being present, pertinent, or relevant in the current environment. Hence semiotic matching provides the basic atomic ingredients to construct and extend semiotic graphs.

Similarly, semiotic matching provides a basic ingredient for the evolution of semiotic entities. Indeed, when a symbol is selected or created and the semiotic point representing the corresponding semiotic target is linked to a matching semiotic point, the semiotic entity containing this latter point gets extended by adding the semiotic link thus created.

For example, if the representative symbol of a semiotic entity is referred to in a new composite symbol, the new semiotic point representing the current intended meaning of the representative symbol may be linked to a matching semiotic point belonging to the history of the semiotic entity, hence extending the semiotic entity by reference. Composite symbols thus obtained are said to be compositions realized by the semiotic entity.

For example, in FIGS. 6, 603 and 605 are compositions realized by the semiotic entity 621;

and the reference 614 to the representative symbol 602 of 621 contained in 605 extends the semiotic entity 621 by reference, thanks to the semiotic match of the “a mouse” interpretation in session @d to the “a mouse” interpretation in session @b, indicated by the semiotic link from 614 to 612.

Appending a semiotic link to the tail of a semiotic entity is referred to as tail-extension, or linear extension, whereas extending a semiotic entity by appending a link to a point other than a tail is referred to as non-linear extension or rewind, to indicate that the history of the semiotic entity had to be rewound in order to find a match. For example, 614 to 612 is a rewind-extension.

### 4.7 Unification, Coherent Aggregates and Annotations

Embodiments of this invention may process a set of related symbols (for example a set of propositional symbols having the same subject symbol, such as 802,803,804 in FIG. 8) by means of unification, which consists in recognizing (or positing) that two or more occurrences of a unifiable symbol (for example: the subject symbol 801 of said propositional symbols) represent the same referent or convey the same meaning. Occurrences of unifiable symbols may come from a thread (such as 814→813→812→811 of FIG. 8) or from far apart sessions, possibly involving distinct users.

Once a symbol has been unified across multiple composite symbols in which it occurred, these composite symbols can be aggregated into a coherent aggregate symbol, for example, a descriptive symbol.

If the unified symbols are hypothesized, rather than recognized, to have the same meaning (or same truth value), the aggregate symbol is referred to as a hypothetical aggregate symbol.

Consider for example (see FIG. 8) the symbol {1}<“John”>, 801, and the three propositional symbols 802, 803 and 804, created in sessions @b, @c, and @d by possibly distinct users:
{2}“JohnLivesInBoston”<1, “lives in Boston” >
{3}“JohnLikeMovies”<1, “likes movies” >;
{4}“JohnIsSick”<1, “is sick today” >. In a subsequent session @f a user may recognize or hypothesize that the four above occurrences of the unifiable “John” symbol {1} refer to the same individual and may therefore cause the memory system to issue a semiotic point 816 that is linked to all the semiotic points 811, 812, 813, and 814, thus yielding a semiotic cluster, indicated by the arrows linking 816 to each point of the cluster (This cluster includes also the semiotic point 815 corresponding to the re-representation of {1}“John” as it will be discussed later).

Unification of the “John” symbol occurrences in turn enables the creation of an annotation-aggregate which consolidates the information about {1}“John”, 801 (the subject or annotated target) provided by the three annotations {2},{3}, {4}, that is, 812,813, and 814.

A special notation for the compositional code of an annotation-aggregate is used, wherein the symbol “+” separates the annotated target from its annotations. In our example this yields the code [1+2,3,4] whose decoded exploitable form is <annotate(1,“with”,2,3,4)>, wherein <:annotate> is a builder which creates an annotation-aggregate. (As discussed later, the annotation aggregate 807 shown in FIG. 8 is slightly different in that it includes also 806 and its annotation target is 805, the re-representation of {1}“John”).

Semiotic unification may require additional treatment in situations where the same symbol occurs twice with different meanings in the same context, such as in the sentence <“My dog ate my hot dog”>. A possible way out to refine/specialize the symbol, for example, <“My animal:dog ate my food:hot-dog”>.

Constructing annotations is especially interesting when its constituent elements (targets and annotations) are gathered from interactive sessions far apart from each other and possibly owned by distinct users, in which case the underlying semiotic unification required to ensure symbol coherency and soundness of the annotation aggregate is non-trivial. As mentioned before, unification can also be hypothetical, which can be used, for example, to explore the possible consequences of hypothesized facts or relations.

It should be noted that annotations provide a mechanism for disambiguation; a user may for example have several friends named “John” but perhaps only one who lives in Boston, so that the annotation {4} would be sufficient to resolve the ambiguity. In general, annotations modify the extended meaning of a symbol in that an annotated symbol (individual) is more refined/precise than the un-annotated symbol.

Two annotation aggregates 606 and 607 are used in the example of FIG. 6 to disambiguate the “mouse” device from the rodent “mouse”. Indeed, the aggregate 606 annotates {1}“a mouse” with the proposition <isa(1,category(“rodent”))> stating that {1} is a member of the category “rodent”. Similarly, 607 contains a statement that {1} is a member of the category “device”.

Another type of coherent aggregates are inference-aggregates (or derivation-aggregates) which group unified symbols participating in an inferential derivation such as a syllogism. These may be denoted by decorating the compositional code by means of an arrow “←”; for example: [0←1,2] is an inference-aggregate where {1} and {2} imply {0}. This inference-aggregate can also be viewed as an annotation-aggregate which annotates {0} with an inferential derivation. Several connected inference-aggregates can be joined together to represent complex inferential derivations.

Yet another type of coherent aggregates is similarity aggregates or topological aggregates which group similar or semantically equivalent symbols. These may be denoted by decorating the compositional code by means of ˜; for example, [0˜1,2] is a topological aggregate where {1} and {2} are semantically similar to {0}. Such a topological aggregate can also be viewed as an annotation-aggregate which annotates {0} with a declaration that {1} and {2} are similar to it.

A symbol built via <:pluck>, such as 707 or 708 (FIG. 7), can be considered an “inverted” annotation, wherein the annotated target (the plucked object) is built after the symbol providing the annotating information.

### Availability Annotations

A symbol may be annotated with suggested symbols it can be combined with (available symbols) to express new information. For example, a restricted virtual expression informs the restricting category that said virtual expression can be applied to instances of the category to express statements. One may then annotate the category with all the restricted expressions mentioning the category. This list may be included in the widget so as to invite users to use the virtual expression.

### 4.7.2 Similarity Between Descriptive Symbols

A similarity measure can be assessed on annotation groupings (e.g., descriptive symbols) based on their overlap. For example, given two descriptive symbols having the same subject, their similarity can be defined as the number of shared annotations, suitably normalized. The resulting distance function, which may be used for matching, may be asymmetric (as it may be based on subsumption relationships).

### 4.8 Creation and Evolution of Semiotic Entities

Embodiments of this invention provide the means to create and modify semiotic entities in a variety of ways, usually in cooperation between the memory system and one more user. As illustrated in FIG. 4, semiotic entities can be created (441); re-represented; updated (via a state-update, informational-update, descriptive updates or renaming-update); extended (442): extended by reference, extended-by-update or extended-by-re-representation; rewound (443), refined (446) (disambiguated or sharpened); consolidated (451); organized into semiotic sub-entities (447) ; analyzed into finer semiotic entities (446,447); reconciled and grouped with other semiotic entities into coarse semiotic entities (448); contrasted with dissimilar semiotic entities (449).

For example, in FIG. 6, semiotic entity 621 was created in session @a; extended in session @b; rewound and extended in session @d; subjected to a refining (disambiguating) descriptive update (re-representation) in session @e. Semiotic entity 622 was created in session @b; rewound and subjected to a refining (disambiguating) descriptive update (re-representation) in session @e. The two semiotic entities 621 and 622 were merge-reconciled in session @f into a new semiotic super-entity (not explicitly shown in FIG. 6) containing the semiotic point 617.

### 4.8.1 Extension-by-Reference

### Linear Extension

The simplest type of semiotic entity evolution step is a linear extension-by-reference which occurs when the representative of the semiotic entity is referred to in a new composite symbol and the new semiotic point is linked to the tail of the semiotic entity. This is appropriate when the current intended meaning of the representative symbol of the semiotic entity is the same or sufficiently similar to its previous most recent meaning.

Linear threads are appropriate to represent “smooth” usages of a symbol which do not exhibit meaning “discontinuities”. In some embodiments, the user may simply recall that the more recent usage of the symbol conveyed the same meaning as its meaning in the current session and may therefore validate the extension of the thread by explicitly recognizing and informing the memory system that the current usage of the representative symbol of the semiotic entity is coherent/consistent with its previous usage.

When a symbol is used repeatedly with negligible change of its instantaneous meaning, a sequence of linear extension-by-reference steps is obtained, and a corresponding linear sequence of compositions is realized. If no other types of evolution steps are applied, then one obtains a 1-symbol regular entity, that is, a linear entity having a unique signifier and whose history is a thread.

### User Validation; Optional User Cooperation

If the user neglects or is not willing to perform this meaning verification task, the memory system may extend the semiotic entity linearly by default, thus incurring a certain risk that a meaning discontinuity remains undetected; it may be useful in this situation to perform consistency/coherence checks at a later time so that this kind of defects can be uncovered and repaired.

As an alternative, the memory system may refuse to create a semiotic link if the user does not provide any information useful for this task, thus treating all symbol occurrences as distinct disconnected semiotic entities, hence failing to recognize the unity of the underlying entities.

One or more users may participate actively in these editing activities in collaboration with the memory system. As described earlier, if a user is unwilling or unable to do so, the memory system may fall back to certain default modes, such as linking the current symbol occurrence to its most recent occurrence or perform no linking at all.

If the user collaborates, then the user may request historical information about the past occurrences of an inspectable symbol if the most recent occurrence of the symbol does not reflect its current meaning. The memory system may also actively prompt one or more user to examine past occurrences of a symbol and select one or more occurrences which are consistent with its current usage. Users can also participate in grouping and organizing semiotic points into clusters (and cluster-entities) and in the reshaping and streamlining of complex semiotic entities into simpler ones.

### Rewinding and Forking

Linear extensions are appropriate to represent “smooth” usages of a symbol which do not exhibit meaning “discontinuities”. If the user determines that the current instantaneous meaning of a symbol is not the same as (or not sufficiently similar to) the posterior meaning of its most recent occurrence, then the user may examine earlier occurrences of the symbol to search for a match and, if a match is found, the current semiotic point is linked to the matched point. This operation is referred to as semiotic rewind because the history of the symbol is rewound and restarted from an earlier point. For example, in session @d of FIG. 6, the node 614 is rewound to 612.

If the rewind operation lands on a matched semiotic point which is not a tail point, then a bifurcation results at the matched semiotic point and the number of tail points is increased by one. This editing operation (extension) is referred to as rewind-and-fork (or simply fork).

### Using Composition Lists to Record Linear Entities

A linear thread can be stored with very little memory resources, as it is sufficient to create an array for every symbol containing the identifiers of the sessions or frames in which the symbol occurs. Some embodiments use composition lists to record the sequence of semiotic points issued from a symbol. That is, for each symbol, these embodiments maintain an array storing the identifiers of its dependent symbols by appending every new dependent composite symbol to this array. This array of upward links (composition lists) is sufficient to represent a linear thread issued for a symbol; however, additional information is required in the more general case where semiotic entities contain multiple branches and threads.

If the rewind point (bifurcation point) belongs to the history of a semiotic entity, this rewind and bifurcation operation may result in a new semiotic entity which may be assigned to be a semiotic sub-entity of the original semiotic entity. Or it may result in a multi-branch semiotic entity with multiple tails.

Rewinding may be necessitated by semiotic drifting of a symbol, due to a significant change of its (instantaneous) meaning caused by a sequence of small imperceptible changes from one usage to the next, which may result in the last instantaneous meaning of the symbol to be quite different from its meaning at an earlier point. If and when this earlier meaning becomes pertinent again, a rewind operation is appropriate.

Some embodiments of this invention present a whole semiotic thread (or a summary thereof) to a user and prompt the user to select the point that best correspond to the current meaning so that the best matching meaning is selected. For example, this semiotic thread could be the semiotic history of a 1-symbol linear entity. Some embodiments perform this step only if the user does not recognize the meaning of the tail of the presented thread as being pertinent.

If no semiotic point is found which provides a good enough match to the current meaning, a new 1-symbol entity is created whose inception point is the current semiotic point.

Some embodiments consider the multiple linear branches of a multi-thread semiotic entity as sub-entities of it.

### 4.8.2 Clustering Operations

One method to obtain a cluster is to compare semiotic points to a prototype point. A set of points recognized to be very close to a prototype can be organized into a cluster since the mutual distance between any two such points is at most twice their distance to the prototype. During an interactive session, the memory system may prompt the user to select a prototype point corresponding to the current meaning of a symbol and may group the current semiotic point with the cluster owned by the selected prototype.

Another method is thread-to-cluster conversion (step 450 of FIG. 4) which can performed by the memory system with the assistance of a user, and which consists in examining the points of thread in order to assess if these points (or a subset of them) can be “collapsed” into a cluster, for example, by evaluating the mutual distances between the points of the thread. If there was no meaning drifting along a thread, then the whole thread can be collapsed to a unique cluster; otherwise, it may be possible to discover one or more clusters within the thread.

A cluster of semiotic point can yield a cluster-entity, that is, a semiotic entity whose history is given by a cluster of semiotic points. Moreover, the compositions (composite symbols) realized by the semiotic points of a cluster or cluster-entity can be aggregated into a coherent aggregate (such as a descriptive symbol) because the cluster enables the unification of the underlying symbols.

Thread-to-Cluster yields a 2-entity (a semiotic entity with two sub-entities), as can be discerned for example in FIG. 8: one semiotic sub-entity corresponds to a linear structure in semiotic space, e.g., the path 827→825→824→823→822→821; the other one, off the cluster center (826), is a cluster of points (same points as in the linear path above) linked to the center 826.

### 4.9 Semiotic Entity Re-Representations

Right after being created, a semiotic entity has exactly one recruited signifier, which is the representative symbol of the semiotic entity. The semiotic entity remains a 1-signifier (and 1-representative) regular entity as long as it evolves by means of extension-by-reference operations only.

A semiotic entity re-representation (RR) consists in the recruiting of a new signifier symbol and takes place when a new semiotic point is appended to the entity history whose signifier is not among the current signifiers of the entity. If the newly recruited symbol replaces the current entity representative (or one of the existing representatives) then the update is referred to as an entity update (EU); if instead it does not displace a current representative, it is a parallel re-representation (PRR): the newly recruited representative coexists in parallel with existing representatives. It should be noted that a semiotic entity which is never subjected to parallel re-representations always has a unique representative, even though it has recruited multiple signifier symbols.

Two types of re-representations are considered: 1) state updates (StU) and 2) descriptive re-representations (DRR). State updates are pertinent when the underlying entity changes state over time and its corresponding semiotic entity is updated to reflect this change; a descriptive re-representation recruits a signifier which provides an alternative or complementary description of the underlying entity, either in parallel to existing representatives or as a replacement of one or more existing representatives.

A descriptive re-representation has two natures; (1) topological: the new recruited representative represents the same entity and may therefore be related to some of the other recruited symbols, for example, by means of an equivalence, similarity, proximity or subsumption relation; and (2) computational: the new representative may facilitate certain computations (e.g.: search).

If the new signifier introduced by a descriptive re-representation is not pertinent to the entire history of the semiotic entity, then it may entail the creation of a semiotic sub-entity whose history includes only the semiotic points for which the new representative is pertinent (semiotic entity split). In a semiotic entity split, the original semiotic entity spins-off/spawns a distinct semiotic entity and, typically, the pre-existing and the new semiotic entity may become semiotic sub-entities of a new coarse semiotic entity.

A parallel representation is also a “split” because entity representation ends up being split between multiple representatives.

### 4.9.1 State Updates

An entity state update (labelled “StU” in FIG. 9) is carried out to represent or record a change of the state of the underlying entity. Entities subject to state updates are said to be variable or dynamic entities. For example, an entity representing the position of a moving car gets continuously state-updated by creating semiotic points representing the current position of the car and by appending the current position to the history of the corresponding semiotic entity. At any point in time, its representative symbol is the current position.

As another example, a semiotic entity representing the list of Bob's friends is state updated by replacing the current list of friends with the new list of friends every time Bob meets a new person (or “loses” an existing friend).

In some embodiments, unless memory resources are scarce, the old lists are not actually deleted from memory, instead, they are simply replaced in their role of entity representative by the most recent list. A user may then retrieve the ensemble of the old lists by retrieving the other semiotic points of the semiotic entity. The memory system may also compress the new representative symbol by using the superseded symbols as a base; for example, a list could be updated by recording only the edits necessary to obtain the new list.

State updates are normally re-representations of the semiotic entity which do not modify the number of representative symbols; thus, a semiotic entity undergoing uniquely state updates usually has a unique representative.

### 4.9.2 Descriptive Re-Representation

A descriptive re-representation occurs when the state of the underlying entity does not change and the new recruited signifier provides an alternative or complementary description of the underlying entity, either in parallel to existing representatives or as a replacement of one or more existing representatives. A descriptive re-representation can be informative, if it provides additional information, or it could merely an entity renaming if the new signifier merely provides a new name (such as a shorthand name or a name in another language).

The new representative may be pertinent only to a portion of the semiotic entity history (embodiments of this invention may perform a check following a re-representation to find out which points are consistent with the new representation), in which case it may be appropriate to spin-off a semiotic sub-entity containing that portion of the history for which the new representative is pertinent. The new representative acts as a retroactive update for that portion of the semiotic entity history for which it is pertinent.

For example, consider again the graph shown FIG. 8, where the symbol {1}<“John”>, 801, has been used to refer to someone named “John” in the utterances of the propositional symbols {2},{3}, {4} (802,803,804) yielding the thread 814→813→812→811. The author of these propositional symbols (assumed herein to be unique) may finally decide to replace the representative symbol of this semiotic entity with the more specific symbol <“John Smith”>, perhaps because the author met a new person named “John” and a more precise symbol is needed to avoid confusion. The meaning of the multiple occurrences is not changed by the update (it refers to the same person), however, more information has been added (his last name is now included in the representative symbol). This descriptive update yields a semiotic link (labeled “DsU”) from the semiotic point corresponding to the creation of the new representative, 815, to the current tail of the entity thread, 814.

Embodiments of this invention may implement a descriptive re-representation by means of an annotation aggregate (such as a descriptive symbol) which incorporates one or more new information elements about the underlying entity into the representative symbol of the corresponding semiotic entity.

For example, the “John” entity of the FIG. 8 is shown to undergo, in session @f, a second update obtained by replacing the current representative symbol {5}<“JohnSmith”> with the descriptive symbol (annotation-aggregate) 807 which contains further information about John, that is, that he lives in Boston, that he likes movies and that he is sick today. This descriptive update does not record a change of state of the entity “John”, only the information which is made explicit within the representative symbol.

As explained earlier, in order for an annotation aggregate to be sound, multiple occurrences of a symbol must be confirmed (or recognized) to have the same referent or meaning (unless the annotation aggregate is a hypothetical aggregate). This unification step is represented by a semiotic cluster which contains the semiotic points representing the symbol occurrences which are recognized to have the same referent. In the example shown in FIG. 8, this cluster 816 contains the semiotic points 811,812,813,814 representing the multiple occurrences of the symbol {1}<“John”>; plus the semiotic point 815 representing the creation of the current representative {5}<“JohnSmith”>, 805.

Moreover, the subject of the descriptive aggregate 807 is the current representative 805 (rather than the former one, 801).

Finally, the locally scoped equivalence statement 806, which asserts the local equivalence of {5} and {1}, is included among the annotations of 807. The compositional code of resulting descriptive aggregate 807 is therefore: [5+2,3,4,6].

Similarly to the previous re-representation event, this second descriptive update yields a semiotic link (labeled “DsU”) from the semiotic point corresponding to the creation of the new representative, 817, to the current tail of the semiotic entity thread, 815.

Another example of descriptive update is the re-representation 614→615 shown in FIG. 6, wherein the representative 602 of semiotic entity 621 given by the symbol {1}“a mouse” is replaced by 606, that is, by the annotation-aggregate which annotates {1}“a mouse” with a statement that {1}“a mouse” is a member of the “device” category: the new entity representative 606 provides the additional information that the underlying entity is a “device”.

It should be noted that the annotating symbols included in a new representative symbol are normally already present in the memory system, albeit in a loose and disconnected way. In the example of FIG. 8, the propositions {2}, {3},{4} are indeed compositions, realized by the semiotic entity, which are already saved in memory; what is added by the new aggregate representative {7} is the information that the constituent symbol {1} has the same referent when it occurs in {2}, {3},{4} (unification) and the “convenience” of having the information element, {2}, {3}, {4} packed together inside {4}. Among other benefits, more tightly packed information facilitates the search during the ingestion phase. Having relevant information packed together often avoids the need for deep inferential searches, as discussed elsewhere in this disclosure.

As described below, a descriptive re-representation may result in (or used for) (1) semiotic entity refinement; (2) semiotic entity analysis, which entails the spawning of one or more semiotic sub-entities; (3) semiotic entity consolidation; (4) semiotic entity regularization (normalization).

### 4.10 Refinements of Semiotic Entities

It is common that additional information provided in a descriptive (informative) re-representation reduces the uncertainty of what the actual referent may be, thus making the posterior meaning of the semiotic entity more precise. If this is case, the descriptive re-representation is a refining re-representation or a semiotic entity refinement. Thus, a refinement is a re-representation where the new representative has a more precise meaning, resulting in a sharper definition of the underlying entity.

For example, the descriptive update 814→815 of FIG. 8, that is: <“John”>→<“John Smith”>, is a refinement if, in the current context, there is uncertainty (ambiguity) as to whom <“John”> refers to and if replacing <“John”> with <“John Smith”> reduces this uncertainty. If instead <“John”> is not uncertain, then the descriptive update would not be a refinement. For example, for the user who created the <“John”> symbol and the thread 815→ . . . →811, who knows exactly whom <“John”> refers to, the update is not refining, just descriptive and informative.

Notice therefore that whether a descriptive update is refinement update or not depends in general on the user who receives the semiotic entity and assigns a posterior meaning to its representative symbol.

Embodiments of this invention apply refinements to coarse and fuzzy semiotic entities, such as the “people” category (e.g. 701 of FIG. 7) to yield more precise symbols and semiotic entities. The word “people” clearly means different things to different users. For example, to the IRS, the category “people” would likely include only people having a social security number. To an historian, “people” would include all people for which there exists some kind of record in a history book. For a user of a digital contact notebook running on a smartphone, “people” would probably include only people known to said user. For someone watching a “Harry Potter” movie, “people” would likely include the fictional character Harry Potter and his friends. To some, “Hercules” would be a member of the category “people” whereas for others it would not because he is immortal.

Fuzzy and vague symbols (and semiotic entities) such as “people” can be made more precise, hence reducing the uncertainty of what their referent is, by applying semiotic entity refinements. For example, the descriptive update 714→716 of FIG. 7, that is, 1@d→6@e, is a refinement which replaces the vague representative 701, that is, {1}“people”>, with the more precise “flavor” of the “people” category given by 707, that is, {6}<pluck( . . . )>. Indeed, the “people” category symbol 707 created by the signification event 716 is constrained to include “fictional characters”, so that its meaning (referent) is more precise (more constrained) than the vague “people” category represented by 701, for which it is not specified whether it may include fictional characters.

In the above example (FIG. 7), category symbols are built to partition the “people” category:
{5}<category(“fictional characters”), subset, category(“people”) >
{6}<pluck(category(“fictional characters”) from 5>
{7}<pluck(category(“people”) from 5>
   Semiotic entities with representative symbols {6} and {7}, respectively, are refined semiotic entities of the semiotic entity {1@a} (that is, the semiotic entity created by event 1@a), so that, in a subsequent session @d, one can use reference 6@d to mean “fictional characters” and reference 7@d to mean “any person including possibly a fictional character”. Furthermore, the coarse “people” semiotic entity {1@a} is structured as having two semiotic sub-entities {6@e} and {7@e} (created at signification events 6@e and 7@e respectively), and possible a third semiotic sub-entity corresponding to non-fictional characters.

It should be noted that a distinction is made herein between semiotic entity refinement and category refinement. Indeed, as a category, 707 of FIG. 7 is not a refinement of 701 since fictional characters are certainly allowed in 707 but, perhaps, they are not allowed in 701, therefore, all individuals belonging to 701 also belong to 707, that is, 707 is “greater or equal” to 701.

On the contrary, as a representative symbol of an entity, 707 is a refinement of 701, i.e., 707 is “smaller” than (included in) 701. Indeed, some users would not consider fictional characters as being people (the IRS would not, for example); therefore, a possible interpretation of 701 is: “category of all real people to the exclusion of fictional characters”, whereas this interpretation is not possible by 707. Hence, 707 is strictly “smaller” than (included in) 701. In other words, semiotic entity 707 is more refined and more precise than 701, even though it contains more individuals than 701 as a category.

Two other similar semiotic entity refinements are shown in FIG. 9.

### 4.11 Consolidation

Semiotic entity consolidation (or consolidating re-representation) is an informative re-representation which upgrades the representative so that all the information gathered throughout the history of the semiotic entity is included (transferred) into the new representative. As such, a semiotic entity consolidation must be subjected to a validation step to ascertain for which of the semiotic points in its history the new representative is pertinent.

In a consolidating re-representation, the compositions realized by a semiotic entity (or semiotic sub-entity) are grouped into an aggregate symbol (sometimes called a consolidated summary) functioning as the new representative symbol of the semiotic entity (or sub-entity). Consolidation consists in grouping existing symbols into a larger symbol (requires semiotic unification) so as to reinforce information about the underlying entity by confirming that the consolidated symbols indeed belong together.

### 4.12 Refining Analysis of Semiotic Entities (Semiotic Analysis)

As a vague, fuzzy semiotic entity such as one representing the category “people” evolves, the extended meaning represented by the collection of semiotic points in its history becomes more complex, and embodiments of the disclosed invention construct more refined semiotic entities to capture some of the specific meanings arising within this history-induced extended meaning. This results in a plurality of semiotic entities which are organized hierarchically, typically with refined flavors of semiotic entities being “contained” as semiotic sub-entities in coarser flavors.

For example, consider the semiotic entities 721 and 722 of FIG. 7, representing two flavors of the “people” category. Initially, in session @a, there exists only one semiotic entity, 721, and its extended meaning is quite vague since its history contains only the creation event 711.

In session @b, the user decided that this vague category was not appropriate to create a sample containing “Harry Potter”, etc., so that a new semiotic entity, 722, was created for this purpose. This new semiotic entity has a somewhat more refined meaning because it has been used according to an interpretation which allows the inclusion of fictional characters.

In session @c, the first flavor 721 was used to realize a sample including famous soccer players so that this semiotic entity, which was initially very vague, has attained a more precise meaning; for example, it has been clarified that it includes people that the user does not personally know (some users may have instead a “people” category in their address book which includes only people that they know).

In session @d, semiotic entity 722 realizes another sample and in session @e it undergoes a refinement update which makes it explicit that it includes fictional characters.

These two semiotic entities, 721, and 722, could be made sub-entities of a coarse “people” semiotic entity whose structure clearly represents its different flavors (this coarse “people” semiotic entity is not shown in FIG. 7).

Whereas this unifying coarse overarching semiotic entity is not shown in FIG. 7, the example of FIG. 9 explicitly shows a coarse semiotic entity 960 containing two refined flavors of a symbol, namely of the category symbol “MyFriends”, as could be used in a personal digital agenda to collect information about friends and acquaintances. The two semiotic sub-entities of 960, namely 941 and 945, represent respectively a “MyFriend” category which includes co-workers and one which explicitly excludes co-workers.

In a first possible scenario, these two category flavors may emerge from interactions of the memory system with distinct users, since a first user may prefer to include co-workers in their “MyFriend” list, while a second user may prefer to maintain two distinct lists.

In a second scenario, the same user initially includes co-workers in their “MyFriends” list and then decides to reserve the “MyFriends” category to close personal friends and to create a separate list for co-workers, hence modifying the meaning of the category “MyFriends”.

The structure of the graph, which is described next, is the same in both scenarios; the difference is simply reflected in the ownership of the sessions (distinct users own the sessions as opposed to having one user own all the sessions).

In the first session shown in FIG. 9, the category symbol 901, <category(“MyFriends”)>, is used to create a sample 911 containing two people who are “proper” friends of the user owning the session (that is, these two people are not co-workers of the user). This session is denoted @b, to suggest that there may be a previous session, @a, where the category symbol 901 was created. The creation event of the sample, 931, is the inception point of the history of the semiotic entity 951, representing the actual list of friends. The reference to the category 901, namely the semiotic point 921, is appended to the semiotic entity 941, representing the “MyFriends” category.

The semiotic point 932 represents some unspecified event involving the sample 911 resulting in the symbol 912. For example, 912 could be a sentence saying that the user met these people on a particular day.

In session @d a user who could be the same user (second scenario) or a different user (first scenario), refers to category 901 to update the list of people by adding a third person, “Zoe”, who is actually a co-worker. The creation event of this sample, 933, is linearly linked to 932 and the semiotic link from 932 to 931 is labeled “StU”, to indicate that this is a state update. At this point in time after session @d, the meaning of semiotic entity 941, presumed from its history including 921 and 923, is one which considers “co-workers” as being members of the “MyFriends” category.

The box 990 contains events occurring during session @e. In this session, a user who could be the same user or a different user, decides that it is desirable to have a “MyFriends” category containing only “friends” in a stricter sense, for example, containing only close personal friends; and that co-workers should instead be in a distinct category. Therefore, there should be two flavors of the “MyFriends” category, one which includes “co-workers”, 904, and one which excludes “co-workers” 905.

To attain this goal, a category “Coworkers” is created, 906, and made a subset of “MyFriends” by means of the subset statement 971, which is used to annotate 901, resulting in the annotation aggregate symbol 904 representing a “MyFriends” category which includes co-workers.

To create a flavor of “MyFriends” category which excludes co-workers, a partition symbol 972 is created which states that “MyCoworkers” and “MyFriends” are disjoint sets. By annotating category “MyFriends” with partition symbol 972 one obtains a flavor of the category “MyFriends” which excludes co-workers, 905. By appending the semiotic point 925 representing the meaning of 905 in session @e to the history of semiotic entity 941, after rewinding to 921, one obtains a flavor of the “People” category entity which excludes co-workers.

This situation could arise if all sessions are owned by the same user and this user decides in session @e that is more useful to store “friends” and “co-workers” in distinct categories (second scenario). Or it could arise if the owner of session @e is distinct from the user of the previous sessions and he/she uses a different classification scheme, one where friends and co-workers are stored separately and if this second user wishes to import the “MyFriends” data from the first user (first scenario).

As an additional example of how coarse entities can be analyzed into finer sub-entities, consider the category symbol: <category(“computer file”)> and the two “computer file” samples with identifiers {file1} and {file2} respectively
<{file1} “is a”, category(“computer file”)>,
<{file2} “is a”, category(“computer file”)>.

Consider now the two expressions:
<“Yesterday, Sally edited”, file1>
<“Yesterday, Sally renamed”, file1, “to”,file2>.
   The first expression states that yesterday Sally edited the (content of) file1; the second states that yesterday Sally renamed the (file path of) file1 to file2. Hence, in the first expression a “computer file” refers to some digital content which can be edited; in the second, it refers to a file path.

Both types of expressions are quite natural and could be employed by a human user to record transactions over an extended period of time, resulting in a long thread labeled by the above category symbol in which the two distinct meanings of “computer files” are used side by side. Human users indeed the term computer file without paying attention to whether the refer to a file path or to the content itself. As before, the coarse semiotic entity “computer file” can receive two refinement updates to yield two semiotic sub-entities that reflect the more specific meanings.

### 4.13 History Re-Representation and Regularization of Semiotic Entities

A descriptive re-representation may be addressed to a particular set of history points, which would then typically form a semiotic entity or a semiotic sub-entity. In this situation, the new representation should be broad (inclusive) enough so as to be pertinent to all the targeted points and, at the same, tight enough to be as descriptive as possible.

For example, following a rewind, embodiments of this invention may re-represent the new branch with a new distinctive symbol and create a semiotic sub-entity so as to avoid the creation of a non-linear entity, which is considered to be a non-regular entity (a definition of regular entities has been given earlier).

Regular entities are easier to implement because every representative symbol only has to store a linear history which can be conveniently stored in an array, whereas irregular entities may need to store non-linear threads with bifurcations requiring additional machinery (in regular entities bifurcations are managed at the semiotic entity level rather than the history-point level). Relabeling a branch with a distinctive representation is referred to as semiotic entity regularization or semiotic entity normalization.

### 4.14 Entity Joins and Reconciliations

A join occurs when a new history point (semiotic point) is recognized to be linkable to multiple points, for example, to a pair of distinct semiotic entities (double linking). A reconciler symbol is created at the join point. Embodiments of this invention may carry out three different types of joins.

(1) A semiotic entity merge-join takes place when two distinct semiotic entities, with possibly distinct representatives, are recognized to have the same (or substantially the same) meaning so that a unique representative is appropriate for both semiotic entities. A new join point is created (whose signifier is a reconciler stating that the representatives of the semiotic entities are equivalent) and linked to the histories of both semiotic entities (or of any number of semiotic entities for which the merge-join is applicable). A new semiotic entity is created which includes the previous semiotic entities as sub-entities. This new semiotic entity effectively “replaces” the existing semiotic entities which, normally, are no longer be extended.

(2) A boundary-join occurs, for example, when a symbol has been used to convey radically different meanings, such as the “mouse” symbol of FIG. 6 (entity boundary detection). In this situation, a new “boundary” symbol reconciler, such as 608 of FIG. 6, is created to record that an ambiguous “multi-sense” symbol has been detected and to record what these meanings are (more precisely, to record the semiotic histories giving rise to the conflicting interpretations). A boundary-join symbol can be likened to a dictionary entry which lists the possible meanings of a word.

(3) A fuzzy-join (or fuzzy reconciliation) occurs when two semiotic entities meet which have overlapping meanings or distinct meanings whose boundary is “fuzzy”. These semiotic entities may have the same representative or distinct representatives. A new coarser semiotic entity is created which includes both meanings.

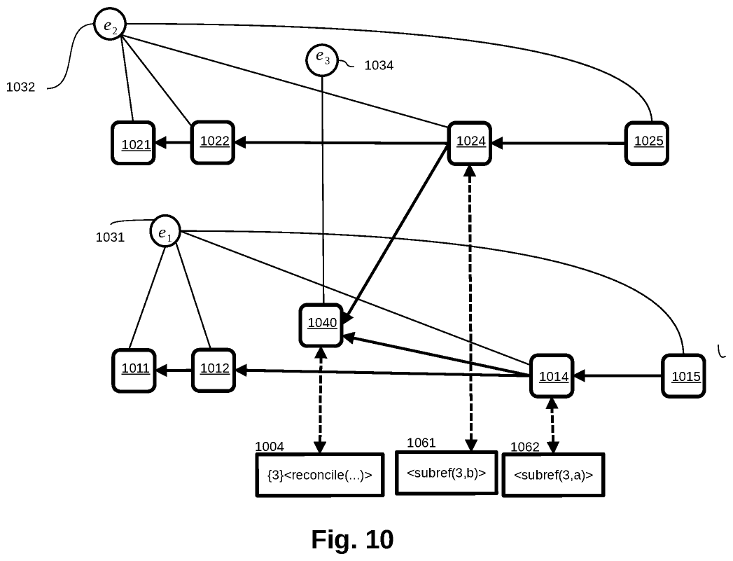

With boundary-joins and fuzzy-joins, the semiotic graph typically has a crossover topology, as illustrated by FIG. 10. Before the session where the join occurs, the two semiotic entities 1031 and 1032 evolve independently from each other. In the example shown, 1031 has history points 1011 and 1012 whereas 1032 has history points 1021 and 1022.

At the join session, a reconciler event 1040 is created whose signifier is a reconciler symbol 1004 (e.g., the boundary symbol 608 of FIG. 6). A new semiotic entity 1034 is created whose incipient point is 1040. If the join event is a boundary detection, the new entity 1034 represents a “dictionary entry” containing multiple distinct (and incompatible meanings). If the join event represents fuzzy reconciliation (fuzzy join), then the new semiotic entity is a “coarser” (fuzzier) entity which includes the extended meanings of 1031 and 1032, such as semiotic entity 960 of FIG. 9.

After the join, each of the pre-existing meanings are still accessible; their corresponding histories can be extended both from the history point which triggered the join and from the reconciler point (double linking). Indeed, semiotic point 1014 links to both 1012 and 1040, and 1024 links to both 1022 and 1040. New signifiers 1061 and 1062 can be built by “sub-referencing” (or plucking) the reconciler symbol 1040. These new signifiers 1061 and 1062 can be used as new representatives of the semiotic entities 1031 and 1032 respectively. These new representatives declare explicitly the relationship with their “conflicting” sibling. For example, given the multi-sense reconciler 608, the “device” interpretation of “mouse” could be “entry-a” of the reconciler 608 and the “rodent” interpretation could be “entry-b”.

After the join and the double linking, the two semiotic entities can continue to evolve independently of each other (1015, 1016) but their representatives are more “informed” in that they carry the “mark” of the join (crossover).

To motivate more precisely reconciliation, we consider a variation of the scenario illustrated by FIG. 9, where the coarse super-entity 960 comes from reconciling two (conflicting) flavors of “MyFriends” which have been developed and used by distinct users (Albert and Beatrice).

A first user Albert maintains a list of his friends under category symbol:
{a1}<category(“my friends”)>
   and includes coworker in this list. Albert's memory system contains two semiotic entities, one with representative symbol <category(“my friends”)> and a second one with representative symbol
<sample({m1}category(“my friends”), “Bill”,“Cindy”, . . . >
   containing the actual time-varying list of his friends and co-worker.

A second user, Beatrice, independently of Albert, maintains two separate lists, one for friends and one for coworkers, under categories
{b1}<category(“my friends”)>
   and <category(“my coworkers”)> respectively. Beatrice needs a total of 4 semiotic entities for storing his information (two for the two categories and two for the two lists themselves).

Albert decides to import Beatrice's information into his memory system. To do so, he needs to reconcile two slightly different meanings of the symbol <category(“my friends”)>, his version {a1} which includes coworkers and the exogenous version, {b1}, which originates from Beatrice and excludes coworkers.

After importing Beatrice's symbols and entities, Albert (in collaboration with his memory system) joins Beatrice's semiotic entity thread of her “my friends” category with his own, to yield a super “my friends” entity which contains his and her “my friends” category semiotic entities as sub-entities (compare with 960 of FIG. 9). This semiotic super-entity is coarser than the two semiotic sub-entities since it includes usages of <category(“my friends”)> which include coworkers and usages of <category(“my friends”)> which exclude coworkers. The coarse “my friends” semiotic entity has two inception points (one from Albert and one from Beatrice).

At the symbol level, a new reconciler symbol is created at the join point
{c1}<reconcile(a1,b1)>.
   From this reconciler, Albert can derive a version of his <category(“my friends”)>, {i1}, which is “informed” of the existence of a conflicting version:
{a2}<pluck(a1 from c1)>.
   Similarly, Albert can derive an informed version of Beatrice's version:
{b2}<pluck(b1 from c1)>.

The conciliator {c1} may be used as representative symbol of the coarse semiotic entity 960 obtained by joining Albert's and Beatrice's “My friends” semiotic entities.

Note that if reconciliation is between semiotic entities with radically distinct meanings (such as the “mouse” example), then a coarse semiotic entity cannot be created.

### 5 Symbol Search, Ingestion and Identification

### 5.1 Symbol Ingestion

A critical step carried out by embodiments of the disclosed invention is ingestion of an ingestible symbol which may be
a. a fresh unidentified input symbol created, composed, imported or searched during the current session; or
b. an inference-borne symbol born or emerged during an inference phase, such as:(1) a goal symbol , (2) a hypothesized symbol or an (3) inferred symbol.

Ingestion includes the step of identification of the ingestible symbol, which consists in assigning a symbol identifier to it, either by finding a match for the ingestible symbol in the memory system (or elsewhere), or by storing the ingestible symbol in a newly allocated and identified memory record, or by saving it temporarily in short-term memory.

In some applications with limited memory resources where the goal is to communicate or transmit information a new symbol identifier may be assigned without there being a memory record containing the ingestible symbol.

Recall that, in typical embodiments, a symbol having an identifier form is known to be already saved in memory (either long-term or short-term) or as a resource on a network such as the world-wide web. This identifier may specify the location of a record in a long-term memory device, or it could be a link or pointer to a permanent resource on a network.

Alternatively, the symbol identifier may be a provisional identifier which may be eventually discarded if the symbol is eventually not deemed suitable or worth for long-term storage.

On the other hand, for an ingestible symbol not having an identifier there may, or there may not be, a matching symbol instantiated in memory or on a network. The ingestion procedure then searches for a match to said ingestible symbol inside the memory system (or elsewhere, e.g., on a network) and returns the resulting identifier (or identifiers) if the search succeeds. If instead a match is not found, the ingestion procedure saves the ingestible symbol in memory and returns the identifier of the newly created record.

As a result, ingestion always returns a symbol identifier, either a pre-existing one or a new one, and ensures that the ingestible symbol is either instantiated in memory (or a network) or matched to a sufficiently similar existing and identified symbol.

In some embodiments, ingestion may return multiple identifiers if more than one valid match has been found.

### 5.1.1 Ingestion Phases

To better understand the disclosed invention, it is useful to distinguish three phases in the ingestion process: search, closing, and grooming.

The search phase consists in exploring the memory (and possibly an external network) so as to find existing instantiated symbols matching the searched symbol.

The closing phase examines the matches found during the search phase (if any) and makes a decision on what to do next, possibly with the assistance of an external user or agent or semiotic master.

Examples of outcomes of the closing phase: 1) returning the identifier of the best match found; 2) returning two or more possible matches, thus leaving to subsequent stages the responsibility of deciding whether one of these possible matches can be considered to be a best match 3) saving (short-term or long-term) the searched symbol and returning the new identifier thus generated or 4) continuing the search, either to find additional matches or to find more supporting evidence if the found matches are based on inferential derivations.

Memory grooming includes several tasks that are useful for preparing the memory system to forthcoming ingestions and other types of processing. Some of these tasks may be carried out or initiated during the search phase or the closing phase. The grooming phase however can extend past the closing phase and may continue while the memory system is in a “sleeping” state waiting for the next interactive session.

In some embodiments, if it is known beforehand that the ingestible symbol is not present in memory, (or if the likelihood of finding a good match is low) then the ingestible symbol may be saved outright without attempting to find a match, resulting in a new identifier being assigned to it.

Similarly, if the search phase has been launched but has not completed after a certain predetermined amount of time, the memory system may decide to switch to the closing phase by treating the searched symbol as an unmatched symbol so that it can be assigned a provisional or permanent identifier and used to compose (or infer or hypothesize) new symbols.

In general, the search phase may be deferred and completed at a later time, possibly offline or during a memory grooming phase; if this deferred search finally succeeds to find a match, then this late match may be “merged” or reconciled with the previously assigned identifier to control or reduce redundancy.

In any case, if search fails and reports a non-existent match when one exists (failed symbol match) then a redundant copy of the symbol is created (double storing; failed symbol integration); as mentioned above, this error can be recovered (e.g., during the grooming phase) by merging the two copies when their similarity of equivalence is ascertained by the memory system or by an external user.

### 5.2 The Search Phase

Embodiments of this invention carry out symbol search by means of a variety of methods and procedures adapted to the type of the searched symbol (e.g., primal vs. non-primal), its form (exploitable form, compositional code, compositional expression), the available computational resources, and whether the searched symbol is a query symbol (referred to as indefinite symbol) or not (definite symbol). Many of the procedures useful for searching definite symbols are also useful to process a query, so that this invention treats query processing in a way similar to ingesting a definite symbol.

Whenever appropriate, these embodiments take advantage of the compositional structure of symbols by treating its constituents (if any) as searchable constituents (compare with the “standard” recursive compositional encoder described earlier). That is, a symbol having searchable constituents is typically searched by first searching and ingesting its constituents.

Moreover, constituents may also be used as search enablers, in which case they are called search-enabling constituents, or probe components. A probe is a set of symbols (typically a set of ancestors of the searched symbol) use jointly to assist (aid) the search, typically by enabling the calculation of a set of potential matches.

### 5.2.1 Exact Symbol Matching

One group of search methods, which are based on exact search of the input ingestible symbol, return only instantiated symbols that match exactly the ingestible symbol. Many such methods known to those skilled in the art may be used in embodiments of this invention.

For example, key-value hash maps and bidirectional key-value hash maps can be used for associating a symbol identifier (the key of the hash-map) to a symbol form instance (the value of the hash-map) such as a compositional code, a primal value, a raw primitive exploitable form, a Java object, etc.

Symbol ingestion is straightforward with this type of data-structures: the input ingestible symbol in inserted into the key-value map and, if the symbol is already present, its corresponding symbol identifier is returned; if it is not, then the ingestible symbol is memorized into the key-value and its newly created identifier is returned.

These types of methods may be appropriate when the ingestible symbol lacks internal (compositional) structure, which is the case, for example, for primitive symbols.

One disadvantage of these conventional data-structures is that they require large amounts of memory resources. To reduce the amount of memory resources required and to expand the applicability of the disclosed memory system, this disclosure describes some exact compositional search methods applicable to code-bearing symbols which take advantage of their compositional structure. Moreover, these disclosed compositional methods can be generalized to carry out approximate and inferential searches.

### 5.2.2 Interleaving Hypothesis Generation, Verification, and Inferential Search

This disclosure describes a search methodology consisting of up to three stages: (1) hypothesis generation, (2) hypothesis verification and (3) inferential search.

The first stage, hypothesis generation, generates a set of potential matches to the searched symbol. As described later, to generate hypotheses, the disclosed method uses different types of compositional lists containing descendants and approximate descendants of symbols.

Hypothesis verification, which typically performs a one-by-one analysis of each potential match generated by the first stage, prunes out invalid matches and may also rank multiple matches in order of a match-quality measure. Hypotheses verification is not needed if hypotheses generation is guaranteed to generate valid matches only.

Finally, an inferential search may be executed, for example, if no valid match has emerged from the previous two stages or if it is desirable to extend the search to non-instantiated symbols which may be obtainable by applying inference derivations to the existing set of instantiated symbols.

These three stages may be executed in an interleaved fashion; for example, a quick and rough search could be run at first by generating a small set of hypotheses and then a second larger set of hypotheses only if the first shot has not generated an acceptable match.

### 5.2.3 Relaxed Search (Approximate Matching)

These three search stages can be restricted to exact matches, or the search can be relaxed (that is, extended) to approximate matches by means of explicit representations of topological relationships between symbols. Techniques for approximate search such as constituent relaxation and containment (subsumption) relaxation will be disclosed. Again, an optional (and more resource intensive) approximate search is typically executed only if a first quick search for exact matches has not yielded any sufficiently good match.

### 5.2.4 Using Feature Aggregates for Searching (Shallow and Multi-Depth Lists)

Feature aggregates (that is, annotation aggregates, descriptive symbols, etc.) obtainable (for example) from semiotic entity consolidations, play an important role as they greatly contribute to speed-up search and to reduce the need of semiotic verification and deep inferential searches.

Whereas non-aggregate symbol may often be searched by means of shallow composition lists and shallow constituent lists (which contain only direct descendants and ancestors, respectively), the search for aggregate symbols typically requires multi-depth descendent lists and multi-depth ancestor lists.

When a feature aggregate (or any symbol in general) is not completely matched, inferential links can be established on the base of partial matches so as to open up potential inferential paths that may provide the missing features.

### 5.3 Exact Matching by Means of Compositional Lists

### 5.3.1 Compositional Structure of the Memory Graph

Recall that each stored code-bearing symbol is defined by a compositional code c=[p₀, . . . , p_{N}] and is representable in a compositional memory graph by a node whose parents are the nodes representing its direct constituents. For the sake of clarity, it is assumed that the above defining code is flat, that is, the labels p₀, . . . , p_{N} of these constituent nodes (parents) are assumed to be symbol identifiers. Flat compositional codes are obtained, for example, by ingesting the builder and the arguments of a compositional expression <X (p₁, . . . , p_{N})>, or by encoding a primitive symbol.

In some embodiments, symbol identifiers are integers or tuples of integers.

Recall that a downward (or descending) link in this compositional memory graph (from a node to one of its parents) represents a dependency relation between a symbol and one of its constituent parents; indeed, the child node ontologically depends on its parents for its existence and its definition. In FIGS. 8, 9, 11A, 11B, 16, 17, these downward links correspond to the diamond-headed arrows from the parent nodes to the child node going in the opposite direction.

In the Universal Modeling Language (UML), a diamond-headed arrow indicates the “aggregate” relation (not to be confused with aggregate symbols used in this application). Note that in FIG. 8, 9, 11A, 11B, 16, 17 these UML arrows point in the upward direction. They indicate that the child symbol is obtained by composing (“aggregating” in UML terminology) its parents (depicted below its children) and that these parent nodes exist independently of the child node. Again, this should not be confused with UML “composition”, which entails that its parts do not exist independently.

Also, the dependency relationship between constituent symbols and the composed symbol should not be confused with the relationship between the corresponding “physical” referents. Consider for example the multiform symbol: {1}<“A dog, which has four legs”>. Its constituent symbol {2}“four legs”> exists independently of {1}, whereas the four legs of the dogs do not exist independently of the dog they are attached to.

To summarize, in this disclosure, the constituents of a composite symbol are the dependencies of the composite symbol and the composite symbol is a dependent of each one of its parents. The composite symbol is also said to be a composition of each one of its parents (whereas in UML terminology it would be said to be an “aggregate”).

Constituents of constituents (and so on recursively) are referred to as nested or indirect constituents (or dependencies). Direct constituents (or dependencies) refer to the immediate constituents of a symbol (that is, its ancestors at depth=1 in the memory graph); they are said to be the depth-1 (or 1-st degree or degree-1) constituents.

The set of general constituents (or recursive constituents) of a symbol includes all constituents (direct and nested) and the symbol itself (which is its own depth=0 constituent). This set of symbols corresponds to a subtree of the memory graph, which is normally considered to be immutable and is referred to as a compositional tree (or ontological subtree, to emphasize that it provides the defining elements for the child node).

The set of nth-degree constituents (ancestors) of s is denoted A⁽ⁿ⁾(s) and corresponds to the set of ancestors at depth=n of the compositional tree of s; thus, the parents of s are denoted A⁽¹⁾(s).

Symbols which are (or can be) combined to compose a composite symbol are said to be composable constituents. The constituent symbols (or ancestors) of a composite symbol which may be used for searching the composite symbol are said to be its search-enabling constituents or ancestors. A set of search-enabling ancestors used for searching a symbol is called a probe and is denoted P(s) or simply P.

A probe normally includes direct ancestors (parents); for some type of composite symbols, notably descriptive symbols obtained by aggregating annotations of a featured symbol, it may be useful or necessary to include degree-2 constituents in the probe.

Indeed, a degree-1 constituent becomes a degree-2 constituent after a symbol (e.g., a propositional symbol) is grouped with other symbols to yield an aggregate descriptive symbol. For example, the predicate <“likes movies”>, a degree-1 constituent of 813, becomes a degree-2 constituent once 813 is grouped with 812 and 814 into descriptive symbol 807.

Along the upward direction, an upward or ascending or bottom-up compositional link from a constituent (parent) symbol to a child node represents an occurrence of the parent symbol in the child symbol: the child symbol is created after the parent symbol by using and referring to the parent symbol.

A compositional bottom-up link is depicted as a UML-aggregate diamond-headed arrow in FIG. 8, 9, 11A, 11B, 16, 17. Sometimes, such as in FIG. 9, the nodes related by a link are shown touching each other. The list of degree-1 children (compositions) of a symbol s is denoted: C⁽¹⁾(s).

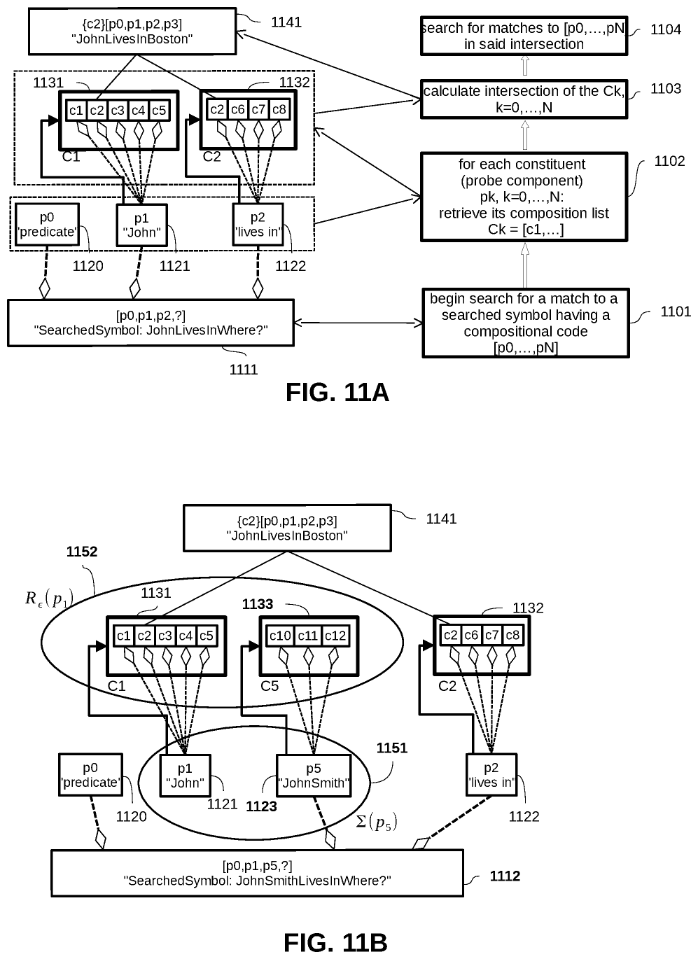

For example, in FIG. 8, after session @d, the symbol {1}<“John”>, 801, has three compositions, namely 812,813,814, so that its composition list, C⁽¹⁾(“John”) , contains the identifiers of the symbols 812,813,814, that is, C⁽¹⁾(“John”)=C⁽¹⁾({1})={{2},{3},{4}}. In FIGS. 11A and 11B, the symbol “John”, 1121, is shown as having a composition list 1131 containing five elements.

Embodiments of the disclosed invention maintain lists of bottom-up ascending links (composition lists) for certain symbols referred to as tracked symbols (or vertically-tracked symbols). If s is a tracked symbol, then C(s) denotes the list of its compositions which is maintained by the memory system. This list is updated every time s is used to create a new symbol and is therefore time-varying; contrast this with the subtree of ancestors (the compositional tree) of s, which is normally immutable.

The linear order of a composition list represents the time order in which compositions have been created, provided that new ones are always appended to the end of the list.

### 5.3.2 Bottom-Up Intersection Search Method

Embodiments of this invention search for a match to a code-bearing ingestible symbol x which is defined by a pure compositional code x=[p₀, . . . , p_{N}], and whose direct constituents (assumed to have been already ingested) are given by the symbol identifiers p₀, . . . , p_{N}, by first calculating a compositional hypotheses list (CHL) which contains potential matches for x.

Such a list is said to be complete if it is guaranteed to contain all instantiated symbols matching the searched symbol; inferrable matching symbols are not required to belong to a complete CHL.

For example, in FIG. 8, if x is a query involving “John”, such as “Where does John live?”, issued after session @d, then an example of a complete compositional hypotheses list is {{2},{3},{4}}, that is, the list of all the instantiated composite symbols containing (referring to) the string “John”.

Some embodiments of this invention order the composition lists C(pₖ) according to size and then search for match in these lists, starting from the smaller list.

Another strategy adopted by some embodiments is to calculate the intersection of composition lists over two or more search-enabling constituents (i.e., probe components) selected from p₀, . . . , p_{N}. More generally, an arbitrary set P of search-enabling (vertically tracked) constituents (of any degree) may be used as a probe, to yield the compositional hypotheses list

$$H ( P ) = {⋂}_{a ∈ P} C ( a ) . \qquad [ CHL ]$$

For searching descriptive symbols, it is necessary to use a probe P which includes degree-2 ancestors; and it is necessary that the composition lists C(a) include degree-2 compositions.

In some embodiments, descriptive symbols are searched in a separate step wherein C(a) contains only degree-2 descendants and P contains only degree-2 ancestors.

In other embodiments descendants (ancestors, respectively) of different degrees are merged in the same list; this results in a more complex top-down verification step but allows to recover more complex candidates.

The disclosed intersection search method is further illustrated by the example shown in FIG. 11A, where the probe used to search for the given symbol is given by the set of direct constituents of the searched symbol, that is, p₀, p₁, p₂, p₃?, where the latter is a queried probe component.

Step 1101 begins the search for a match to a searched symbol having a compositional code [p₀, . . . , p_{N}]. Specifically, in the example shown, the searched symbol is a compositional query [p₀, p₁, p₂, p₃?], where (compare with 801 of FIG. 8)
{p₀}<:predicate> (1120)
{p₁}<“John”> (1121)
{p₂}<“lives in”> (1122)

Step 1102, which is repeated for each probe component {pₖ}, retrieves the list of dependent symbols (the composition lists) of pₖ, C(pₖ). FIG. 11A (as well as FIG. 11B) depicts the lists C(p₁) and C(p₂), 1131 and 1132, having respectively 5 and 4 elements.

Step 1103 calculates the intersection (CHL) which, in the example shown, contains only one element: [p₀, p₁, p₂, p₃], where p₃ is <“Boston”>, a potential match to the queried probe component p₃? In general, the compositional hypotheses list CHL contains many more elements, most of which are not valid matches to the probe.

Step 1104 searches for a valid match to the searched symbol [p₀, . . . , p_{N}] among the match hypotheses contained in the compositional hypotheses list CHL and performs the necessary top-down verification.

If the code corresponds to a query symbol (as in the example shown in FIG. 11), such as the compositional query form: [p₀, . . . , pₖ?, . . . , p_{N}], wherein pₖ? denotes a queried probe component (slot), then at least one of the composition list is missing from the above formula; the same situation occurs if a constituent is excluded from the probe, for example, for computational reasons of because it is not a tracked symbol.

Matches found for queried components are returned as the result of the query.

### 5.3.3 Compressing Compositional Lists by Means of Session Identifiers

In some situations, embodiments of this invention reduce the size of the composition lists by using lists of session identifiers instead of a list of the compositions themselves. For example, a particular symbol representing the category “computer file” may be used thousands of times in a particular session where, for example, thousands or millions of files are scanned. In this case, the composition list of “computer file” can be greatly reduced by including the session identifier only in the list used to determine compositional hypotheses (however, the large list of files would still to be scanned to find potential matches).

### 5.3.4 The Verification Stage

The candidate symbols in the compositional hypotheses list obtained by calculating the above intersection are examined individually in order to find one or more valid matches (top-down hypothesis verification). Each hypothesis in the CHL may be tested for:
a) Matches found for queried (or missing) probe components must be equal to or consistent with any constraint on the probe component specified in the query. An equality constraint may be relaxed to a containment or subsumption constraint. For example, a descriptive symbol may be matched by a descriptive symbol which contains all of its features plus additional features; a category symbol may be matched by a sub-category; a propositional symbol may be matched by one which extends it with one or more adjuncts (e.g., “The cat chased the mouse” may be matched by “the cat chased the mouse under the table”).
b) the order in which constituents appear in the tested hypothesis must be the same (or consistent with) the order in which they appear in the query.
c) logical coherence: multiple occurrences of a propositional symbol must have the same truth value.
d) semiotic coherence: multiple occurrences of a symbol must represent the same referent.

The last two constraints are especially relevant for multi-depth search involving descriptive symbols where sets of features are matched against sets of features and there is at least one symbol which occurs multiple times (e.g., “John”, 801, occurring in 812,813,814 in FIG. 8).

### 5.3.5 Other Methods for Compositional Search

In some embodiments, the compositional hypotheses list is refined sequentially by applying the composition lists of its constituents in succession. More specifically, this method executes the following steps: 1) order the composition lists according to length: the shorter list comes first, etc. 2) If the first list is short enough, test all candidate symbols by comparing them with the searched symbol; if not 3) calculate the intersection of the first few lists and the carry out the test on the intersection.

In some scenarios it may not be possible to maintain composition lists for certain symbols, especially if these lists are very large. An alternative method is to select one tracked constituent (sometimes referred to as pivot); then retrieve its compositions from the memory system and test each composition for equality (or near equality if performing a relaxed search) with the search symbol.

### 5.3.6 Limits of Exact Matching, Benefits of Approximate and Inferential Matching

Search methods limited to exact matching, which ignore the topological structure of the symbol space, that is, equivalence, proximity, similarity and subsumption relations between symbols, have limited applicability. Specifically, restricting the search to exact matches doesn't take into account that a typical information element can be represented by more than one symbol (vocabulary mismatch, symbol redundancy) and that both humans and artificial system (especially humans) do indeed utilize different symbols to convey the same meaning or to represent the same referent.

Humans are not inclined to express themselves in exactly the same way when referring to a piece of information multiple times and may end up using a different expression when requesting a piece of information from what they used when storing it. Forcing users of the memory system to represent information in the same way consistently over long period of times may place a big burden on them, even more so when this constraint is imposed on several users, since all users would then be forced to adopt an identical symbol-to-meaning representation map.

Moreover, methods limited to exact search break down in the presence of noise, for example, deviations in primal spaces between ingestion-time and search-time values.

Embodiments of this invention overcome these limitations by enabling the search for approximate matches of searched symbols. An example of this, subsumption relaxation in hypothesis verification was mentioned earlier.

Moreover, some embodiments also take into account logical and inferential relations so that, for example, <“Garfield the cat”> may be returned when querying for an <“animal”>, based on the (stored) information that <“cats”> are <“animals”>.

### 5.4 Relaxed Compositional Matching

The method described earlier generates a complete hypotheses list which is guaranteed to include any composite symbol whose constituents match exactly the constituents of the searched symbol. This method fails to find matches in which a constituent of the instantiated symbol is equivalent but not identical to the corresponding constituent of the searched symbol, for example, if the constituents <“John”> and <“JohnSmith”> are both used to refer the same person (see the example shown in FIG. 8).

To overcome this limitation, embodiments of this invention augment the “vertical” search carried out by means of the bottom-up composition lists with a “horizontal” search obtained by “jiggling” a probe component pₖ within a slack search region Σ(pₖ) containing symbols which are equivalent or similar to pₖ.

Jiggling a constituent pₖ yields a relaxed composition list R(pₖ) which contains every composition having a reference to pₖ or to another symbol within its slack region Σ(pₖ), that is:

$$R ( {p}_{k} ) = {⋃}_{\tilde{{p}_{k}} ∈ \sum ( {p}_{k} )} C ( \tilde{{p}_{k}} )$$

FIG. 11B illustrates this constituent relaxation method. In the example shown in FIG. 11B, the ingested symbol is 1112, which differs from 1111 in that the probe component “John” (that is, 1121) has been replaced with the probe component “JohnSmith” (that is, 1123). By “jiggling” the probe component 1123 to 1121, one obtains the relaxed compositional list 1152, which also includes the hypotheses contained in 1131, wherein 1131 is the composition list of the probe component “John”, 1121.

Note: a constituent may be relaxed to a subsumed symbol (category “animal” may be substituted by category “cat”, whereas category “cat” may NOT be substituted by category “animal”). More specifically, when the searched symbol is a category symbol, the searched slack region may contain its sub-categories.

Note: When matching a descriptive symbol, the searched slack region may contain its supersets.

By using relaxed composition lists to calculate a hypotheses list one obtains the following relaxed compositional hypotheses list:

$${⋂}_{{p}_{k} ∈ {A}^{( 1 )} ( x )} R ( {p}_{k} ) = {⋂}_{{p}_{k} ∈ {A}^{( 1 )} ( x )} {⋃}_{\tilde{{p}_{k}} ∈ \sum ( {p}_{k} )} C ( \tilde{{p}_{k}} )$$

which contains instantiated candidate symbols which are approximations of the searched symbol. In the above formula, the set Sigma(p_k) is the slack search region for p_k.

More generally, when a set of ancestors P is used as probe the resulting set of hypotheses is:

$$Γ ( P ) = {⋂}_{a ∈ P} R ( a ) = {⋂}_{a ∈ P} {⋃}_{\tilde{a} ∈ \sum ( a )} C ( \tilde{a} ) \qquad [ RCHL ]$$

As before, the RCHL must undergo a top-down verification and filtering step to ensure proper ordering of the probe components, semiotic and logical coherence, etc.

This method can be applied to constituents of the searched symbol which are both (vertically) tracked and horizontally tracked. A symbol s is said to be horizontally tracked or relaxable if the memory system maintains an up-to-date efficient representation of its neighborhood that can be used as slack search region.

Specifically, embodiments of this invention maintain one or more adaptive neighborhoods N_{ε}(s) of a relaxable symbol s which contain its topologically related neighbors and which can be used as slack search region.

A symbol is said to be robustly tracked if its relaxable and if its neighbors in its slack search region are (vertically) tracked, so that its relaxed compositional hypotheses list can be calculated by means of the above formula [RCHL].

In some embodiments, the parameter ε is a non-negative number ε≥0 which indicates the amount of slack introduced in the horizontal search, that is, N_{ε}(s) contains symbols whose “semantic” or primal distance from s is less or equal to ε.

If ε=0 or if ε is very small, then only symbols equivalent to s are included in N_{ε}(s).

In these embodiments the search can be performed with a low value of ε first and then with a larger value only if the initial search is not successful (multi-stage relaxed compositional search).

In other embodiments ε is a context-dependent parameter (hence the name adaptive neighborhood).

Topological relationships are typically represented in the memory graph by means of multiform symbols that group together equivalent or similar symbols. These may be generated by the user or the system and may be bootstrapped from proximity relations in primal spaces.

Overlap measures can be used for aggregate symbols such as descriptive symbols.

The representative symbols of semiotic entities are a good source of efficient representations of topological relationships, thanks also to the consolidation updates of semiotic entities, which group similar and alternative representations of the same underlying entity, collected from the history of the corresponding semiotic entity, into an aggregate symbol.

Upon ingestion of an ingestible symbol, the search for a match to said ingestible symbol and the consequent exploration of the memory graph in its the vicinity results in the creation of a primordial neighborhood for said ingested symbol, which is used as an initialization of its adaptive neighborhood.

For example, this primordial neighborhood can be obtained from a relaxed compositional hypotheses list (RCHL) by discarding the invalid matches and by retaining confirmed candidates which are similar to or in the vicinity of the ingestible symbol.

Adaptive neighborhoods are not immutable and need to be updated from time to time, for example when a nearby symbol is created.

Whenever possible (depending on the amount of available storage resources), adaptive neighborhoods are cached in memory so that they need to be calculated only once.

### 5.4.1 Other Methods for Relaxed Search

In some embodiments it may not be possible to maintain relaxed hypotheses lists, especially if they are very large. An alternative method is as follows. Given a searched symbol x with compositional code [p₀, . . . , p_{N}], explore its neighborhood of by jiggling inside a slack region H_{ε}(pₖ) to yield jiggled constituents [symbol] ∈H_{ε}(pₖ).

For each jiggled code [symbol] =[ [symbol] , . . . , [symbol] ] obtained this way, a vertical search is performed to check if it corresponds to an instantiated symbol. If the jiggled code does correspond to an instantiated symbol, the following distance is calculated:

d(x, [symbol] )=Σd(pₖ, [symbol] )

and the instantiated symbol [symbol] is included in a list of possible neighbors of x. Note that each d(pₖ, [symbol] ) represents a “cost” incurred for jiggling away from the un-jiggled symbol.

NOTE: this distance may be calculated also when using the method based relaxed hypotheses lists described earlier.

When this procedure completes, this list of candidate neighbors is processed, for example, by removing duplicates, and then assigned to be the slack region H_{ε}(x) of the searched symbol.

In some embodiments, the memory system may ask the user for an estimate of the jiggle cost d(pₖ, [symbol] ).

Note that, in general, the diameters of the slack region may not be constant, and it may be convenient or necessary to maintain slack regions with multiple values of the diameter (given by 2ε) in order to perform a satisfactory search. Try first with smallest value possible; then increase diameter value until slack region is non-empty.

Notice that the number of jiggle combinations may grow exponentially with the number of constituents, for example, if the input symbol has 3 constituents and each constituent has 5 elements in its neighborhood, there would be a total of 5*5*5=125 jiggled combinations to test. For this reason, it is important to keep the size of slack regions at a minimum, for example, by selecting covering subsets or minimal subsets that are nonetheless sufficiently representative of the whole slack region.

### 5.5 Inference in the Memory Graph

By representing and exploiting logical and inferential relationships, it is possible to broaden the range of searches which can be performed successfully; for example, a cat named “Garfield” can be returned when searching for an animal named “Garfield” if the inference can be made that all cats are animals.

Generally speaking, inference refers to the process of generating new information from existing information, or new representations of information from existing representations.

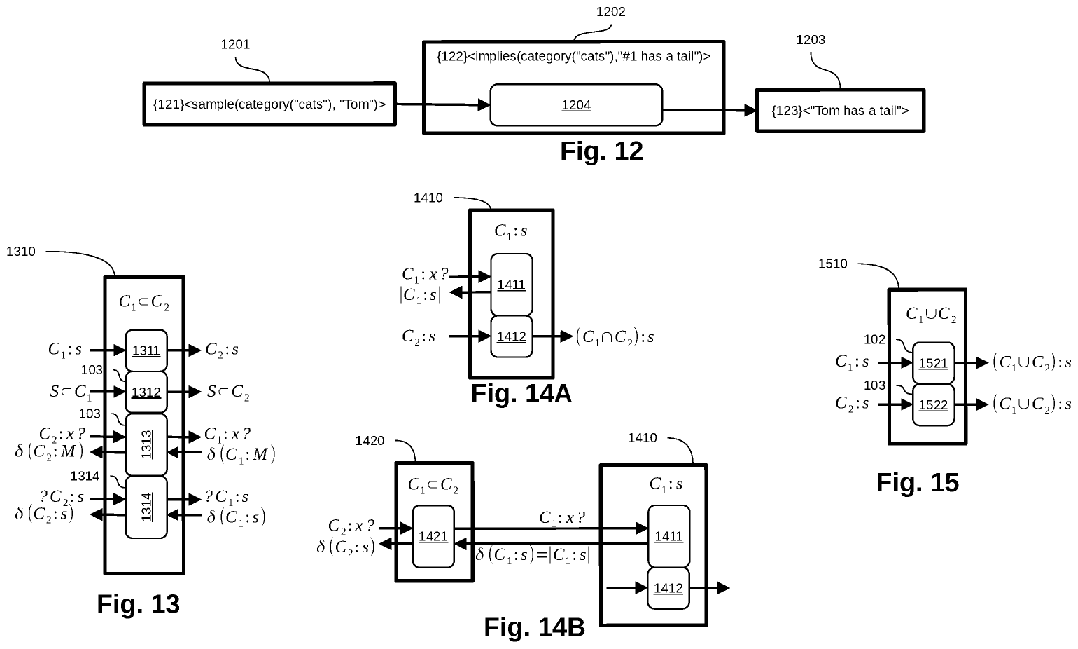

For example (see FIG. 12), from the symbols
{121}“TomTheCat”<sample(category(“cats”), “Tom”)>
   and
{122}“CatsHaveTail”<implies(category(“cats”),“#1 has a tail”)>
   the syllogism inference rule yields:
{123}<“Tom has a tail”>.

Enabling inference and reasoning based on logical and induction principles greatly improves the capabilities and usability of a memory system. Several existing technologies for databases and information management comprise a reasoner or inference engine whose task is to perform inferences.

### 5.5.1 Inference Network

Embodiments of the disclosed invention perform inference by means of an inference graph, also referred to as inference network, which is embedded in the memory graph and which comprises inference nodes, inference links and inference signals transmitted along these links.

As shown by the examples, in FIG. 12-22, an inference node comprises instructions which, upon receiving an inference signal, generate one or more symbols which are normally added to a managed pool of goal symbols to be further processed and possibly transmitted along connected links.

An inference signal typically comprises a symbol which can be an instantiated symbol, a query symbol, an ingested symbol, a searched symbol, an inferred symbol, or a goal symbol which was obtained by rewriting another symbol.

The symbols and the signals generated by an inferential node are obtained based on inferential rules well known to those skilled in the art, such as the syllogism inference rule.

### 5.5.2 Search and Discovery Modes

As shown by the examples in FIG. 12-22, an inference node is typically embedded or nested in another host node representing some symbol. For example, in FIG. 12, 1204 is an inference node embedded in the node 1202; the node 1202 represents the symbol {122} which declares that “cats have a tail”. Inference node 1204, upon receiving an input signal representing a sample 1201 of the “cat” category named “Tom”, draws the conclusion that “Tom has a tail”, represented by symbol {123} and node 1203.

Embodiments of this invention comprise two types of inference nodes: rewriting (or backward-chaining or search) nodes, whose input signals include a goal symbol (e.g. a query symbol or a searched symbol), and which process their inputs by either resolving the goal symbol or by rewriting it into other goal symbols; and forward-chaining or discovery nodes, such as 1204 in the above example, which process input signals by inferring one or more new symbols from the input signals but no to have a specific goal symbol to be resolved.

Forward-chaining nodes are normally used in an exploration or discovery mode, whereby the inferential network pushes forward certain existing or instantiated symbols, for example, salient symbols or symbols highlighted by a user, or symbols being in an attentional focus, so as to discover new information or to organize more efficiently existing information by means of inference.

Rewriting nodes are normally used in a search mode, whereby the inferential network seeks one or more instantiated symbols matching a searched symbol or a query symbol. Rewriting nodes typically transmit signals first in forward direction and then, once the input signal has been resolved, in a backward direction.

More specifically, when an input signal including a search or query request arrives into a rewriting node, and when the node is selected for processing, the node performs the following steps in sequential order: (a) rewrites it into one or more goal symbols; (b) transmits the corresponding signals downstream; (c) enters a waiting state until a response arrives back from the nodes to which the rewritten signals have been transmitted; (d) resolves the input request signal; (e) transmit a signal back to the upstream node or nodes, thus enabling the resolution of any upstream goal symbols. A rewriting node may also be in the capacity to resolve directly the input search or query request without the need to delegate a subnetwork, hence skipping the steps (a), (b) and (c) above.

Typical embodiments include a managed pool of goal symbols to decide in which order the goal symbols should be processed according to the steps above.

A goal symbol becomes an inferred symbol once it has been resolved.

### 5.5.3 Derivation-Aggregate Symbols

In some embodiments, once an input signal has been resolved, a derivation-aggregate symbol is created which represents the supporting evidence and the chain of inference steps executed in order to resolve the input request. For example, in the example of FIG. 12, in addition to symbol {123} (node 1203), these embodiments create a derivation-aggregate symbol which includes {121}, {122} and {123} and is denoted δ(123⇐121,122) or δ(121,122→123).

Some embodiments also redefine the conclusion {123} by plucking it from the derivation-aggregate δ so as to make explicit the support on which it is based:

pluck(123, from δ(123⇐121,123))

An alternative notation for the above is: π(123⇐δ(123⇐121,122)).

Another example is shown in FIG. 14B, where input signals containing a goal symbol are resolved by issuing derivation-aggregates (see detailed discussion later).

Embodiments of this invention verify that multiple occurrences of a symbol within a derivation satisfy semiotic coherency (and also logical coherency). The issuance of a derivation-aggregate symbol acts a confirmation that these constraints are satisfied.

### 5.5.4 Inferential Linking (Mating)

A pair of instantiated symbols is said to be (inferentially) linkable if it contains a pair of nested inference nodes which can exchange inference signals. Embodiments of this invention construct an inference network by searching for pairs of linkable instantiated symbols. For example, FIG. 14B shows a pair of linkable nodes (1410, 1420) containing inference sub-nodes 1411 and 1421 which can exchange inference signals in search (backward-chaining) mode.

Two linkable nodes may be connected by means of an inference link. When this occurs, the nodes are said to be mated. Embodiments of this invention searches for linkable pairs of nodes by searching for pairs of nodes sharing at least one constituent.

More specifically, in some typical embodiments, inference links are obtained by scanning the constituent compositions of an inferentially linkable symbol x, that is, the compositions of the constituents of said inferentially linkable symbol x.

This yields the mating candidate list (MCL):

$$M ( x ) = {⋃}_{p ∈ {A}^{( 1 )} ( x )} {C}^{( 1 )} ( p ) \qquad [ MCLp ]$$

where A⁽¹⁾(x) is the set of direct constituents of x and C⁽¹⁾(p) is the set of direct compositions of p. More generally, when a set of ancestors P of x is used:

$$M ( P ) = {⋃}_{a ∈ P} C ( a ) \qquad [ MCL ]$$

The composition list C(a) of an ancestor a must have the same degree as the ancestor.

Nodes in this list containing a nested inferential node which is compatible with the inferentially linkable symbol x may yield an inference link. The elements of the above set M(x) are referred to as a mating candidates or potential mates (see FIG. 12-22, sheets 8-11, for examples).

It should be noted that a pair of mates obtained in this way indeed share a common constituent. In fact, by assuming for simplicity that A consists of a set of parents, if y∈M(x) then there exists p∈A⁽¹⁾(x) such that y∈C⁽¹⁾(p), from which it follows that p∈A⁽¹⁾(y): thus p is a constituent (parent) of both x and y.

This can be generalized to mating pairs having multiple constituents in common.

In some embodiments, the above search for mates is relaxed by allowing constituents to jiggle. For examples, constituents may be allowed to jiggle within adaptive neighborhoods N_{ε}(p), to yield the following relaxed mating candidate set:

$${M}_{ε} ( x ) = {⋃}_{p ∈ {A}^{( 1 )} ( x )} {⋃}_{\tilde{p} ∈ {N}_{ε} ( p )} C ( \tilde{p} )$$

or, more generally, when an arbitrary set of ancestors P is used (as probe):

$${M}_{ε} ( P ) = {⋃}_{a ∈ P} {⋃}_{\tilde{a} ∈ {N}_{ε} ( a )} C ( \tilde{a} ) . \qquad [ RMHL ]$$

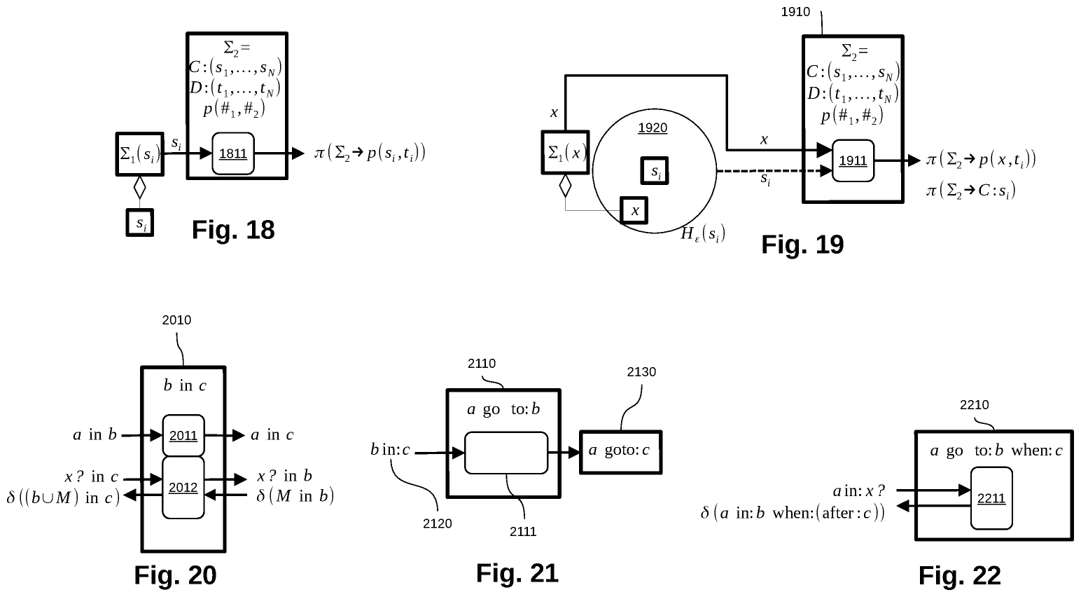

An example of a link obtained in this way is shown in FIG. 19. It should be noted that a pair of mates (x, y) obtained in this way, that is, such that y∈M_{ε}(x) have a pair of constituents p∈A⁽¹⁾(X) and [symbol] ∈A⁽¹⁾(y), each belonging to its respective mate, which are within a distance of at most ε of each other: d(p, [symbol] )≤ε.

In some embodiments, once a symbol is created, a set of mating candidates is calculated and the new symbol is mated with all existing compatible inferential nodes. This step can be considered as part of the grooming phase and may be completed while the memory system is in a waiting (“sleeping”) stage.

When searching for inferential links of a category descriptive symbol node, the slack search region (e.g., adaptive neighborhood) typically contains its sub-categories.

When searching for inferential links of a descriptive symbol node, the slack search region (e.g., adaptive neighborhood) typically contains its supersets.

### 5.6 Integration of Compositional Search and Inferential Search

Some embodiments of this invention resort to an inferential search if compositional search (such as embodied by formulas [CHL] and [RCHL]) fail to find a valid match to the searched symbol. As described previously, inferential search is based on inferential links established by searching for instantiated symbols sharing one or more constituents with the searched symbol.

The reader should notice of the structural similarity between formulas [CHL] and [MHL] which define H(P) and M(P) respectively.

As before, the set of ancestors P is referred to as probe in this context. For compositional search, all the elements of the probe must be present, whereas for establishing an inferential link one element of the probe is sufficient, according to these two formulas.

For compositional search to succeed, a set of ancestors must be determined so that the hypotheses list H(P) can be efficiently scanned to find a valid match. For this to be the case, P must contain enough components or features to ensure that H(P) is not too large. If however P is too large, then set H(P) may be empty. Therefore, embodiments of this invention may carry out a compositional search with multiple probes of different sizes in order to find an optimal tradeoff between these two conflicting requirements.

Therefore, it is often the case that the result of the compositional search is a partial match; for example, if the searched symbol is a descriptive symbol, a partial match is obtained by removing features from the probe P until all the remaining features can be found in an instantiated aggregate symbol; it's a partial match because some of the features of the searched symbol had to be given up in order to find a match.

As another example, if the search symbol is a natural language expression, a partial match is obtained when P contains a subset of its actors which are found in an instantiated propositional symbol.

As an example of a situation where a search can yield only a partial match, consider a memory system which does not contain any sample of the category “animal” but contains the if-then rule: “cats are animals”. A search for samples of “animal”, such as “? is an animal”, would then certainly fail in returning a complete match but would return “cats are animals” as a partial match if “animal” were used as a probe of “? is an animal”. An inferential search could then come to the rescue if the memory system contains, for example, the sample “Tom is a cat”.

According to the teachings of this invention, partial compositional matches are delivered to the inference sub-system so that the missing components necessary to complete the match can be inferentially generated.

Moreover, large partial matches (e.g. containing multiple features) are given higher priority so as to minimize the number of components that must be found by the inference engine. For example, when searching for a descriptive symbol containing several features, if the memory system stores one symbol containing a large subset of these features, if would certainly be beneficial to initiate an inferential search from this large subset of features, rather than trying to assemble these features from scattered places within the memory system or from the network.

It should also be noted that features which are also aggregated within a descriptive symbol do not typically need to undergo a semiotic verification.

In order to take advantage of partial matches, the mating candidate lists given by [MHL] are generalized to mating candidate lists where mating candidates share multiple constituents.

To do so, embodiments of this invention generate non-empty compositional hypotheses lists H(P) for a plurality of maximally large probe P and include the partial matches H(P) thus obtained in a mating candidate list:

$$M ( α ) = {⋃}_{P ∈ α} H ( P ) \qquad [ MHL - 2 ]$$

wherein α is a set of probes and H(P) is the set of partial matches to the probe P

Notice that the original formula [MHL] is a special case of [MHL-2] obtained where α contains probes consisting of a single parent (or ancestor).

Embodiments of this invention may apply [MHL-2] in stages. Initially, a set α of probes containing large probes is used, which yields a small number of mating candidates. Then, if no satisfactory match is found, the size of the probes is reduced, resulting in a larger set of mating candidates. Finally, the broadest mating candidate list given by [MHL] may be used.

At any of these stages, constituent (or ancestor) relaxation may be used, as defined by [RCHL], to yield:

$$M ( α ) = {⋃}_{P ∈ α} Γ ( P ) \qquad [ MHL - 3 ]$$

Mating must pass a semiotic coherence test on symbol occurrences from distinct mates (mating can couple symbols from distant-away sessions!)

### 5.7 Search Pool Management

An inferential network typically contains a plurality of goal symbols for which the memory system searches a match. These symbols, which are either input into the memory system by a user or generated by rewriting backward-chaining inference nodes, are held in a search pool.

To advance the search, the memory system picks one of the goal symbols from the search pool and invokes the ingestion procedure on it. If this invocation terminates, which typically happens only for some of the goal symbols, a symbol identifier is returned. The returned identifier may be a pre-existing identifier representing an instantiated symbol stored in the memory system.

The invocation may alternatively terminate by returning a derivation of the goal symbol upon which the ingestion procedure was called. In this case, a transient provisional identifier is assigned to the derived goal symbol and only if this derived symbol ends up being critical for resolving the current main search is this provisional identifier converted to a permanent symbol identifier.

In some circumstances, the provisional identifier of a derived goal symbol may be converted to a permanent one even though it is not critical for resolving the current search; this would be the case, for example, if the derived symbol is recognized to be critical to achieve a more compact representation of existing information; or if it represents a new valuable unexpected piece of information (As it often happens that we find a valuable object lost in our home while we look for something else, the memory system may similarly find valuable information not directly related to the main search).

One issue that must be dealt with is the potentially very large number of goal symbols that may be created, due to the inherent exponential nature of the search process. Embodiments of this invention manage this issue by a combination of methods.

Firstly, the search pool is prioritized by maintaining an ordered list of the most promising goal symbols. For example, annotation aggregate symbols (descriptive symbols) for a subject symbol are given higher priority than the un-annotated subject symbols because one of the annotations incorporated in an aggregate symbol may provide critical information to resolve the input signal without the need to spawn additional searches.

Secondly, the semiotic layer of the memory system is brought to bear into the ranking of the goal symbols. One way of doing this is to give higher priority to semiotic entity representatives. Indeed, a symbol which represents a semiotic entity is likely to comprise essential information about the underlying entity which has been consolidated into it in as a result of the historical entity evolution. As mentioned earlier, this consolidating information may enable the corresponding node to resolve the input query or search directly, without the need to spawn additional goal symbols.

Thirdly, the disclosed search method comprises provisions to terminate (give up) the search if the explored symbol space has reached a substantial size. To ensure that a best effort has been made to direct the search fairly in all possible “directions”, a search cost value is associated to a goal symbol which sums up both the topological adjustments applied to its constituents (with respect to the original input searched symbol) and the number of inferential rewritings applied to obtain said goal symbol.

To ensure fairness, and also to increase the likelihood of finding a match, goal symbols with lower cost are given higher priority in the search pool so as to direct the search process uniformly in all directions. If the goal symbol pool reaches an unmanageable size without having found any match to the current main search, the search process simply terminates with a fail status. By having consistently prioritized the hypotheses “closer” to the original searched symbol, the memory system provides a certain “fairness” guarantee that a best effort has been made to find a match.

In some implementations, fairness is achieved by allocating an energy amount to search paths and by consuming this energy by jiggling hops within slack regions and when generating newgoal symbols.

### 5.8 Examples of Inferential Nodes

In the examples described below, signals in search mode (also referred to as requests or request signals) typically include at least one “?” (question mark); signals without a “?” are normally in discover mode.

FIGS. 12-22 show only a small excerpt of the inferential nodes contained in the disclosed invention, those skilled in the art will appreciate how many more nodes of this kind can be added based on computational logic and on the common semantics of natural language expressions.

### 5.8.1 Inference Nodes for Propositional Symbols

FIG. 12 depicts a nodes 1202 representing the information element “cats have a tail” by means of the multiform symbol: <implies(category(“cats”),“#1 has a tail”)>, which is a propositional implication symbol or, equivalently, a category inclusion (subset) symbol C₁⊂C₂ wherein, in the example shown in FIG. 12, C₁ is the symbol <category(“cats”)> and C₂ is the predicate-defined category <“#1 has a tail”>.

FIG. 12 further depicts node 1201 providing a representation of the information element: “Tom the cat” by means of the category sample symbol <sample(category(“cats”), “Tom”)>.

The node 1202 “cats have a tail” contains a forward-chaining inferential node 1204, which is linked to the input node 1201 by virtue of the common occurrence of the symbol <category(“cats”)>.

When the input 1201 “fires” by sending an inference signal along the inferential link, the forward-chaining inference node 1204 generates the node 1203 representing the symbol <“Tom has a tail”>.

Typical embodiments perform a semiotic coherency check before executing the inference, which consists in verifying that the meaning of the shared symbol (<category(“cats”)> in the above example) is the same in the two linked nodes (unification).

FIG. 13 depicts a node 1310, representing a category subset symbol C₁⊂C₂, of which {122} of FIG. 12 is a concrete example, hosting two forward-chaining inference nodes 1311,1312, and two backward-chaining inference nodes 1313,1314.

Sub-node 1311 (of which 1204 of FIG. 12 is a concrete example) embodies the syllogism inference rule associated with the host symbol C₁⊂C₂ which, on input signal C₁:s, that is, “s is a member of category C₁”, deduces C₂:s, that is, “s is a member of category C₂”.

Similarly, sub-node 1312 embodies the deduction that S₁⊂C₂ follows from S₁⊂C₁ enabled by the host symbol C₁⊂C₂.

Sub-node 1313, which is a backward-chaining node, processes queries of the type C₂:x?, “What is a member of C₂?”, which seek members (samples) of the category C₂.

Sub-node 1313 rewrites the query C₂:x? into C₁:x? by virtue of the host symbol C₁⊂C₂ and inserts the rewritten goal symbol C₁:x? into the search pool; it then enters a waiting state and wakes up when it receives a response δ(C₁:M) from its down-stream network.

The response δ(C₁:M) represents a derivation containing evidence supporting the sample category symbol C₁:M, where M denotes a list of sample items. Sub-node 1313 then upgrades the derivation δ(C₁:M) to a derivation δ(C₂:M) by appending to it the host symbol C₁⊂C₂. The derivation δ(C₂:M) provides the evidence that the sample items M are logically deduced to be members of C₂.

The original input query C₂: x? is then declared to be resolved, and the response signal δ(C₂:M) is delivered upstream, hence enabling the resolution of any other goal symbol upstream.

Sub-node 1314 processes a searched symbol (e.g., an ingestible symbol) C₂:s representing a category sample. The “?” in front of the symbol indicates that the symbol C₂:s is being searched. The signal ? C₂:s represents questions such as “Is s a member of C₂?” or an order such as “Find the object s belonging to category C₂”.

Similarly to sub-node 1313, this input symbol is logically rewritten based on the meaning of the host symbol C₁⊂C₂ and, once a response is received from the downstream network, it is converted and then delivered upstream.

The derivation symbol δ(C₂:s) contains the evidence found which supports the claim that s is a member of the category C₂ and includes the host symbol C₁⊂C₂ and δ(C₁:s), the derivation received from the downstream network.

FIG. 14A depicts a singleton sample node C ₁:s, 1410, hosting-the terminal back-chaining inferential node 1411, which resolves an input request symbol C₁: x? directly, without the need to spawn an additional search. This response is simply the symbol identifier of the host node C₁:s, which is denoted here |C₁:s| (may also use {C₁:s}).

The node 1410 also hosts and a forward-chaining node 1412 that deduces (C₁∩C₂):s from the input signal C₂:s.

In FIG. 14B, the terminal back-chaining node 1411 is shown as being connected (inferentially linked) to inference node 1421 hosted by symbol 1420 by virtue of the shared symbol C₁.

The inference network comprising the nodes 1410 and 1420 illustrate a depth-1 inferential path which is traversed when a query C₂:x? reaches the node C₁⊂C₂ (by virtue of the shared symbol C₂); is rewritten to C₁:x? (by the inference node 1421) and then reaches node 1410 (by virtue of the shared symbol C₁) where it is resolved by 1411, which emits backwards the resolving derivation δ(C₁:s)=|C₁:s|; which is then combined with C₁⊂C₂ to yield the derivation δ(C₂:s)=|C₁:s|+C₁∩C₂, which resolves the original query.

As an example, a network of this type would return a derivation for <“Tom the cat”> (node 1410, where C₁ is the <“cat”> category and s is “Tom”), when searching for an <“animal”> (the category C₂), by means of the query <“? is an animal”> (the indefinite symbol C₂:x?) from the fact that <“cats are animals”> (node 1420, C₁⊂C₂).

FIG. 15 depicts a node 1510 for the symbol C₁∪C₂, representing the union of two categories, hosting two inferential sub-node 1521,1522 which deduce (C₁∪C₂):s from either C₁:2 or C₂:s.

### 5.8.2 Conjunctive and Disjunctive Symbols

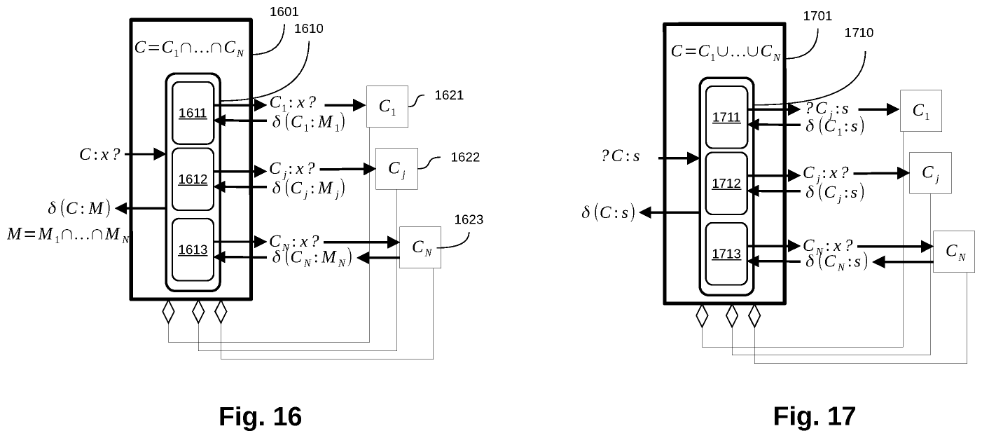

FIG. 16 depicts an inference node 1610 hosted by symbol-node 1601, C=C₁∩ . . . ∩C_{N},

which processes a query C:x? seeking samples of a conjunction of categories or equivalently, symbols matching a conjunction of predicates.

It should be noted that the sub-node 1610 comprises N nested inferential nodes 1611,1612,1613, one for each constituent Cⱼ of the host symbol 1601. In the example shown, there are 3 constituents 1621,1622 and 1623 connected to the host node 1601 via diamond-headed arrows. Each of these nested nodes 1611,1612,1613, is enabled to forward a rewritten signal Cⱼ:x? to the corresponding constituent symbol Cⱼ, that is, 1621,1622,1623 respectively. Every nested node 1631,1632,1633 waits until Cⱼ resolves the corresponding re-written query Cⱼ:x? by returning the derivation symbol δ(Cⱼ:Mⱼ), which provides evidence that the sample items Mⱼ are members or Cⱼ. Once all the nested nodes 1611,1612,1613 are resolved, the inference node 1610 calculates the intersection M=M₁∩ . . . ∩M_{N} and combines the derivations from δ(C₁:M₁) to δ(C_{N}:M_{N}) into the derivation δ(C:M), which provides the evidence that the sample items M belong to each one of the categories Cⱼ, that is, to C=C₁∩ . . . ∩C_{N}.

Again, a semiotic-coherency check is performed by more advanced embodiments to confirm that multiple occurrences of a symbol all have the same meaning.

The inference node 1711 of FIG. 17 is structurally similar to the one in FIG. 16, except that the host symbol is a union of categories C=C₁∪ . . . ∪C_{N}, and the input signal specifies a searched symbol ? C:s. The signal flow is also quite similar, except that here the inferential node is typically considered to be resolved even if only one of the constituent nested nodes returns.

### Notes

(1) The same way 1610 delegates 1621, etc. it could also delegate Cⱼ∩Cₖ, etc.; it could also search for samples of {i(C)}, that is of the instantiated category C directly (if it exists in memory).

(2) C could inferentially link to the intersection of any subset of categories.

(3) As mentioned earlier, enhanced embodiments search for samples of conjuncted categories rather than combining independent samples of each category.

(4) They also take advantage of annotated categories, where each instantiated super-

category given by any instantiated subset of conjunctive terms yields an annotation of the annotation-aggregate category symbol. An annotated category participates in very powerful inference links wherein the category conjunction can delegate groomed groupings of conjunction terms, reducing arborescence and reducing the need (or simplifying) semiotic coherency checks.

(5) Correspondingly, for disjunctions of categories, an annotated category is obtained by

grouping all sub-categories obtained from each subset of instantiated disjunctive terms).

### 5.8.3 Table Symbols

FIG. 18 illustrates a possible implementation of a 2-column table symbol Σ₂ comprising two category samples C:(s1, . . . , sN) and D:(t1, . . . , tN), referred to as columns in this context, and a two-slot predicate p(#1,#2) describing the relationship between the items in the two columns. For example, the first column could be a list of internet accounts; the second columns could be a list of passwords; and the predicate could be the relationship <“#2 is the password of #1”>.

Inference, in the discovery mode, can be used to extract information from the table. Let Σ₁(sᵢ) be any symbol which contains an occurrence of a sample item of the first column of the table. This symbol is linked to the inferential node 1811 hosted by the table symbol by virtue of the common constituent sᵢ.

Upon feeding the discovery signal sᵢ into sub-node 1811, the sub-node 1811 reacts by generating a symbol p(sᵢ, tᵢ) which represents the relationship embodied by the predicate between the sample item sᵢ and its corresponding sample item tᵢ in the second column.

In some circumstances it may appropriate to simply return p(sᵢ, tᵢ). In other circumstances, embodiments of this invention make use of the <:pluck> builder to generate a more accurate symbol which further specifies the origin of the predicate (as shown in FIG. 18): π(Σ₂→p(sᵢ, tᵢ)).

This pluck form has the additional advantage of admitting a very compact compositional code consisting of 3 identifiers: one for the pluck builder, one for the table, and a third one to identify the row of the table. It should also be noted that the predication and its plucked form are not in generally semantically equivalent (even though they are similar). Indeed, the plucked form specifies a context from which the predication was obtained, which provides additional constraints on the possible interpretation of the predication symbol.

Those skilled in the art can appreciate how other inferential nodes can be similarly constructed for a table symbol, for example, by allowing input signals comprising multiple sample items, or input signals given by search requests.

### 5.8.4 Relaxed Inference Links

FIG. 19 depicts the same table symbol Σ₂ of FIG. 18 as being linked to an input node Σ₁(x) referring to an approximation x of a sample item sᵢ of the table.

This relaxed inferential link, denoted by the dashed arrow from 1920 to 1911, can be obtained via the slack search region 1920 by constructing a mating candidate set where the constituents are allowed to jiggle within said slack search region. The nearby symbols x and sᵢ could be, for example, different representations of the same underlying entity, for example, of an internet account, which could be specified a first time by an email address and a second time by an account number (or could simply be “John” and “JohnSmith” from FIG. 8).

### 5.8.5 Inference Nodes for Natural Language Semantics

FIGS. 20, 21, 22 illustrate inferential nodes (both forward and backward chaining) for linguistic symbols and in particular for the “is in” predicate. The most complex example, FIG. 22, illustrates relaxed inference with linguistic expressions with four grammatical roles (subject, verb, plus “when” and “where” prepositional phrases).

FIG. 20 depicts a node 2010, for the expression <“$b is in $c”> where $b and $c are two actors, for example, <“Paris is in France”>. Sub-node 2011 accepts an input of the type <“$a is in $b”> and simply deduces <“$a is in $c”>. The second sub-node, 2012 accepts a query seeking for symbols “contained” in $c and rewrites the query into a query seeking symbols “contained” in $b. It then adds itself to anything else found to be contained in $b and returns the result, which is then back-propagated.

FIG. 21 illustrates some of the semantics of the verb (predicator) “to go”. The symbol 2110 of FIG. 21 represents an object $a that goes to a location $b. The sub-node 2111 accepts a containment relation b in:c and draws the conclusion that a goto:c.

Finally, FIG. 22 illustrates natural language expressions obtained by adding an adjunct <“when: $c”> to the symbol 2110 of FIG. 21 which represents the time at which the “go” event occurs. The sub-node 2211 links to the query a in:x?, representing a request of locations which contain $a, corresponding to the question: “where is a?”. The output of the channel is the symbol a in:b when:(after:c) which represents the time-constrained containment relationship <“$a is in $b after time $c”>, which follows from $a having moved to $b at time $c.

NOTE: The search of valid inputs for the sub-node 2211 may rely on an ad-hoc upward link between the builder $in and the predicator $go. The query has both $a and $in as constituents, hence the intersection method applied on the two corresponding upward composition lists would tap into the node 2210.

### Adjuncts

Removing an adjunct component from a linguistic expression is a form of (deductive) inference. For example,
{401}<“I saw Star Wars”>,
{402}<qualify(1,“last Sunday”)>.
   The symbol {401} can be plucked-deduced from {402}.

### Induction Nodes/Symbols

The builder <:induced> groups repeated similar symbols (e.g. events) and infers a conclusion inductively. For example:
{0}<“Amy went to church on Sunday May 6”>
{1}<“Amy went to church on Sunday May 13”>
{2}<“Amy went to church on Sunday May 20”>
{3}<“Amy went to church on Sunday May 27”>
   yield
{4}<induced(“Amy goes to Church every Sunday”,0,1,2,3)>.

### Unqualified Actors

The role of an actor need not to be specified in situations where the context defines it. For example, the role of {201} in
{202}<{201}actor(“Sally”),“met Bob yesterday”>
   is not specified. Embodiments of the invention invoke the builder <: infer_role_of>
{203}<infer_role_of(201 “from” 202)>
   to pluck-infer the role of {201} in {202}.

### 5.9 The Power of Aggregate Symbols

According to the teachings of this invention, aggregate symbols such as descriptive symbols, annotated categories, etc., such as those that result from semiotic entity consolidation, play an important role in speeding up and simplifying the search for matches to conjunctions of predicates and similar constructs (e.g. intersection of categories and descriptive symbols containing multiple features) by reducing the need for expensive inferential calculations.

Consider for example the following query
<? “lives in Boston”>&<? “likes movies”>
   in the context of the graph shown in FIG. 8. After session @c, the graph contains symbols 812 and 813 which can be combined to provide a solution to the query by means of an inferential node such as 1610 of FIG. 16. However, for more complex queries, this strategy may require multiple inferential iterations and the resulting exponentially large number of goal nodes spawned may bring the search to a halt. Additionally, it is necessary to verify that multiple occurrences of every symbol (e.g. the symbol {1} of FIG. 8) have the same referent when “loose” propositional symbols such as 812 and 813 are combined (semiotic verification), especially if these symbols were created at very different times or by distinct sources.

Instead, after session @f, the two “features” 812 and 813 of {1} have been consolidated into the aggregate symbol 807. The above query is then resolved directly by means of the intersection method described earlier, without the need for neither inference iterations or semiotic verification: entity consolidation and the resulting aggregation of propositional symbols greatly simplify the search for complex symbols by means of pre-unification.

Pre-unification (such as embodied by 807 of FIG. 8) should be contrasted with post-unification as embodied by inferential rules (nodes) such as 1610 of FIG. 16. Whereas with pre-unification the work of unifying (semiotic coherence checks) and bringing together co-occurring features (or categories or predicates) is done in advance (and recorded in an aggregate symbol such as 807), with post-unification the task of gathering features (or categories or predicates) is done after the issuance of the query, when inferential nodes such as 1610 get activated.

Similarly, annotated categories including descriptors for super-categories of the featured category make it possible to hit a candidate solution for queries containing a conjunction of categories C1, C1, . . . , CN (provided C1, C1, . . . , CN are in an annotated category) thus avoiding the need for constituent/subsumption relaxation and inferential search.

Indeed, if an annotated category contains all of the Cj as super-categories, it will be hit by the intersection algorithm (without constituent/subsumption relaxation) provided the parent upward links of second degree are used. If so, the featured category is a relaxed matched to the conjunction of the Cj.

And even if only a subset of C1, C1, . . . , CN are contained in an annotated category, the disclosed invention can take advantage of the symbol aggregation by reducing the amount of inferential iterations and constituent relaxation by means of partial pre-unification.

In conclusion, since co-occurrence of features (and categories and terms in a conjunction of predicates) is likely to repeat itself, embodiments of this invention register these co-occurrences so that they can be hit directly by means of compositional search.

### 5.10 Search and Ingestion of Compositional Expressions

A compositional expressions <X(s1, . . . , sN)> (also denoted: X(s₁, . . . , s_{N})) comprises a symbol builder $X (also denoted X) and one or more multiform symbol arguments $sK (also denoted sₖ) which may be in any of several possible forms (exploitable form, compositional code, symbol identifier). The standard encoder described earlier, which transforms a compositional expression into a code-bearing symbol, is used by embodiments if this invention to ingest compositional expressions.

More specifically, typical embodiments of this invention ingest a compositional expression as follows. First, the builder $X and the arguments $sK are ingested, to yield the identifiers pK=i(sK); then the compositional code [p0, p1, . . . , pN]=[i(X), i(s1), . . . , i(sN)] is formed by concatenating these identifiers (thus transforming the compositional expression into a composite code-bearing symbol); thirdly, the resulting composite (code-bearing) symbol is processed by the search procedures for composite symbols described earlier; finally, the closing phase follows and finalizes the ingestion of the compositional expression.

It should be noted that this ingestion procedure is recursive in that it breaks down the task of ingesting a compositional expression into the tasks of ingesting its constituents, followed by the ingestion the resulting compositional code.

The following sections will describe methods to carry out the search phase for primal symbols and primitive symbols, hence enabling the ingestion of any compositional expressions containing symbols of these types.

### 5.11 Approximate Matching and Ingestion of Primal Symbols

Primal symbols are the most basic type of ingestable symbols. A primal symbol represents a data point in a primal space, such as a numerical value, a character string, or any data type appropriate for the specific application at hand (a date, a geographic location, the result of a physical measurement, etc.).

Embodiments of the disclosed invention may utilize specialized data structures and databases to store primal data so that specialized search and processing algorithms can be used. For example, character strings can be stored in a data structure specifically designed for character strings, geographic data may be stored in a GIS database, etc.

To identify symbols stored in these specialized data structures, each of these data structures may be wrapped by a memory slice interface, which allows symbols of same type to be stored together in a dedicated data structure. Essentially, these slice interfaces are implemented by adopting symbol identifiers that identify both a memory slice (which may contain a specialized data structures) and a record (or entry) of the memory slice.

For example, a pair of integers (slice_id, slice_index) are sometimes used as a symbol identifier, wherein the first integer, slice_id, identifies a memory slice and the second integer, slice_index, identifies a record contained in the slice.

It is often convenient to fill these records consecutively so that the slice_index specifies the order in which symbols are created. When a primal symbol is ingested, the appropriate slice is determined based on its type (string or number, etc.) and the input primal symbol is ingested into the appropriate slice.

In some embodiments, primal symbols are searched by means of one the KNN algorithms known to those skilled in the art, which finds and returns the K nearest-neighbors of the input symbol.

These sets of nearest-neighbors can provided the basis to construct, initialize and update dynamic neighborhoods and horizontal search sets (slack search regions). For example, if N_{K}(p) is the set of K nearest-neighbors of $p and ε>0 is the maximum distance from p to an element of N_{K}(p), then we can define H_{ε}(p)=N_{K}(p) to be a primordial neighborhood which initializes the slack search region of radius ε for the point $p. Slack search regions with different values of ε are obtained by varying the parameter K.

Some embodiments compress a slack search region H_{ε}(p) by removing points from it until any two points have a distance greater than δ where δ is a fraction of ε, for example, δ=ε/4.

It is sometimes useful or necessary to represent sets of primal symbols living in the same primal space as a group or aggregate symbol; consider for example the set of timestamps of a burst of photographs taken in rapid succession. The builder <:cluster> is used by embodiments of this invention for this purpose. For example:
<cluster(temperature(“37.1”),temperature(“37.2”),temperature(“37.0”))>;
<cluster(string(“beat”),string(“meat”),string(“feat”))>.

### 5.12 Approximate Matching of Non-Primal Primitive Symbols

Recall that primitive multiform symbols are those who do not have a code form. Exogenous symbols and certain objects generated by object-oriented implementations of applications are often of this type. A primitive symbol who is also primal can be ingested and processed according the method described in the previous section. A primitive non-primal symbol, on the other hand, unless it is processed, is viewed by the memory system as a “black-box” and the only way to compare it to other symbols is by means of its low-level representation.

Therefore, embodiments of the disclosed invention may ingest a fresh primitive non-primal symbol either by saving it without performing any search, or they may search for a match by means of its low-level representation which could be, for instance, its bit-sequence. A hash-based dictionary (key-value map) could be used to associate this type of symbols to their identifiers. As for their topological relationships with other symbols, these can be introduced, for example, with the assistance of a user or external agent, either at the time of ingestion or at a later time.

To better integrate a primitive symbol into the memory system, embodiments of this invention encode it by transform it into a compositional expression or a code-bearing symbol whose constituents come from the “vocabulary” of the memory system. For example, previous sections have described methods to transform primitive character strings representing natural language expressions into compositional expressions. Other ad-hoc encoders may be provided by the external application utilizing the memory system.

An encoded primitive symbol is typically assigned a distinct symbol identifier and is therefore considered a distinct symbol from the original primitive symbol.

### 5.13 The Closing Phase

The exploration of the memory graph in the vicinity of the input fresh symbol yields zero, one or more instantiated symbols (graph nodes) matching said input. The main goal of the post-search closing phase is to make a decision, based on the matches found during the search phase, as to whether a new record and new symbol identifier should be created to save the input symbol.

If during the search phase a single good match is found, then its symbol identifier is immediately returned and no new record is created. If, on the contrary, it is determined that no good match exists, the input symbol is saved and its newly created identifier is returned.

In some embodiments, multiple match candidates symbols found during the search phase are be presented to the user or agent (which could be a possibly external or remote application), who may then provide feedback to the memory system by evaluating the matches or by requesting the memory system to extend the search.

The semiotic subsystem may also be brought to bear, for example, by presenting to the agent the history of past usages (semiotic-points and semiotic-entities) of the found matches, so that the agent may select or suggest a past symbol usage (semiotic-point) that best corresponds to the current intended meaning.

### 5.14 Memory Grooming

Memory grooming includes several tasks that are useful to prepare the memory system to forthcoming ingestions. Some of these tasks (described below) are part of an overall ongoing memory consolidation effort which is often initiated during search or ingestion of an input symbol but is mostly carried out offline, between interactive sessions, while the system is in a waiting state.

### Grooming Tasks

percolate/settle the last ingested symbol by linking (and prioritizing, organizing, pruning) its inference nodes, creating its primordial adaptive neighborhoods, and updating touched adaptive neighborhoods of other nodes;
develop the inferential network by further linking and optimizing inferential paths;
compress fluffy neighborhoods (e.g. those created after set-unions and extensive relaxed searches which may contain redundant points);
save the results of hard calculations in the memory graph or in caches to reduce duplication of computational work;
ensure that the memory contains symbols which have already been pairwise compared and mated, which greatly simplifies ingestion of a single new fresh symbol; a new symbols requires an O(N) computation to be compared to every other memorized symbol (can be done offline while the memory system is in a sleep state);
perform ahead computations such as creating and linking inferential nodes.

### 5.15 Overall Strategy to Search Conjunctions

How is a conjunctive symbol such as (C₁∩C₂:s) ingested and searched? Process it as a

“goal”.

1) First, the category C₁∩C₂ is ingested (which eventually yields its identifier {C₁∩C₂}. This entails the calculation of its adaptive neighborhood which may contain aggregate symbols including both C1 and C2.

2) $s is searched as a member (sample) of the category with the identifier {C₁∩C₂} which provides a coherent context in which the two categories have been pre-unified. Moreover, by carrying a relaxed searched, it is also searched in categories found in the adaptive neighborhood of {C₁∩C₂}, which may contain larger conjunctions.

3) If the above step 2) does not come up with match, an attempt is made to build the goal by conjoining separate symbols coming from different contexts (post-unification). Separate searches are carried out for (C₁:s) and (C₂:s) (as done by the inference node 1610).

4) (a) If both the above separate searches for for (C₁:s) and (C₂:s) succeed, then two statements in distinct contexts have been found to build the goal; (b) if not, the goal is composed from scratch; (c) if only one succeeds, the fragment found is completed with a freshly built term built from scratch and linked to the new composition.

### 5.16 Protected Derivations; Relativistic Logic; Defeasibility

Embodiments of this invention regard all symbols as being possibly ambiguous unless they are declared to be invariant. Therefore, a symbol is vested with a meaning only when (and each time) it occurs in a particular context. Similarly, the truth-value of a propositional symbol, such as the statement “It rains”, is regarded to be dependent on the context in which it occurs.

Inferential symbols such as, “Cats have a tail”, (FIG. 12) also have a context-dependent meaning and truth-value. For example, “All cats have a tail” might have to be treated as being false in a context containing a cat who has lost its tail in an accident.

In situations where a statement such as “Garfield the cat has no tail” were to be included in the same context as “Cats have a tail”, embodiments of this invention provide tools to cure the contradiction in one of possible ways; for example
a) mark the context as incoherent
b) provide a list of truth-value assignments which cure the contradiction; for example “Cats have a tail” is false; Garfield is not cat; etc.
c) Join the conflicting symbols into a conflict-reconciler, then pluck from it, to obtain, for example, weak inference rule which apply only for “typical” category members. For example, “Garfield is a cat”, “Garfield has no tail” and “Cats have a tail” could all be joined in a conflict reconciler and the rule “Garfield has no tail” could be plucked from it to yield a weak rule which actually means “Typical cats have a tail”. This plucked rule would then be coherent with the other two statements. Another solution would be to pluck “Garfield is a cat”, which would then be reinterpreted as “Garfield is an atypical cat”.

### Logical Coherent Aggregates

Consider for example the syllogism represented by the symbols {121},{122}, {123} of FIG. 12. The symbols “Tom” and <category(“cats”)> occur twice in these three symbols and, in general, each symbol's meaning could vary from one occurrence to the other. If a user or an agent, within a particular context, determines that the meanings of these two symbol is the same (or sufficiently similar), then the syllogism would be validated and the three symbols {121},{122}, {123} could be glued together into a coherent aggregate:
{124}<derived (123, “from”, 121,122)>, or
{125}<deduction (121,122,123)>.

The <:derived> and <:deduction> builders make explicit the formal relationship between its constituents and provides a contextual scope (e.g. a coherent frame) within which the meanings of occurrences of all constituents and recursive sub-constituents is constrained to be coherent. Furthermore, these builders turn the standalone statement {123} into a relative statement which explicitly declares the support for the statement.

Coherent aggregates, such {124} or {125}, provide the scope within which logical consistency constrain are applied. Logical derivations result in increasingly larger coherent aggregates, and users are given the possibility to supervise and possibly correct automatic logical deductions.

Logical derivation may need to be invalidated if semiotic unification is not possible, even though all the premises are individually valid. For example, consider the script:
{4}<implies(category(“mice”), “#1 is clickable”))>
{5}<sample(category(“mice”),“Jerry”)>
{6}<“Jerry is clickable”>
{7}<deduction(6,4,5)>

A user may “invalidate” symbol <deduction(6,4,5)> on the ground that the user knows about a famous rodent-mouse named <“Jerry”> and therefore concludes that the two occurrences of the symbol <category(“mice”)> have different meanings. Yet another user who has named his computer mouse “Jerry” would consider {7} valid.

Thus, the disclosed memory system may solicit the user (or more generally a semiotic master) to confirm that the necessary coherency exists along the inference paths explored during the search phase (controlled inference).

1. We claim a method to memorize an information element in a memory system containing a plurality of instantiated symbols, the method comprising the steps of:
a. selecting, from said plurality of instantiated symbols, a plurality of relevant constituent symbols that are relevant for representing said information element;
b. composing said plurality of relevant constituent symbols into an input symbol which represents said information element;
c. ingesting said input symbol into said memory system, to yield an output symbol, instantiated in said memory system, which represents said information element.

2. The method of claim 1 wherein said output symbol is embodied by an output symbol identifier which identifies a record in said memory system that stores a defining representation of said input symbol.

3. The method of claim 1, wherein said output symbol is a pre-existing instantiated symbol of said memory system that approximately matches said input symbol.

4. The method of claim 1, wherein said information element entails a constituent information element, the method further comprising the steps of:
a. searching for a semiotic match to said constituent information element, to yield a semiotically matching constituent symbol which matches said constituent information element;
b. adding said semiotically matching constituent symbol to said plurality of relevant constituent symbols.

5. The method of claim 4, wherein
a. said information element is the meaning of a natural language expression;
b. said input symbol is a linguistic symbol;
c. said entailed constituent information element is a grammatical actor; and represented by
d. said searching for a semiotic match yields an actor symbol that represents said grammatical actor.

6. The method of claim 1, further comprising the steps of
a. searching for a symbolic match to a searched symbol, to yield a set of symbolic matches belonging to said plurality of instantiated symbols.

7. The method of claim 6, wherein
a. said step of searching for a symbolic match is carried out during said ingesting step;
b. said searched symbol is said input symbol; and wherein said ingestion step further comprises the steps of:
c. selecting one of said symbolic matches to be said output symbol if said set of symbolic matches is non-empty;
d. storing said input symbol in a newly allocated record of said memory system and returning an output symbol identifier that identifies said newly allocated record if said set of symbolic matches is empty.

8. The method of claim 6, wherein said searched symbol is a query symbol directed to said information element, the method further comprising the step of
a. returning a query resolution comprising said output symbol.

9. The method of claim 1, wherein said instantiated symbols and said relevant constituent symbols belong to a vocabulary of symbols and represent a plurality of memorized information elements belonging to a universe of information elements; and wherein
a. said universe of information elements comprises objective entities, meanings of natural language expressions, meanings of formally defined expressions, bundles of information elements;
b. said objective entities comprise real-world entities, abstract entities, living entities, inanimate entities, fictional entities, primal entities, digital assets;
c. said primal entities include numbers, tuples of numbers, space-time coordinates, geographic coordinates, physical quantities, physical measurements;
d. said digital assets comprise files, folders, digital media, emails, digital documents; and wherein
e. said vocabulary of symbols comprises names, natural language expressions, structured expressions, linguistic symbols, predicate symbols, logical constructs, category symbols, category sample symbols, category sample symbols with attributes, symbolic representations of objective entities, symbolic representations of formally defined expressions, builder symbols, operation symbols, coherent aggregates, topological aggregates, logical coherent aggregates, deductive aggregates, hypothetical coherent aggregates, lists of symbols, bundles of symbols.

10. The method of claim 1, wherein
a. said information element is a category;
b. said input symbol is a category symbol representing said category;
c. one of said relevant constituent symbols is a name-representing character string defining the name of said category; the method further comprising the steps of:
d. representing a set of members of said category by providing a list of member-representing character strings representing said category members;
e. composing said category symbol with said list of member-representing character strings, to yield a category sample symbol which represents said set of category members;
f. converting said category symbol into a first compositional code obtained by concatenating (1) an identifier representing a category symbol builder and (2) an identifier of said name-representing character string;
g. converting said category sample symbol into a second compositional code obtained by concatenating (1) an identifier representing a category sample symbol builder; (2) an identifier of said category symbol; (3) a list of identifiers representing said list of member-representing character strings.

11. The method of claim 1, wherein
a. said plurality of relevant constituent symbols comprises descriptor symbols that represent annotations of said information element; and
b. said input symbol is a descriptive aggregate symbol containing references to said descriptor symbols and providing a plurality of annotations of said information element.

12. The method of claim 1, wherein said plurality of instantiated symbols contains an instantiated multiform symbol; and wherein
a. an occurrence of said instantiated multiform symbol in said memory system is embodied by an instantiated symbol form belonging to a plurality of possible symbol forms;
b. said plurality of possible symbol forms of said instantiated multiform symbol includes an exploitable form, a compositional code, a symbol identifier; the method further comprising the step of
c. calculating a second instantiated symbol form from a first instantiated symbol form.

13. The method of claim 12, wherein
a. each instantiated symbol form is represented by a sequence of bits and
b. each occurrence of said each instantiated symbol form is given by a materialized digital structure consisting of a chunk of cells of said memory system containing said sequence of bits.

14. The method of claim 1 further comprising the step of
a. encoding said plurality of relevant constituent symbols into an ingestible compositional code that embodies said input symbol, wherein said ingesting comprises the step of
b. ingesting said ingestible compositional code.

15. The method of claim 14, wherein said encoding comprises the step of concatenating the symbol identifiers of said relevant constituent symbols, to yield said ingestible compositional code.

16. The method of claim 1, wherein said plurality of relevant constituent symbols comprises a composable builder and one or more composable arguments, further comprising the step of
a. applying said composable builder to said composable arguments to yield an exploitable form of said input symbol.

17. The method of claim 16, wherein
a. said composable builder is a constructor created by an object-oriented programming language; and
b. said composable arguments and said exploitable form of said input symbol are software objects created by said object-oriented programming language.

18. The method of claim 1, further comprising the step of memorizing a second information element represented by an input primitive symbol embodied by an input exploitable form.

19. The method of claim 18, wherein
a. said input primitive symbol is an input primal symbol;
b. said input primal symbol belongs to a primal space having a natural distance function.

20. The method of the claim 19, wherein the symbols in said primal space are semantically invariant symbols having a universal context independent meaning.

21. The method of claim 1, wherein each of said instantiated symbols occurs one or more times in said memory system, the method further comprising the step of
a. organizing the occurrences of said plurality of instantiated symbols into coherent frames, wherein multiple occurrences of an instantiated symbol in one of said coherent frames are assigned the same instantaneous meaning.

22. The method of claim 21, wherein said coherent frames include composite symbols, coherent aggregates, cluster semiotic entities, interactive sessions.

23. The method of claim 1, wherein said memory system further comprises an inference graph, the method further comprising the steps of:
a. adding, to the nodes of said inference graph, an inference host node wrapping one of said instantiated symbols;
b. embedding an inference node in said inference host node;
c. adding rule-based inferring instructions to said inference node;
d. delivering an inference signal to said embedded inference node along an edge of said inference graph;
e. executing said rule-based inferring instructions, to yield an inferred symbol, if said inference signal comprises a definite symbol;
f. executing said rule-based inferring instructions, to yield a second goal symbol, if said inference signal comprises a first goal symbol.

24. The method of claim 12, wherein an instantiated symbol is embodied by a compressed symbol form which contains an internal form, further comprising the step of
a. expanding said compressed symbol form by expanding said internal form, to expose additional information inherent to the information element represented by said instantiated symbol.

25. The method of claim 24 wherein
a. said internal form is a symbol identifier and said expanding said internal form comprises the step of
b. dereferencing said symbol identifier to retrieve the symbol definition corresponding to said symbol identifier.

26. The method of claim 24, wherein said internal form is a nested compositional code, and said expanding said internal form comprises the step of
a. decoding said nested compositional code.

27. The method of claim 26, wherein said compressed symbol form is either a hybrid exploitable form or a hierarchical compositional code.

28. The method of claim 24, further comprising the steps of:
a. executing said expanding one or more times to yield a variable-complexity multiform symbol, which comprises a plurality of semantically equivalent symbol forms having varying computational complexities; and
b. selecting an optimal symbol form from said variable-complexity multiform symbol that is adapted to the current context.

29. The method of claim 1, further comprising the step of
a. browsing said memory system, to yield a plurality of presented symbols selected from said plurality of instantiated symbols, wherein
b. said relevant constituent symbols are selected from said presented symbols.

30. The method of claim 29, wherein said browsing comprises the steps of:
a. creating a widget form for one of said instantiated symbols, to yield a presentable symbol;
b. presenting said widget form to a receiving party.

31. The method of claim 30, wherein said presentable symbol represents a presented information element and is embodied by a compressed symbol form; wherein
a. said widget form provides a succinct description of said presented information element, the method further comprising the steps of:
b. assigning a player to said widget form, to yield a playable widget;
c. triggering said player, to yield a rich widget form that presents a richer description of said presented information element; wherein said triggering comprises the step of:
d. expanding said compressed symbol form.

32. The method of claim 1, further comprising the step of
a. selecting two or more unifiable symbols from said plurality of instantiated symbols wherein said unifiable symbols contain an occurrence of a common constituent;
b. unifying said unifiable symbols by assigning the same instantaneous meaning to all occurrences, in said unifiable symbols, of said common constituent; and
c. aggregating said plurality of unifiable symbols into a coherent aggregate symbol.

33. The method of claim 32, wherein said assigning the same instantaneous meaning comprises the steps of:
a. reconstructing, from available contextual information, the instantaneous meanings of each occurrence of said common constituent in each of said unifiable symbols;
b. determining that these reconstructed instantaneous meanings are substantially equal.

34. The method of claim 32, wherein said unifiable symbols and said coherent aggregate symbol are produced by the same creator at different points in time, and said assigning the same instantaneous meaning comprises the steps of:
a. recollecting, by said creator, the past instantaneous meanings of each occurrence of said common constituent in each of said unifiable symbols;
b. recognizing, by said creator, that these recollected past instantaneous meanings are substantially equal.

35. The method of claim 32, wherein said assigning the same instantaneous meaning comprises the step of
a. hypothesizing that the instantaneous meanings of said occurrences are substantially equal, and wherein said coherent aggregate symbol is a hypothetical aggregate symbol.

36. The method of claim 32, wherein said unifiable symbols are propositional linguistic symbols and
a. said common constituent is a subject actor symbol of said propositional linguistic symbols which represents an annotated objective entity;
b. said propositional linguistic symbols represent annotations of said annotated objective entity;
c. said aggregate symbol is an annotation aggregate symbol.

37. The method of claim 32, wherein said unifiable symbols are propositional linguistic symbols participating in a logical deduction and said coherent aggregate symbol is a logical aggregate symbol, wherein multiple occurrences of any one of said propositional linguistic symbols in said logical coherent aggregate are assigned the same truth value.

38. The method of claim 1, further comprising the step of aggregating a plurality of instantiated symbols participating in a topological relationship into a topological aggregate symbol.

39. The method of claim 36, further comprising the steps of:
a. calculating an overlap measure between a first annotation aggregate symbol and a second annotation aggregate symbol, wherein said overlap measure depends on the number of components shared between said first annotation aggregate symbol and said second annotation aggregate symbol;
b. aggregating said first and second annotation aggregates into a topological aggregate symbol if said overlap measure is sufficiently large.

40. The method of claim 6, further comprising the steps of:
a. Aggregating a plurality of similar symbols into a first similarity aggregate symbol and
b. calculating, during said searching, an overlap measure between said first similarity aggregate symbol and a second similarity aggregate symbol, wherein said first and second similarity aggregate symbols are topological aggregate symbols.

41. The method of claim 1, wherein said plurality of instantiated symbols includes a plurality of tracked symbols, the method further comprising the step of
a. maintaining a compositions list for each tracked symbol, wherein said compositions list is a first order descendants list containing direct descendants of said each tracked symbol; and wherein
b. a direct descendant is a composite symbol that contains a reference to said each tracked symbol, and said each tracked symbol is a constituent of said direct descendant.

42. The method of claim 41, wherein
a. said plurality of relevant constituent symbols comprises a tracked constituent,
b. said input symbol is a direct descendant of said tracked constituent; and wherein said maintaining comprises the step of
c. updating the compositions list of said tracked constituent by adding said output symbol to the compositions list of said tracked constituent.

43. The method of claim 41, wherein
a. said plurality of relevant constituent symbols comprises a tracked constituent,
b. said input symbol is a direct descendant of said tracked constituent,
c. said output symbol provides an approximation of said input symbol; and wherein said maintaining comprises the steps of
d. aggregating said input symbol and said output symbol into a topological aggregate symbol representing the proximity of said input symbol and said output symbol;
e. updating the compositions list of said tracked constituent by adding said topological aggregate symbol to the compositions list of said tracked constituent.

44. The method of claim 41, further comprising the step of
a. calculating a second-order descendants list for a selected tracked symbol by joining the compositions lists of the direct descendants contained in the compositions list of said selected tracked symbol.

45. The method of claim 6, wherein said plurality of instantiated symbols includes a plurality of relaxable symbols, the method further comprising the step of
a. maintaining an adaptive neighborhood for each relaxable symbol, wherein said adaptive neighborhood contains a plurality of slack regions, wherein
b. each slack region contains symbols which are in a topological relationship with said relaxable symbol.

46. The method of claim 45, wherein said topological relationship belongs to a plurality of semiotic topological relationships which include: semantic equivalence, semantic similarity, metric proximity, subsumption, substantial overlap of pairs of aggregate symbols.

47. The method of claim 45 wherein said adaptive neighborhood comprises a first slack region containing exclusively semantically equivalent symbols and a second slack region containing semantically similar symbols.

48. The method of claim 45 wherein said adaptive neighborhood belongs to a metric space and comprises a plurality of bounded slack regions of said metric space having different diameters.

49. The method of claim 45, further comprising the step of executing said searching for a symbolic match by means of a multistage relaxed compositional search, which comprises the steps of:
a. selecting, in a first stage of said searching for a symbolic match, a first small slack region from said adaptive neighborhood;
b. selecting, in a second stage of said searching for a symbolic match, and only if said first stage has not resulted in a satisfactory result, a second larger slack region.

50. The method of claim 45, wherein said plurality of relaxable symbols contains a robustly tracked symbol, the method further comprising the steps of:
a. maintaining a compositions list for each symbol in the adaptive neighborhood of said robustly tracked symbol;
b. obtaining a relaxed compositions list for said robustly tracked symbol by joining the compositions lists of symbols contained in a selected slack region of said adaptive neighborhood, wherein
c. said relaxed compositions list contains all composite symbols belonging to the compositions list of some symbol in said selected slack region.

51. The method of claim 50, further comprising the steps of:
a. storing, in said memory system, said relaxed compositions list of said robustly tracked symbol; and
b. adding the compositions list of said input symbol to said relaxed compositions list if said robustly tracked symbol is in the adaptive neighborhood of said input symbol.

52. The method of claim 50, further comprising the step of
a. calculating a relaxed second-order descendants list for said robustly tracked symbol by joining the relaxed compositions lists of the symbols contained in the relaxed compositions list of said robustly tracked symbol.

53. The method of claim 52, further comprising the step of merging said relaxed compositions list with said second-order descendant list, to yield a merged relaxed descendants list for said robustly tracked symbol.

54. The method of the claim 6, wherein said searched symbol is a searched primal symbol, and wherein said searching for a symbol match comprises the steps of:
a. executing a K-nearest neighbor search, to yield a set of primal symbol matches given by a set of nearest neighbors of said searched primal symbol;
b. defining a primordial neighborhood of said searched primal symbol which includes said set of nearest neighbors.

55. The method of the claim 54, wherein said searched primal symbol is stored in an ad-hoc memory slice suitable to carry out said K-nearest neighbor search.

56. The method of the claim 54, further comprising the step of
a. using said primordial neighborhood to bootstrap the calculation of adaptive neighborhoods of composite symbols that contain an occurrence of a symbol of said primordial neighborhood.

57. The method of claim 6, wherein said searched symbol is a searched composite symbol and said searching comprises the steps of:
a. generating a compositional hypotheses list containing hypothesized symbolic matches to said searched composite symbol; and
b. searching for said symbolic matches by scanning said compositional hypotheses list.

58. The method of claim 57, further comprising the steps of
a. generating a probe containing a plurality of selected constituent symbols of said searched composite symbol, wherein said plurality of selected constituent symbols are tracked symbols;
b. obtaining the compositions lists of said selected constituent symbols; and
c. defining said compositional hypotheses list to be the intersection of said compositions lists, so that each hypothesized symbolic match and said searched composite symbol share the constituent symbols belonging to said probe.

59. The method of claim 57, wherein said set of symbolic matches are approximate matches, further comprising the steps of
a. generating a probe containing a plurality of selected constituent symbols of said searched composite symbol, wherein said plurality of selected constituent symbols are robustly tracked symbols;
b. obtaining a relaxed compositions lists for said selected constituent symbols; and
c. defining said compositional hypotheses list to be the intersection of said relaxed compositions lists, so that each hypothesized symbolic match and said searched composite symbol approximately share the constituent symbols belonging to said probe.

60. The method of claim 57, wherein said set of symbolic matches are approximate matches, further comprising the steps of:
a. generating a probe containing a plurality of first-and-second-order ancestors of said searched composite symbol, wherein said plurality of first-and-second-order ancestors are robustly tracked symbols;
b. obtaining the relaxed merged first-and-second-order descendants lists for said plurality of first-and-second-order ancestors; and
c. defining said compositional hypotheses list to be the intersection of said relaxed first-and-second-order descendants lists, so that each hypothesized symbolic match and said searched composite symbol approximately share the first-and-second-order ancestors
which belong to said probe.

61. The method of claim 57 further comprising the steps of:
a. evaluating, during said searching for symbolic matches, a composite distance between said searched symbol and a tested hypothesized symbolic match from said compositional hypotheses list;
b. creating a primordial neighborhood for said searched composite symbol, wherein said tested hypothesized symbolic match is added to said primordial neighborhood if said composite distance is sufficiently small;
c. using said primordial neighborhood to initialize the adaptive neighborhood of said searched composite symbol.

62. The method of claim 61, wherein said evaluating said composite distance comprises the steps of:
a. evaluating the distances between constituents of said hypothesized symbol match and constituents of said searched symbol; and
b. combining said constituent distances to yield said composite distance.

63. The method of claim 57, wherein said generating said compositional hypotheses list comprises the steps of:
a. creating a probe for said searched composite symbol, wherein said probe contains ancestors symbols of said searched symbol;
b. selecting a first ancestor symbol from said probe;
c. obtaining a descendants list of said first ancestor symbol;
d. initializing said compositional hypotheses list to be said descendants list of said first ancestor symbol;
e. selecting a further ancestor symbol from said probe;
f. obtaining a descendants list for said further ancestor symbol;
g. removing from said compositional hypotheses list all symbols which are not in said descendants list for said further ancestor symbol;
h. repeating, zero, one or more times, said selecting a further ancestor symbol, said obtaining and said removing until either
i) said compositional hypotheses list is small enough to be exhaustively searchable for finding a valid symbolic match;
ii) said compositional hypotheses list is empty, or
iii) all ancestor symbols in said probe have been processed.

64. The method of the claim 63, further comprising the steps of:
a. calculating the sizes of the descendants lists generated by said repeating step and
b. selecting said ancestor symbols from said probe according to the increasing order of the calculated sizes of said descendants lists.

65. The method of the claim 63, wherein said descendants lists are relaxed descendants lists, further comprising the step of repeating the steps of claim 63 with an increased slack value if said search resulted in an empty set of symbolic matches.

66. The method of claim 57, wherein said memory system comprises an inference graph;
a. said searched composite symbol is an inference-capable symbol belonging to said plurality of instantiated symbols;
b. said searched composite symbol is wrapped as an inference host node of said inference graph;
c. said symbolic matches to said searched composite symbol are partial matches providing a mating candidates list for said inference host node; the method further comprising the steps of:
d. scanning said mating candidates list to detect valid mates, to produce a plurality of inference links;
e. adding said inference links to the set of edges of said inference graph;
f. repeating, for a plurality of inference host nodes, said searching, said scanning, said producing a plurality of inference links, and said adding; and
g. performing, during said ingesting said input symbol, an inferential search, by means of said inference graph, to obtain an inferred symbolic match to said input symbol.

67. The method of claim 1, wherein said memory system comprises an inference graph, the method further comprising the steps of:
a. selecting an inference-capable symbol from said plurality of instantiated symbols;
b. wrapping said inference-capable symbol as a node of said inference graph, wherein said node is an inference host node, to yield a first inference host node;
c. creating an embedded inference node, embedded in said first inference host node, which contains rule-based inferring instructions for producing an inference-borne symbol;
d. adding said embedded inference node to said inference graph;
e. obtaining a mating candidates list for said first inference host node wherein a mating candidate is a second inference host node having one or more ancestors that are approximately the same as some ancestors of said first inference host node;
f. executing, one or more times, said selecting an inference-capable symbol, said wrapping, and said obtaining a mating candidates list, to generate a plurality of candidate mating pairs;
g. scanning said plurality of candidate mating pairs to find a plurality of linkable pairs of inference host nodes, wherein
i) a linkable pair consists of an upstream host node and a downstream host node, wherein said downstream host node contains a downstream embedded node;
ii) said downstream embedded node contains downstream rule-based inferring instructions; and wherein
iii) said upstream host node contains parameter values required to execute said downstream rule-based inferring instructions;
h. creating an inference link from said upstream host node to said downstream embedded node;
i. adding said inference link to the collection of edges of said inference graph.

68. The method of claim 67, further comprising the step of updating said inference graph upon ingestion of said input symbol, wherein said updating said inference graph comprises:
a. determining if said input symbol is inference-capable and, if said input symbol is inference-capable:
b. executing said wrapping on said input symbol so that said first inference host node wraps said input symbol;
c. executing said creating embedded inference nodes, said obtaining a mating candidate list, said generating a plurality of candidate mating pairs, said scanning, said finding linkable pairs and said creating inference links, so as to create a plurality of inference links for said input symbol.

69. The method of claim 68 wherein said updating said inference graph is finished during an off-line grooming phase.

70. The method of claim 67, further comprising the steps of:
a. selecting a plurality of constituents of said selected inference-capable symbol;
b. defining said mating candidates list to be the union of the compositions lists of said selected constituents, so that the two symbols wrapped by the two nodes of one of said candidate mating pairs share at least one constituent symbol.

71. The method of claim 67 wherein said selected inference-capable symbol is an annotation aggregate, further comprising the steps of:
a. selecting a plurality of second-degree ancestors of said selected inference-capable symbol;
b. defining said mating candidates list to be the union of second-order descendants lists of said selected second-degree ancestors, so that the two symbols wrapped by the two nodes of one of said candidate mating pairs share at least one second-order ancestor.

72. The method of claim 67, further comprising the steps of:
a. defining a plurality of probes for said selected inference-capable symbol, each containing a plurality of ancestors of said selected inference-capable symbol;
b. obtaining the relaxed descendants lists for the symbols in a selected probe from said plurality of probes;
c. calculating the intersection of said relaxed descendants lists, to yield a plurality of mating candidates for said selected probe;
d. repeating the previous two steps by selecting all probes in said plurality of probes;
e. joining the mating candidates obtained for each probe, to obtain mating candidates having a varying number of common ancestors with said selected inference-capable symbol.

73. The method of claim 67 further comprising the steps of:
a. firing said upstream host node of said inference link;
b. delivering a first downstream inference signal from said upstream host node to said downstream embedded node, wherein said first downstream inference signal includes said parameter values required to execute said downstream rule-based inferring instructions, thus enabling said downstream rule-based inferring instructions;
c. executing said downstream rule-based inferring instructions, to yield an output inference-borne symbol;
d. adding said output inference-borne symbol to a managed pool.

74. The method of claim 73, wherein said downstream embedded node is a forward-chaining inferential node and said output inference-borne symbol is an inferred symbol; the method further comprising the step of:
a. generating a deduction aggregate symbol representing symbolic evidence which logically supports said inferred symbol, wherein said deduction aggregate symbol includes an identifier of said downstream embedded node.

75. The method of claim 73, wherein said downstream embedded node is a rewriting node wherein
a. said downstream rule-based inferring instructions are for rewriting an input goal symbol into an output downstream goal symbol;
b. said downstream embedded node further contains rule-based resolving instructions to convert an input goal resolution into an output upstream goal resolution.

76. The method of claim 75, wherein said first downstream inference signal, delivered by said upstream host node to said downstream embedded node, provides said input goal symbol, the method further comprising the steps of:
a. rewriting said input goal symbol into said output downstream goal symbol, which is said inference-borne symbol;
b. delivering a second downstream inference signal to a plurality of further downstream inferentially-linked nodes, wherein said second downstream inference signal contains said output downstream goal symbol;
c. putting said downstream embedded node in a waiting state;
d. delivering an input goal resolution signal to said downstream embedded node;
e. waking up said downstream embedded node;
f. executing said rule-based resolving instructions to produce said output upstream goal resolution;
g. delivering, to said upstream host node, an output upstream inference signal containing said output upstream goal resolution.

77. The method of claim 1, wherein said step of selecting a plurality of relevant constituent symbols comprises the steps of:
a. inspecting the semiotic history of an inspected symbol, wherein said semiotic history includes past occurrences of said inspected symbol, to determine the past instantaneous meanings of said inspected symbol;
b. recognizing one of said past instantaneous meanings to be relevant for representing said information element; and
c. including said inspected symbol in said plurality of relevant constituent symbols.

78. The method of 77 further comprising the steps of
a. issuing a current semiotic point representing the current usage of said inspected symbol;
b. issuing a past semiotic point representing said past instantaneous meaning recognized to be relevant for representing said information element; and
c. creating a semiotic link from said current semiotic point to said past semiotic point to represent the proximity or equality between the instantaneous meaning conveyed by said inspected symbol in said current semiotic point and the instantaneous meaning conveyed by said inspected symbol in said past semiotic point.

79. The method of the claim 78 further comprising
a. creating a semiotic entity whose representative symbol is said inspected symbol; and
b. including said current semiotic point and said past semiotic point in the semiotic history of said semiotic entity.

80. The method of claim 1, further comprising the step of refining the meaning of an imprecise symbol that conveys a precise current instantaneous meaning in the current context, wherein said refining comprises the steps of:
a. retrieving the usage history of said imprecise symbol;
b. selecting a past usage from said usage history wherein the precise past instantaneous meaning of said imprecise symbol is sufficiently close to said precise current instantaneous meaning of said imprecise symbol;
c. qualifying the current usage of said imprecise symbol with said past usage to refine the meaning of said imprecise symbol.

81. The method of claim 80 wherein said qualifying comprises the steps of:
a. issuing a current semiotic point from said imprecise symbol to represent the instantaneous meaning of the current usage of said imprecise symbol;
b. issuing a past semiotic point from said imprecise symbol to represent the instantaneous meaning of said past usage of said imprecise symbol; and
c. creating a semiotic link from said current semiotic point to said past semiotic point.

82. The method of claim 80, wherein
a. said imprecise symbol is an ambiguous symbol and said refining results in disambiguating the meaning of said imprecise symbol, so that the correct precise instantaneous meaning is assigned to the current usage of said imprecise meaning.

83. The method of claim 80, wherein
a. said imprecise symbol is a vague symbol and said refining results in sharpening the meaning of said vague symbol.

84. The method of claim 1, wherein said memory system comprises a semiotic graph, the method further comprising the steps of:
a. providing a current context representation which represents contextual information inherent to the context in which said relevant constituent symbols have been selected and composed into said input symbol;
b. combining a selected constituent symbol belonging to said plurality of relevant constituent symbols with said current context representation, to yield a current constituent semiotic point, issued from said selected constituent symbol, which represents the current instantaneous meaning of said selected constituent symbol;
c. adding said current constituent semiotic point to said semiotic graph.

85. The method of claim 84, wherein said current constituent semiotic point represents the occurrence of said selected constituent symbol in said input symbol and further represents the instantaneous meaning conveyed by said occurrence.

86. The method of claim 85, further comprising the step of including said input symbol in said context representation, wherein said input symbol provides contextual information for the interpretation of said selected constituent symbol.

87. The method of claim 86 wherein said selected constituent symbol is a tracked symbol, the method further comprising the step of concatenating an identifier of the compositions list of said selected constituent symbol with the integer index that identifies the position of said input symbol in said compositions list, to yield an identifier of said current constituent semiotic point.

88. The method of claim 84, further comprising
a. combining said input symbol with said current context representation, to yield an inception semiotic point, issued from said input symbol, which represents the current instantaneous meaning of said input symbol and the creation event of said input symbol.

89. The method of claim 84, wherein said current context representation is given by a coherent frame, wherein
a. multiple occurrences of a repeated symbol in said coherent frame have the same referent and
b. multiple occurrences of a repeated propositional symbol in said coherent frame have the same truth value.

90. The method of claim 89, wherein
a. said coherent frame specifies the creator of said input symbol;
b. said coherent frame specifies a coherent time frame containing the creation timestamp of said input symbol and such that:
i) any symbol created by said creator during said coherent time frame and referenced by said creator during said coherent time frame is assigned a constant instantaneous meaning throughout said coherent time frame;
ii) any propositional symbol created by said creator during said coherent time frame and referenced by said creator during said coherent time frame is assigned a constant truth value throughout said coherent time frame.

91. The method of claim 90, wherein said coherent time frame corresponds to an interactive session between said creator and said memory system.

92. The method of claim 84, further comprising the steps of:
a. linking said current constituent semiotic point to a past semiotic point that represents substantially the same instantaneous meaning as the current instantaneous meaning of said selected constituent symbol, to yield a semiotic link; and
b. adding said semiotic link to the collection of edges of said semiotic graph.

93. The method of claim 92, wherein said past semiotic point is issued from said selected constituent symbol and represents the most recent past instantaneous meaning of said selected constituent symbol.

94. The method of claim 92, wherein said past semiotic point is issued from a symbol other than said selected constituent symbol.

95. The method of claim 92, further comprising the step of history rewinding wherein
a. the most recent past instantaneous meaning of said selected constituent symbol is different from its current instantaneous meaning and
b. said past semiotic point, which said current constituent semiotic point links to, was issued earlier than the most recent past semiotic point issued from said selected constituent symbol.

96. The method of claim 4, wherein said searching for a semiotic match to said constituent information element comprises the steps of:
a. presenting a plurality of semiotic points, to yield a plurality of presented semiotic points;
b. recovering the instantaneous meanings of said presented semiotic points;
c. selecting a semiotic point from said plurality of presented semiotic points whose recovered instantaneous meaning matches said constituent information element, to yield a matching constituent semiotic point, wherein said semiotically matching constituent symbol is the signifier of said matching constituent semiotic point.

97. The method of claim 96 further comprising the steps of:
a. issuing a current constituent semiotic point from said signifier of said matching constituent semiotic point;
b. creating a semiotic link from said current constituent semiotic point to said matching constituent semiotic point.

98. The method of claim 1, wherein
a. said memory system contains a plurality of semiotic entities, each having a representative symbol and a semiotic history; and
b. said semiotic history comprises a plurality of semiotic points which represent the instantaneous meanings conveyed by said representative symbol in a plurality of signification events.

99. The method of claim 1, wherein said memory system contains a semiotic entity representing a stream of interactions between a semiotic master and an objective entity, the method comprising the steps of:
a. triggering a plurality of signification events from said stream of interactions;
b. representing a signification event triggered by said stream of interactions by a semiotic point;
c. adding said semiotic point to the semiotic history of said semiotic entity.

100. The method of claim 1, wherein
a. said memory system contains a plurality of semiotic entities, each having a representative symbol and a semiotic history, the method further comprising the steps of:
b. selecting a relevant constituent semiotic entity from said plurality of semiotic entities;
c. including the current representative symbol of said relevant constituent semiotic entity into said plurality of relevant constituent symbols;
d. issuing a current constituent semiotic point for said current representative symbol, which represents the current instantaneous meaning conveyed by said current representative symbol; and
e. extending said relevant constituent semiotic entity by adding said current constituent semiotic point to the semiotic history of said relevant constituent semiotic entity.

101. The method of claim 100, further comprising the step of:
a. assigning an extended meaning to said relevant constituent semiotic entity given by the set of instantaneous meanings of the semiotic points in the semiotic history of said relevant constituent semiotic entity.

102. The method of claim 100, further comprising the step of assigning, to said current constituent semiotic point, a current context representation given by a coherent frame, wherein multiple occurrences of a repeated symbol within said coherent frame are assigned the same instantaneous meaning and multiple occurrences of a repeated propositional symbol within said coherent frame are assigned the same truth value.

103. The method of claim 100, further comprising the step of assigning, to said current constituent semiotic point, a current context representation which includes said input symbol, wherein said input symbol provides contextual information for the interpretation of said selected constituent symbol.

104. The method of claim 100, further comprising the steps of
a. creating a new semiotic entity whose representative symbol is said input symbol;
b. issuing an incipient semiotic point whose signifier is said input symbol, wherein said incipient semiotic point represents the creation event of said input symbol and the intended instantaneous meaning of said input symbol; and
c. initializing the history of said new semiotic entity with said incipient semiotic point.

105. The method of claim 100, further comprising the step of updating a selected semiotic entity by
a. assigning said input symbol to be the new representative symbol of said selected semiotic entity;
b. issuing an incipient semiotic point from said input symbol; and
c. linking said incipient semiotic point to the semiotic history of said selected semiotic entity.

106. The method of claim 105, wherein said selected entity represents an objective time-varying entity and said input symbol represents a state change of said objective time-varying entity.

107. The method of claim 106, wherein said state change corresponds to a new value being assigned to a variable quantity.

108. The method of claim 106, wherein
a. said objective time-varying entity is a list of items;
b. said state change is a modification of said list of items; and wherein
c. said modification is an addition of one or more items or the deletion of one or more items.

109. The method of claim 105, wherein said updating said selected semiotic entity is a descriptive update wherein:
a. said new representative symbol, given by said input symbol, provides a more informative representation of said information element than the previous representative symbol of said selected semiotic entity.

110. The method of claim 109 wherein
a. said previous representative symbol of said selected entity has an imprecise meaning and
b. said descriptive update is a refinement update wherein the instantaneous meaning of said new representative symbol is more precise than said previous representative symbol.

111. The method of claim 109 wherein
a. said previous representative symbol of said selected entity has an ambiguous meaning and
b. said descriptive update is a disambiguating update whereby the instantaneous meaning of said new representative symbol is unambiguous.

112. The method of claim 100 further comprising the step of refining a coarse semiotic entity whose semiotic history provides a coarse extended meaning for said coarse semiotic entity, the method comprising the sub-steps of:
a. finding a clustered set of semiotic points, belonging to the semiotic history of said coarse semiotic entity, to yield a refined semiotic sub-history providing a refined extended meaning;
b. refining the representative symbol of said coarse semiotic entity to yield a refined symbol that is consistent with said refined extended meaning;
c. creating a refined sub-entity of said coarse semiotic entity whose representative symbol is said refined symbol and whose semiotic history is said refined sub-history.

113. The method of claim 112, wherein said refining the representative symbol of said coarse entity comprises:
a. annotating said representative symbol of said coarse entity with a plurality of descriptor symbols, to yield a descriptive aggregate symbol, which is said refined symbol; and wherein said finding a clustered set of semiotic points comprises the step of
b. selecting semiotic points from the history of said coarse entity whose instantaneous meanings are consistent with said refined symbol.

114. The method of claim 112, wherein said finding said clustered set of semiotic points comprises the steps of:
a. recognizing that a selected set of semiotic points belonging to the semiotic history of said coarse semiotic entity have substantially the same instantaneous meaning; and wherein
b. said refined symbol conveys, in the current context, substantially the same instantaneous meaning as each semiotic point of said selected set of semiotic points.

115. The method of claim 114, wherein said recognizing entails
a. comparing each point of said clustered set of semiotic points with a prototype semiotic point; and
b. determining that the instantaneous meanings of said set of clustered points is the same as the instantaneous meaning of said prototype semiotic point.

116. The method of claim 105, further comprising the steps of:
a. updating a second semiotic entity jointly with the updating of said selected semiotic entity;
b. creating a reconciler symbol which references the representative symbol of said selected semiotic entity and the representative symbol of said second semiotic entity.

117. The method of claim 116, wherein
a. said selected semiotic entity and said second semiotic entity have substantially the same extended meaning;
b. said reconciler symbol asserts that the representative symbol of said selected semiotic entity and the representative symbol of said second semiotic entity convey substantially the same meaning;
c. said input symbol, which is the new representative symbol of said selected semiotic entity, is said reconciler symbol; the method further comprising the step of:
d. creating a new semiotic super-entity of which said selected semiotic entity and said second semiotic entity are semiotic sub-entities, and whose initial representative symbol is said reconciler symbol;
e. assigning said reconciler symbol to be the new representative symbol of said selected semiotic entity and of said second semiotic entity;
f. creating a semiotic link from said incipient semiotic point, which issued from said reconciler symbol, to both to the history of said selected semiotic entity and to the history of said second semiotic entity.

118. The method of claim 116, wherein
a. said selected semiotic entity and said second semiotic entity have overlapping extended meanings and represent different flavors of a vague information element;
b. said reconciler symbol asserts that the representative symbols of said two semiotic entities convey similar meanings; further comprising the step of
c. creating a coarser semiotic entity of which said selected semiotic entity and said second semiotic entity are sub-entities, and whose extended meaning encompasses the extended meaning of said selected semiotic entity and the extended meaning of said second semiotic entity;
d. assigning said reconciler symbol to be the initial representative symbol of said coarser semiotic entity.

119. The method of claim 118, further comprising the steps of:
a. plucking the representative symbol of said selected semiotic entity from said reconciler symbol, to yield a first plucked symbol, wherein said incipient semiotic point is issued from said first plucked symbol;
b. assigning said first plucked symbol, which is said input symbol, to be the new representative symbol of said selected semiotic entity;
c. plucking the representative symbol of said second semiotic entity from said reconciler symbol, to yield a second plucked symbol;
d. assigning said second plucked symbol to be the new representative symbol of said second semiotic entity;
e. issuing, from said second plucked symbol, a second incipient semiotic point;
f. linking said second incipient point to the history of said second semiotic entity.

120. The method of claim 116, wherein
a. the representative symbol of said second semiotic entity is the same as or a formal mutation of the representative symbol of said selected semiotic entity;
b. said selected semiotic entity and said second semiotic entity have disjoint extended meanings;
c. said reconciler symbol is a multi-sense reconciler symbol which asserts that the two representative symbols of said two entities convey different meanings despite being the same or substantially the same symbol;
d. creating a meaning-boundary semiotic entity, of which said selected semiotic entity and said second semiotic entity are sub-entities, and which declares a meaning boundary between the extended meanings provided by the semiotic histories of its sub-entities;
e. assigning said multi-sense reconciler symbol to be the initial representative symbol of said meaning-boundary semiotic entity.

121. The method of claim 120, further comprising the steps of
a. plucking the representative symbol of said selected semiotic entity from said reconciler symbol, to yield a first plucked symbol, wherein said input symbol is said first plucked symbol and said incipient semiotic point is issued from said first plucked symbol;
b. plucking the representative symbol of said second semiotic entity from said reconciler symbol, to yield a second plucked symbol;
c. assigning said second plucked symbol to be the new representative symbol of said second semiotic entity;
d. issuing, from said second plucked symbol, a second incipient semiotic point;
e. linking said second incipient point to the history of said second semiotic entity.

122. The method of claim 105, wherein
a. said plurality of relevant constituent symbols comprises a plurality of symbols recruited by said selected semiotic entity; and
b. said input symbol, which is the new representative symbol of said selected semiotic entity, is a coherent aggregate symbol that consolidates the history of said selected semiotic entity, wherein said coherent aggregate symbol contains occurrences of said plurality of symbols recruited by said selected semiotic entity.

123. The method of claim 122, wherein said plurality of recruited symbols include a topological aggregate symbol which represents an adaptive neighborhood.

124. The method of claim 122, wherein
a. said recruited symbols comprise a plurality of descriptor symbols, each obtained in a past context by binding a unary predicate symbol with the representative symbol of said selected semiotic entity that was current in said past context;
b. said input symbol is a category sample with attributes obtained by aggregating the most recent representative symbol of said selected entity and said plurality of unary predicate symbols.

125. The method of the claim 105, wherein said updating further comprises the step of consolidating said semiotic entity, and wherein said consolidating comprises the steps of:
a. selecting a plurality of semiotic points from the semiotic history of said selected semiotic entity;
b. recognizing that the instantaneous meanings of said selected plurality of semiotic points is substantially the same;
c. retrieving the signifiers said selected plurality of semiotic points, to yield a plurality of unifiable symbols;
d. unifying said plurality of unifiable symbols by aggregating them into a coherent symbol aggregate, wherein said input symbol is said coherent symbol aggregate.

126. The method of claim 112, further comprising the steps of:
a. presenting the content of said memory system with an adaptable amount of detail, resulting in a plurality of presented elements which includes a plurality of presented symbols, a plurality of presented semiotic entities and a plurality of presented semiotic points; said presenting further comprising the steps of:
b. processing a first request to reduce said adaptable amount of detail by excluding from said presented elements all symbols which are not currently an entity representative symbol;
c. processing a second request to reduce said adaptable amount of detail by excluding from said presented elements all sub-entities and all representative symbols of sub-entities;
d. selecting a semiotic entity from said plurality of presented semiotic entities, to yield a selected semiotic entity;
e. processing a third request to increase said adaptable amount of detail by presenting the semiotic points of said selected semiotic entity;
f. processing a fourth request to increase said adaptable amount of detail by presenting the symbols recruited by said selected semiotic entity.

127. The method of claim 18, wherein
a. said input primitive symbol is an input character string which represents a natural language expression;
b. said information element is the meaning of said natural language expression; the method further comprising the steps of:
c. recognizing that a fragment of said input character string represents a grammatical actor of said natural language expression;
d. creating an actor symbol to represent said grammatical actor, wherein said actor symbol has a grammatical role identifier and a role player symbol;
e. replacing said fragment of said input character string with said actor symbol, to yield a first linguistic symbol having one actor symbol;
f. executing, one or more times, said recognizing, said creating an actor symbol and said replacing to obtain an additional linguistic symbol having a plurality of actor symbols, wherein said first linguistic symbol and said additional linguistic symbol are grammatically structured linguistic expressions.

128. The method of claim 127, wherein said grammatical actor belongs to a collection of possible grammatical actors which includes subjects, verbs, grammatical objects, prepositional phrases.

129. The method of claim 127, further comprising the steps of
a. building a vocabulary of linguistic symbols and
b. adding said actor symbols and said grammatically structured linguistic expressions to said vocabulary.

130. The method of claim 127, further comprising the step of extending an extendable linguistic symbol with an adjunct actor symbol, wherein the grammatical role identifier of said adjunct actor symbol specifies a preposition or a wh-word.

131. The method of claim 127, further comprising the steps of
a. aggregating a plurality of linguistic symbols having a common role player symbol into a coherent aggregate symbol;
b. refining the meaning of said common role player symbol by plucking said common role player symbol from said coherent aggregate symbol, so that the contextual information provided by said plurality of linguistic symbols is brought to bear on said common role player symbol.

132. The method of claim 131, wherein
a. said plurality of linguistic symbols are compositions realized by a semiotic entity whose representative symbol is said common role player symbol and
b. said refining the meaning of said common actor symbol yields a refinement update of said semiotic entity, obtained by replacing the representative symbol of said semiotic entity with said plucked symbol.

133. The method of claim 127, further comprising the steps of
a. virtualizing said linguistic symbol to obtain a bindable expression, wherein said step of virtualizing comprises:
b. replacing a selected actor symbol of said linguistic symbol with a virtual actor symbol, wherein
i) said virtual actor symbol is obtained by nullifying the role player of said selected actor symbol and
ii) said virtual actor symbol is bindable to a plurality of allowable role player symbols;
c. executing said step of virtualizing N times, to obtain an N-bindable expression having N virtual actor symbols.

134. The method of the claim 133, further comprising the step of:
a. restricting the allowable role player symbols of said virtual actor symbol by means of a restricting category symbol attached to said virtual actor symbol, to yield a restricted virtual actor symbol.

135. The method of claim 133 further comprising the steps of:
a. binding said N-bindable expression to a provided role player symbol in a selected virtual actor symbol of said N-bindable expression, to yield a 1-bound,(N-1)-bindable expression, wherein said binding comprises the steps of:
b. selecting one of said virtual actor symbols of said N-bindable expression;
c. binding said selected virtual actor symbol to said provided role player symbol, to yield a filled concrete actor symbol;
d. creating said 1-bound,(N-1)-bindable expression by replacing said selected virtual actor symbol with said filled concrete actor symbol;
e. converting said 1-bound,(N-1) bindable symbol into a compositional code by concatenating (1) an identifier for a binder builder symbol, (2) an identifier for said N-bindable expression, (3) an integer number between 1 and N that identifies said selected virtual actor symbol within said N-bindable expression, and (4) an identifier of said filled concrete actor symbol or said provided role player symbol.

136. The method of claim 135, wherein said selected virtual actor symbol is a restricted virtual actor symbol, further comprising the steps of:
a. testing said provided role player symbol to determine if said provided role player symbol is an allowable role player symbol for said selected virtual actor symbol, wherein
b. said testing comprises the step of checking if said provided role player symbol is a member of the restricting category of said selected virtual actor symbol.

137. The method of claim 136, further comprising the step of overriding the restrictive nature of said restricting category symbol by:
a. forcing said provided role player symbol to bind to said restricted virtual actor symbol;
b. inferring that said provided role player symbol is a member of said restricting category symbol by virtue of it having been forcibly bound to said restricted virtual actor symbol;
c. creating a deduction aggregate symbol representing said inferred category member symbol along with the inferential evidence whereby said inferred category member was derived.

138. The method of claim 133, further comprising the step of including said N-bindable expression into a collection of bindable expressions which includes unary predicates and binary predicates, wherein
a. unary predicates are K-bound,1-bindable expressions-having one subject virtual actor;
b. binary predicates are K-bound,2-bindable expressions having a subject virtual actor and an object virtual actor.

139. The method of claim 138, further comprising the steps of:
a. binding a K-bound unary predicate to a provided role player symbol, to yield a K+1-bound saturated expression;
b. binding a K-bound binary predicate to two provided role player symbols, to yield a K+2-bound saturated expression.

140. The method of claim 138, further comprising the step of assigning a plurality of attributes to a list of category members, wherein said assigning comprises the steps of:
a. representing said list of category members with a category sample symbol;
b. representing said plurality of attributes with a list of unary predicate symbols;
c. aggregating said category sample symbol with said list of unary predicate symbols, to yield a category sample with attributes.

141. The method of claim 140, further comprising the steps of:
a. plucking one member from said category sample with attributes, to yield a plucked category member;
b. plucking one predicate from said annotated category sample symbol, to yield a plucked predicate;
c. binding said plucked member to said plucked predicate, to yield a saturated expression wherein said plucked category member plays the subject role;
d. encoding said saturated expression by concatenating (1) an identifier of a binding builder symbol, (2) an identifier of said category sample with attributes, (3) the integer index identifying said plucked category member in said category sample with attributes, and (4) the integer index identifying said plucked predicate in said list of unary predicates to yield a compositional code containing 4 components and representing said saturated expression.

142. The method of claim 138, further comprising the step of annotating a category represented by a category symbol with a plurality of fillable properties applicable to members of said category:
a. representing said fillable properties by a plurality of binary predicates, wherein said category symbol is a restricting category for said binary predicates;
b. aggregating said category symbol with said plurality of binary predicates, to yield an annotated categorvaggregate symbol.

143. The method of claim 138, further comprising the step of assigning a plurality of property values, corresponding to a list of properties, to a list of members of a first category, to yield a filled table symbol, wherein said assigning comprises the steps of:
a. representing said first category with a a first category symbol;
b. representing said list of category members by a category sample symbol whose category symbol is said first category symbol;
c. representing said list of properties by a plurality of restricted binary predicates, wherein
i) the subject role player of a selected predicate from said plurality of restricted binary predicates is restricted by a second category symbol which is a super-category of said first category symbol, and wherein
ii) the object role player of said selected predicate restricted to an object category symbol;
d. providing a list of property values for said selected predicate, wherein said list of property values are members of the category represented by said object category symbol;
e. aggregating said category sample symbol, said plurality of restricted binary predicates and said lists of property values, to yield said filled table symbol.

144. (canceled)

145. (canceled)

146. (canceled)

147. (canceled)

148. (canceled)

149. (canceled)

150. (canceled)

151. (canceled)

152. (canceled)

153. (canceled)

154. (canceled)

155. (canceled)

156. (canceled)

157. (canceled)

158. We claim a method to build a vocabulary of symbols, the method comprising the steps of:
a. providing an input character string representing a natural language expression;
b. recognizing that a fragment of said input character string represents a grammatical actor of said natural language expression;
c. creating an actor symbol to represent said grammatical actor;
d. encoding said input character string into the structured expression obtained by replacing said fragment with said actor symbol;
e. adding said actor and said structured expression to said vocabulary of linguistic symbols.

159. The method of claim 158, wherein said vocabulary is stored in a memory system, the method further comprising the step of ingesting said actor symbol and said structured expression into said memory system, and wherein said ingesting comprises the step of searching, in said memory system, for a symbolic match to said actor symbol and a symbol match to said structured expression.

160. The method of claim 158, further comprising the step of representing a formally defined expression containing a formal operation and a plurality of operands, the method further comprising the steps of:
a. representing a plurality of formal operations by means of a plurality of operation builder symbols;
b. composing an operation builder symbol, selected from said plurality of operation builder symbols, with a plurality of operand symbols, to yield a-composite symbol representing said formally defined expression;
c. converting said composite symbol into a first compositional code representing said formally defined expression, wherein said first compositional code is obtained by concatenating an identifier of said operation builder symbol with a list of identifiers of said operand symbols;
d. adding the above symbols said vocabulary of symbols.

161. The method of claim 160, wherein said plurality of formal operations comprises: set-union, set-intersection, set-partition, string concatenation, logical-and, logical-or.

162. The method of claim 160, wherein said plurality of formal operations comprises an unfold operator; the method further comprising the steps of:
a. concatenating an identifier of the builder symbol representing said unfold operator with said first compositional code, to obtain a second compositional code, which represents the result of executing the operation defined by said by formally defined expression;
b. decoding said second compositional code, to yield an exploitable form representation of said result.

163. We claim a memory system apparatus comprising:
a. storage means containing a plurality of instantiated symbols representing a plurality of memorized information elements, wherein said apparatus contains multiple occurrences of an instantiated multiform symbol which are materialized by occurrences of symbol forms; the apparatus further comprising:
b. symbol transforming means for transforming a first symbol form of said instantiated multiform symbol into a second symbol form of said instantiated multiform symbol;
c. symbol presenting means to present a plurality of presentable symbols to a receiving party;
d. symbol selecting means to select a plurality of relevant constituent symbols to be the defining constituents of an input symbol;
e. symbol composing means to compose said plurality of relevant constituent symbols into a composite symbol;
f. symbol searching means for finding a set of symbolic matches to a searchable symbol;
g. symbol ingesting means to ingest said input symbol into said apparatus, wherein said ingesting results in either a symbolic match being found which is contained in said apparatus, or in said input symbol being recorded by said apparatus.

164. The apparatus of claim 163, wherein said symbol forms include:
exploitable forms, symbol identifiers, compositional codes, semiotic points, semiotic entities and widget forms.

165. The apparatus of claim 163 wherein said transforming means includes decoding means for decoding a compositional code symbol form into an exploitable symbol form.

166. The apparatus of claim 163 wherein said transforming means includes encoding means to encode an input character string representing a natural language expression into a grammatically structured expression which contains an actor symbol.

167. The apparatus of claim 163 wherein said presenting means comprises:
a. an output module for converting said plurality of presentable symbols into a plurality of widget forms which are interpretable by an agent; and
b. an input module for receiving input data and input commands from said agent, the apparatus further comprising
c. means for processing said input data and said input commands to implement the selection of said relevant constituent symbols and the creation of said composite symbol.

168. The apparatus of claim 163, wherein said storage means contains a plurality of semiotic points which represent the instantaneous meanings of the occurrences of said instantiated symbols in said apparatus.

169. The apparatus of claim 163, wherein said storage means contains a plurality of semiotic entities which provide historical representations of (a) a plurality of objective entities and of (b) the meanings of a plurality of natural language expressions, wherein
a. said historical representations span a plurality of contexts and contain a plurality of semiotic points;
b. said semiotic points represent (a) the interactions of said objective entities with a plurality of agents and (b) the instantaneous meanings assigned by said plurality of agents to said natural language expressions over said plurality of contexts.

170. The apparatus of claim 169 further comprising:
a. means for presenting said semiotic points and said semiotic entities;
b. means for processing said input data and said input commands to select a relevant semiotic entity and a relevant semiotic point from said presented semiotic points and said presented semiotic entities, wherein said relevant semiotic point represents a past symbol occurrence conveying a substantially equal instantaneous meaning as the current instantaneous meaning of a selected symbol.

171. The apparatus of claim 163 comprising rule-based inferring instructions to generate an inference-borne symbol when an inference signal, that comprises required values for executing said rule-based inferring instructions, is delivered to an inference node of an inference graph.

172. The method of claim 159, further comprising memorizing an information element in said memory system, wherein said memory system contains a plurality of instantiated symbol, further comprising the steps of:
a. selecting, from said plurality of instantiated symbols, a plurality of relevant constituent symbols that are relevant for representing said information element;
b. composing said plurality of relevant constituent symbols into an input symbol which represent said information element;
c. ingesting said input symbol into said memory system, to yield an output symbol, instantiated in said memory system, which represents said information element.

173. The method of the previous claim, wherein said relevant constituent symbols include a bindable expression and a plurality of actor symbols and wherein said composing comprises the step of binding said actor symbols into said bindable expression.

174. We claim a method to represent a plurality of underlying entities comprising the steps of:
a. receiving a plurality of expressions, triggering a plurality of top-level signification events;
b. isolating a set of constituent symbols which occur in said expressions, wherein an occurrence of one of said constituent symbols in one of said expressions triggers a nested signification event;
c. generating a plurality of semiotic points representing the plurality of signification events of the previous two steps, wherein each of said underlying entities matches the instantaneous meaning of at least one of said signification events, whereby said semiotic points provide representations of said underlying entities.

175. The method of claim 174, wherein said plurality of underlying entities comprises a plurality of information elements and a plurality of objective entities.

176. The method of claim 174, wherein one of said semiotic points includes contextual information pertaining to one of said occurrences.

177. The method of claim 174, wherein one of said expressions is a linguistic expression uttered by a user and said isolating yields a multiform symbol representing a grammatical constituent of said uttered linguistic expression.

178. The method of claim 174, wherein said expressions and said constituent symbols are instantiated multiform symbols stored in a memory system.

179. The method of claim 174, further comprising the steps of:
a. creating a semiotic link between any pair of semiotic points which have been deemed to convey essentially the same instantaneous meaning;
b. organizing said semiotic points into a plurality of semiotic entities, wherein each of said semiotic entities:
i) comprises a connected set of semiotic points;
ii) designates a representative symbol;
iii) provides an extended meaning for one of said underlying entities which comprises the instantaneous meanings of said connected set of semiotic points.

180. The method of the previous claim, wherein said semiotic entities further provide dynamic representations of said underlying entities, wherein the method further comprises the steps of:
a. selecting a semiotic entity to be updated, wherein said selected semiotic entity represents a selected underlying entity from said plurality of underlying entities, and
b. updating said selected semiotic entity by designating a new representative symbol for said selected semiotic entity.

181. The method of claim 180, wherein said selected underlying entity is a time-varying entity and said new representative symbol represents a new state of said time-varying entity.

182. The method of claim 180, wherein said updating said selected semiotic entity is a descriptive update and wherein said new representative symbol provides a more informative representation of said information element than the previous representative symbol of said selected semiotic entity.

183. The method of claim 182 wherein
a. said previous representative symbol of said selected entity has an imprecise meaning and
b. said descriptive update is a refinement update wherein the instantaneous meaning of said new representative symbol is more precise than said previous representative symbol.

184. The method of claim 182 wherein
a. said previous representative symbol of said selected entity has an ambiguous meaning and
b. said descriptive update is a disambiguating update whereby the instantaneous meaning of said new representative symbol is unambiguous.

185. The method of claim 179 further comprising the step of refining a coarse semiotic entity whose semiotic history provides a coarse extended meaning for said coarse semiotic entity, the method comprising the sub-steps of:
a. finding a clustered set of semiotic points, belonging to the semiotic history of said coarse semiotic entity, to yield a refined semiotic sub-history providing a refined extended meaning;
b. refining the representative symbol of said coarse semiotic entity to yield a refined symbol that is consistent with said refined extended meaning;
c. creating a refined sub-entity of said coarse semiotic entity whose representative symbol is said refined symbol and whose semiotic history is said refined sub-history.

186. The method of claim 185, wherein said refining the representative symbol of said coarse entity comprises:
a. annotating said representative symbol of said coarse entity with a plurality of descriptor symbols, to yield a descriptive aggregate symbol, which is said refined symbol; and wherein said finding a clustered set of semiotic points comprises the step of:
b. selecting semiotic points from the history of said coarse entity whose instantaneous meanings are consistent with said refined symbol.

187. The method of claim 185, wherein said finding said clustered set of semiotic points comprises the steps of:
a. recognizing that a selected set of semiotic points belonging to the semiotic history of said coarse semiotic entity have substantially the same instantaneous meaning; and wherein
b. said refined symbol conveys, in the current context, substantially the same instantaneous meaning as each semiotic point of said selected set of semiotic points.

188. The method of claim 187, wherein said recognizing entails
a. comparing each point of said clustered set of semiotic points to a prototype semiotic point; and
b. determining that the instantaneous meanings of said set of clustered points is the same as the instantaneous meaning of said prototype semiotic point.

189. The method of claim 180, further comprising the steps of:
a. updating a second semiotic entity jointly with the updating of said selected semiotic entity;
b. creating a reconciler symbol which references the representative symbol of said selected semiotic entity and the representative symbol of said second semiotic entity.

190. The method of claim 189, wherein
a. said selected semiotic entity and said second semiotic entity have substantially the same extended meaning;
b. said reconciler symbol asserts that the representative symbol of said selected semiotic entity and the representative symbol of said second semiotic entity convey substantially the same meaning; the method further comprising the steps of:
c. creating a new semiotic super-entity of which said selected semiotic entity and said second semiotic entity are semiotic sub-entities, and whose initial representative symbol is said reconciler symbol;
d. assigning said reconciler symbol to be the new representative symbol of said selected semiotic entity and of said second semiotic entity;
e. creating a semiotic link from said incipient semiotic point, which issued from said reconciler symbol, to both to the history of said selected semiotic entity and to the history of said second semiotic entity.

191. The method of claim 189, wherein
a. said selected semiotic entity and said second semiotic entity have overlapping extended meanings and represent different flavors of a vague underlying entity;
b. said reconciler symbol asserts that the representative symbols of said two semiotic entities convey similar meanings; further comprising the step of
c. creating a coarser semiotic entity of which said selected semiotic entity and said second semiotic entity are sub-entities, and whose extended meaning encompasses the extended meaning of said selected semiotic entity and the extended meaning of said second semiotic entity;
d. assigning said reconciler symbol to be the initial representative symbol of said coarser semiotic entity.

192. The method of claim 191, further comprising the steps of:
a. plucking the representative symbol of said selected semiotic entity from said reconciler symbol, to yield a first plucked symbol, wherein said incipient semiotic point is issued from said first plucked symbol;
b. assigning said first plucked symbol-to be the new representative symbol of said selected semiotic entity;
c. plucking the representative symbol of said second semiotic entity from said reconciler symbol, to yield a second plucked symbol;
d. assigning said second plucked symbol to be the new representative symbol of said second semiotic entity;
e. issuing, from said second plucked symbol, a second incipient semiotic point;
f. linking said second incipient point to the history of said second semiotic entity.

193. The method of claim 189, wherein
a. the representative symbol of said second semiotic entity is the same as, or a formal mutation of, the representative symbol of said selected semiotic entity;
b. said selected semiotic entity and said second semiotic entity have disjoint extended meanings;
c. said reconciler symbol is a multi-sense reconciler symbol which asserts that the two representative symbols of said two entities convey different meanings despite being the same or substantially the same symbol;
d. creating a meaning-boundary semiotic entity, of which said selected semiotic entity and said second semiotic entity are sub-entities, and which declares a meaning boundary between the extended meanings provided by the semiotic histories of its sub-entities;
e. assigning said multi-sense reconciler symbol to be the initial representative symbol of said meaning-boundary semiotic entity.

194. The method of claim 193, further comprising the steps of
a. plucking the representative symbol of said selected semiotic entity from said reconciler symbol, to yield a first plucked symbol, wherein said input symbol is said first plucked symbol and said incipient semiotic point is issued from said first plucked symbol;
b. plucking the representative symbol of said second semiotic entity from said reconciler symbol, to yield a second plucked symbol;
c. assigning said second plucked symbol to be the new representative symbol of said second semiotic entity;
d. issuing, from said second plucked symbol, a second incipient semiotic point;
e. linking said second incipient point to the history of said second semiotic entity.

195. The method of claim 180, wherein said new representative symbol of said selected semiotic entity is a coherent aggregate symbol that consolidates the history of said selected semiotic entity, wherein said coherent aggregate symbol contains occurrences of the symbols recruited by said selected semiotic entity.

196. The method of claim 195, wherein said plurality of recruited symbols include a topological aggregate symbol which represents an adaptive neighborhood.

197. The method of claim 195, wherein said recruited symbols comprise a plurality of descriptor symbols, each obtained in a past context by binding a unary predicate symbol with the representative symbol of said selected semiotic entity that was current in said past context.

198. The method of the claim 180, wherein said updating further comprises the step of consolidating said semiotic entity, and wherein said consolidating comprises the steps of:
a. selecting a plurality of semiotic points from the semiotic history of said selected semiotic entity;
b. recognizing that the instantaneous meanings of said selected plurality of semiotic points are substantially equal to each other;
c. retrieving the signifiers said selected plurality of semiotic points, to yield a plurality of unifiable symbols;
d. unifying said plurality of unifiable symbols by aggregating them into a coherent symbol aggregate, wherein said new representative symbol is said coherent symbol aggregate.

199. The method of claim 185, further comprising the steps of:
a. presenting the content of said memory system with an adaptable amount of detail, resulting in a plurality of presented elements which includes a plurality of presented symbols, a plurality of presented semiotic entities and a plurality of presented semiotic points; said presenting further comprising the steps of:
b. processing a first request to reduce said adaptable amount of detail by excluding from said presented elements all symbols which are not currently an entity representative symbol;
c. processing a second request to reduce said adaptable amount of detail by excluding from said presented elements all sub-entities and all representative symbols of sub-entities;
d. selecting a semiotic entity from said plurality of presented semiotic entities, to yield a selected presented semiotic entity;
e. processing a third request to increase said adaptable amount of detail by presenting the semiotic points of said selected presented semiotic entity;
f. processing a fourth request to increase said adaptable amount of detail by presenting the symbols recruited by said selected presented semiotic entity.
